(19) United States
(12) Patent Application Publication
(10) Pub. No.: US 2026/0307158 A1
(43) Pub. Date: Oct. 8, 2026

(54) HOLESAW ASSEMBLY

(71) Applicant: Black & Decker Inc., New Britain, CT (US)

(72) Inventors: Jeffrey Charles Proulx, Suffield, CT (US); Poinon Zanga Sanogo, West Hartford, CT (US); Nicholas Edward Spagnolo, Southwick, MA (US); Kenneth Hall, East Longmeadow, MA (US)

(21) Appl. No.: 19/713,217

(22) Filed: Jun. 18, 2026

Related U.S. Application Data
(63) Continuation-in-part of application No. 19/349,360, filed on Oct. 3, 2025.
Application No. 19/349,360 is a continuation-in-part of application No. 18/984,440, filed on Dec. 17, 2024.
(63) Continuation-in-part of application No. PCT/US2024/060556, filed on Dec. 17, 2024.
(60) Provisional application No. 63/611,480, filed on Dec. 18, 2023.
(60) Provisional application No. 63/611,480, filed on Dec. 18, 2023.
(60) Provisional application No. 63/670,577, filed on Jul. 12, 2024.
(60) Provisional application No. 63/670,577, filed on Jul. 12, 2024.

(51) Int. Cl. B23B 51/04

(52) U.S. Cl. CPC B23B 51/0473

(57) ABSTRACT

A holesaw arbor assembly includes an arbor body, at least one drive pin, a base support plate, a support surface, and a resilient member. The arbor body extends along an axis and has a threaded portion configured to engage a corresponding threaded portion of a holesaw. The drive pin is supported by the arbor body and is configured to engage an aperture in the base of the holesaw. The base support plate is disposed relative to the arbor body and is movable axially to support the base of the holesaw. The support surface is fixed relative to the arbor body and non-movable axially. The resilient member is positioned between the support surface and the base support plate, biasing the base support plate axially toward the base of the holesaw. This arrangement provides compliance as the holesaw is threaded onto the arbor, enabling alignment of the apertures with the drive pin and allowing the holesaw base to seat firmly against the base support plate in a manner that limits excessive tightening and reduces the potential for gaps.

### RELATED APPLICATIONS

This application is a continuation-in-part of U.S. patent application Ser. No. 19/349,360, filed on Oct. 3, 2025, entitled “HOLESAW ASSEMBLY,” which is a continuation-in-part of U.S. patent application Ser. No. 18/984,440, filed on Dec. 17, 2024, entitled “HOLESAW ASSEMBLY,” which claims the benefit of U.S. Provisional Patent Application No. 63/670,577, filed on Jul. 12, 2024, entitled “HOLESAW ASSEMBLY,” and U.S. Provisional Patent Application No. 63/611,480, filed on Dec. 18, 2023, entitled “HOLESAW ASSEMBLY,” each of which is hereby incorporated herein by reference.

This application is also a continuation-in-part of PCT Application No. PCT/US2024/060556, filed on Dec. 17, 2024, entitled “HOLE CUTTING ASSEMBLY, HOLE SAW ARBOR ASSEMBLY AND DRILL BIT FOR HOLE SAW ASSEMBLY,” which claims the benefit of U.S. Provisional Patent Application No. 63/670,577, filed on Jul. 12, 2024, entitled “HOLESAW ASSEMBLY,” and U.S. Provisional Patent Application No. 63/611,480, filed on Dec. 18, 2023, entitled “HOLESAW ASSEMBLY,” each of which is hereby incorporated herein by reference.

### TECHNICAL FIELD

This application generally relates to power tool accessories, and more particularly to a holesaw assembly and components thereof.

### BACKGROUND

Holesaws are generally used with a drill to form large diameter holes in a workpiece. A holesaw generally has a circular base and a cylindrical peripheral cutting edge with a plurality of teeth or other cutters coupled to the cutting edge. A holesaw may be coupled to a tool holder (e.g., a chuck) of a drill by an arbor to which the holesaw is removably coupled. A drill bit also may be removably coupled to the arbor and may enter the workpiece before the holesaw in order to form a pilot hole in the workpiece.

In use, the holesaw generally forms a cylindrical plug of material that is removed from the workpiece. The plug may become stuck inside the peripheral wall of the holesaw. Removing a plug from a holesaw may require use of a secondary tool (e.g., a screwdriver or similar implement) to access the plug from a side of the hole saw and pry it out. This process can be difficult and time consuming.

### SUMMARY

In an aspect, a hole cutting assembly can include a cutting tool defining an internal space configured to receive a plug of material formed during a cutting operation. The cutting tool can include a cutting edge and a base. The hole cutting assembly can include an arbor coupled to the cutting tool and configured to rotate the cutting tool during the cutting operation. The cutting tool can include a drill bit that can include a cutting tip configured to create a pilot hole in a workpiece and a shaft configured to be coupled to the arbor. The drill bit may be movable relative to the arbor along a longitudinal axis between an extended position and a retracted position. The cutting tool can include a retainer associated with the arbor and configured to selectively maintain the drill bit in the retracted position. The cutting tool can include a biasing member configured to exert a force on the drill bit to move the drill bit toward the extended position when the retainer can be disengaged. The cutting tool can include a release actuator operable to release the retainer. Movement of the drill bit toward the extended position can cause the drill bit to apply an ejection force to at least partially dislodge the plug from the internal space of the cutting tool.

Implementations of the aspect of the previous paragraph may include one or more of the following features. The arbor can include a helical channel and a drill bit carrier to which the drill bit can be configured to be coupled. The drill bit carrier can include at least one projection configured to engage with the helical channel, such that rotation of the arbor relative to the drill bit carrier facilitates the movement of the drill bit along the longitudinal axis between the extended position and the retracted position. The arbor can include an axial channel and a drill bit carrier to which the drill bit can be configured to be coupled. The drill bit carrier can include at least one projection configured to engage with the axial channel, wherein the axial channel facilitates movement of the drill bit along the longitudinal axis between the extended position and the retracted position through compression of the drill bit or release of the retainer. The hole cutting assembly can include a visual indicator disposed on the arbor, the visual indicator providing an indication of whether the drill bit can be in the extended position or the retracted position. The retainer can include at least one projection that engages a recess within the arbor to maintain the drill bit in the retracted position. Disengagement of the projection allows movement of the drill bit toward the extended position.

Implementations of the aspect of any of the previous paragraphs may include one or more of the following features. The release actuator can include a collar positioned about the arbor, the collar being movable along the longitudinal axis of the arbor to actuate the release of the retainer. The biasing member can include a compression spring configured to exert an axial force on the drill bit to move the drill bit toward the extended position upon release of the retainer. The cutting tool can include a holesaw with a cylindrical wall extending from the base, the wall defining the internal space. The drill bit can be configured to mechanically and/or frictionally engage the plug during movement toward the extended position to facilitate at least partially dislodging the plug. The cutting tool can include a plurality of teeth on the cutting edge, the teeth configured to form a cylindrical cut in a workpiece during rotation by the arbor. The arbor can include a quick-release actuator configured to facilitate removal of at least one of the cutting tool or the drill bit without requiring additional tools. The quick-release actuator can include a collar positioned about the arbor, the collar being rotatable about the arbor to actuate the release of the drill bit. The retainer can be biased into an engaged position by a retainer spring.

Implementations of the aspect of any of the previous paragraphs may include one or more of the following features. The release actuator can be operable to provide a plurality of modes including a first mode for retaining the drill bit in the retracted position, a second mode for releasing the drill bit to move toward the extended position, and a third mode for allowing removal of the drill bit from the arbor. The drill bit can include a textured surface configured to enhance mechanical and/or frictional engagement with the plug. The arbor and the holesaw can be configured to rotate in unison during the cutting operation. The drill bit can be configured to rotate independently of the arbor when in the extended position. At least one of an exterior surface of the drill bit carrier or an interior surface of the arbor can define a groove. The hole cutting assembly can include an alignment element configured to engage with the groove, the alignment element being operatively coupled to the other of the drill bit carrier or the arbor, such that the groove and the alignment element cooperate to rotationally fix the drill bit carrier relative to the arbor while permitting axial movement of the drill bit carrier and the drill bit supported therein. The alignment element can include a bearing, pin, or projection extending radially from the surface opposite the groove. The groove can extend substantially parallel to an axis of the arbor and can be configured to allow axial translation of the drill bit carrier within the arbor.

In another aspect, a holesaw arbor assembly, can include a shank including a first portion couplable to a tool holder of a power tool, a second portion couplable to a holesaw; a drill bit carrier movably coupled to the shank and configured to be couplable to a drill bit, the drill bit carrier configured to move relative to the shank between an extended position and a retracted position, the drill bit carrier being closer to the first portion of the shank in the retracted position than in the extended position; and a retainer configured to selectively maintain the drill bit carrier in the retracted position, wherein release of the retainer permits movement of the drill bit carrier toward the extended position.

Implementations of the aspect of the previous paragraph may include one or more of the following features. The holesaw arbor assembly can include a biasing member configured to exert an ejection force on the drill bit carrier upon release of the retainer when the drill bit can be in the retracted position, the ejection force being sufficient to move the drill bit carrier toward the extended position and at least partially eject a plug from the holesaw. The holesaw arbor assembly can include a release actuator including a collar positioned about an exterior surface of the shank, the collar being movable between at least a first position and a second position, the second position corresponding to the release of the retainer. The shank can include a helical channel. The drill bit carrier can include at least one projection engageable with the helical channel, such that rotation of the shank relative to the drill bit carrier can cause retraction of the drill bit carrier from the extended position toward the retracted position. The shank can include an axial channel. The drill bit carrier can include at least one projection engageable with the axial channel, wherein the axial channel facilitates movement of the drill bit along the longitudinal axis between the extended position and the retracted position through compression of the drill bit or release of the retainer. The holesaw arbor assembly can include a visual indicator positioned on the arbor, the visual indicator configured to provide an indication of whether the drill bit can be in the extended position or the retracted position. The retainer can include at least one projection cooperatively engageable with a recess in the arbor, and wherein release of the retainer can include movement of the at least one projection from an engaged position with the recess to a non-engaged position. The drill bit can be configured to form a pilot hole in a workpiece when in the extended position, and wherein rotation of the arbor facilitates movement of the drill bit from the extended position to the retracted position for subsequent cutting by the holesaw.

In another aspect, a holesaw arbor assembly can include a shank extending along a longitudinal axis and can include a proximal end configured to be coupled with a tool holder of a power tool and a distal end configured to be coupled with a holesaw. The holesaw arbor assembly can include a drill bit carrier at least partially received within the shank, the drill bit carrier movable between a retracted position and an extended position along the longitudinal axis relative to the shank. The holesaw arbor assembly can include a drill bit couplable to the drill bit carrier and configured to extend axially from the shank. The holesaw arbor assembly can include a collar movable between a first position and a second position. The holesaw arbor assembly can include a lock configured to selectively restrict axial movement of the drill bit carrier when the drill bit carrier can be in the first position. The holesaw arbor assembly can include a spring configured to bias the drill bit carrier toward the second position. The collar, when moved to the second position, releases the lock and allows the drill bit carrier and drill bit to move toward the extended position to at least partially eject a plug formed in the holesaw.

In another aspect, a holesaw arbor assembly can include a shank including a proximal end configured to couple with a tool holder of a power tool and a distal end configured to be coupled with a holesaw; a collar rotationally coupled to the shank; a lock operatively coupled to the collar, the lock configured to move radially to engage or release a drill bit; and a detent configured to define at least two rotational positions of the collar. In a first rotational position, the lock can be configured to secure the drill bit within the shank; and in a second rotational position, the lock can be configured to release the drill bit.

In another aspect, a holesaw arbor assembly can include a shank extending along a longitudinal axis and configured to couple with a tool holder of a power tool; a base coupled to the shank and configured to couple with a holesaw; a drill bit carrier at least partially received within the shank, the drill bit carrier coupleable to a drill bit and movable between a retracted position and an extended position; a plug eject actuator operatively coupled to the shank and movable between a first position to retain the drill bit carrier in the retracted position and a second position to enable movement of the drill bit carrier toward the extended position to at least partially eject a plug formed in the holesaw; and a drill bit release actuator operatively coupled to the shank and movable between a locked position to couple the drill bit to the drill bit carrier and an unlocked position to release the drill bit from the drill bit carrier.

Implementations of the aspect of the previous paragraph may include one or more of the following features. The holesaw arbor assembly can include a detent system operatively associated with the drill bit release actuator and the plug eject actuator. The detent system can be configured to inhibit movement of the plug eject actuator when the drill bit release actuator can be in the unlocked position, and inhibit movement of the drill bit release actuator to the unlocked position when the plug eject actuator can be in a second position.

In another aspect, a drill bit for use in a holesaw assembly, can include an elongate shaft can include a cutting tip at a first end, a shank at a rear end, and a shaft extending rearward from the cutting tip toward the shank, the shaft can include an outer surface and at least one flute formed in the shaft; and a mechanical engagement surface formed on a portion of the shaft, the mechanical engagement surface distinct from the outer surface and the at least one flute of the shaft. The mechanical engagement surface can be configured to mechanically and/or frictionally engage an inner surface of a pilot hole of a plug formed within a holesaw. The mechanical engagement surface provides mechanical and/or frictional engagement that inhibits the drill bit from sliding entirely through the pilot hole and facilitates at least partial ejection of the plug from the holesaw when the drill bit can be moved axially relative to the holesaw.

Implementations of the aspect of the previous paragraph may include one or more of the following features. The mechanical engagement surface can include threads. The mechanical engagement surface can include a roughened surface. The mechanical engagement surface can include one or more ridges or grooves.

In another aspect, a holesaw assembly can include an arbor can include a proximal end configured to engage a power tool and a distal end configured to receive a holesaw; a holesaw removably coupled to the distal end of the arbor, the holesaw including a base with a plurality of openings; a collar rotatably coupled to the arbor, the collar can include an internal ramp extending between a first ramp height corresponding to a retracted position and a second ramp height corresponding to an extended position; and a plurality of drive pins coupled to the collar and configured to interact with the ramp of the collar. Rotational movement of the collar can cause movement of the drive pins between the retracted position and the extended position, such that in the retracted position, the drive pins are aligned with the first ramp height, causing the drive pins to at least partially retract and disengage from the openings in the holesaw. In the extended position, the drive pins are aligned with the second ramp height, causing the drive pins to extend outward from the arbor and engage the openings in the holesaw.

Implementations of the aspect of the previous paragraph may include one or more of the following features. The holesaw can be threadably coupled to the distal end of the arbor, and the drive pins provide additional engagement to resist rotational decoupling of the holesaw during operation. The extended position and the retracted position of the drive pins are separated by less than a full turn of the collar about the arbor. The extended position and the retracted position of the drive pins are separated by less than a half turn of the collar about the arbor. The extended position and the retracted position of the drive pins are separated by less than a quarter turn of the collar about the arbor. The retracted position of the drive pins corresponds to a configuration in which the rotational movement of the collar also disengages the drill bit from a drill bit carrier, enabling removal of the drill bit from the arbor. The collar can be a first collar. The holesaw assembly can include a second collar can be configured to provide a plug ejection feature to at least partially eject a plug from an internal space of the holesaw.

Advantages may include one or more of the following. The holesaw assembly and/or holesaw arbor assembly enable easier removal of a plug from the holesaw, reducing or eliminating the need for a secondary tool to pry the plug out of the holesaw. The assembly can allow for quick and tool-free attachment or detachment of the drill bit and/or holesaw, enhancing operational efficiency and user convenience. These features improve the reliability of the plug ejection process, reduce downtime during cutting operations, and reduce the risk of damage to the holesaw or the workpiece. These and other advantages and features will be apparent from the description, the drawings, and the claims.

### BRIEF DESCRIPTION OF THE DRAWINGS

FIG. 1 is a perspective view, partially in phantom, of an example of a holesaw assembly, in accordance with embodiments of the present disclosure.

FIG. 2 is an exploded view of the holesaw assembly of FIG. 1.

FIG. 3 is a cross-sectional side view of an example of a holesaw assembly, in accordance with embodiments of the present disclosure.

FIG. 4A illustrates a cross-sectional view of an example of a holesaw assembly in an extended position, in accordance with embodiments of the present disclosure.

FIG. 4B illustrates the holesaw assembly of FIG. 4A presented in an intermediate position relative to the extended position.

FIG. 4C illustrates the holesaw assembly of FIG. 4A in a retracted position.

FIG. 4D illustrates the holesaw assembly of FIG. 4A in a retracted position with a plug.

FIG. 4E illustrates the holesaw assembly of FIG. 4A in an extended position with the plug ejected.

FIG. 5A illustrates an example of a holesaw assembly in a retracted position, in accordance with embodiments of the present disclosure.

FIG. 5B illustrates the holesaw assembly of FIG. 5A in an extended position following the activation of a switch.

FIG. 6A is a cross-sectional side view of another example of a holesaw assembly, in accordance with embodiments of the present disclosure.

FIG. 6B is a close-up cross-sectional side view of a portion of the holesaw assembly of FIG. 6A.

FIG. 7A is a cross-sectional side view of the holesaw assembly of FIG. 6A with the switch in a first position and the drill bit carrier in an extended position.

FIG. 7B is a cross-sectional side view of the holesaw assembly of FIG. 6A with the switch in a first position and the drill bit carrier in a retracted position.

FIG. 8A is a cross-sectional side view of the holesaw assembly of FIG. 6A with the switch in a second position and the drill bit carrier in a retracted position.

FIG. 8B is a close-up cross-sectional side view of a portion of the holesaw assembly of FIG. 8A.

FIG. 9A is a cross-sectional side view of the holesaw assembly of FIG. 6A with the switch in a second position and the drill bit carrier in an extended position.

FIG. 9B is a close-up cross-sectional side view of a portion of the holesaw assembly of FIG. 9A.

FIG. 9C is a close-up cross-sectional side view of a portion of the holesaw assembly of FIG. 9A.

FIG. 10A is a cross-sectional side view of the holesaw assembly of FIG. 6A with the switch in a third position and the drill bit carrier in an extended position.

FIG. 10B is a close-up cross-sectional side view of a portion of the holesaw assembly of FIG. 10A.

FIG. 11 is a perspective view of another example of a holesaw assembly, in accordance with embodiments of the present disclosure.

FIG. 12A is a cross-sectional side view of the holesaw assembly of FIG. 11 with the first switch in a first position and the drill bit carrier in an extended position.

FIG. 12B is a cross-sectional side view of the holesaw assembly of FIG. 11 with the first switch in a first position and the drill bit carrier in a retracted position.

FIG. 13A is a cross-sectional side view of the holesaw assembly of FIG. 11 with the first switch in a second position and the drill bit carrier in an extended position.

FIG. 13B is a cross-sectional side view of the holesaw assembly of FIG. 11 with the first switch in a second position and the drill bit carrier in an extended position.

FIG. 14A is a cross-sectional view of the holesaw assembly of FIG. 12A, taken along line A-A, with the second switch in a first position.

FIG. 14B is a cross-sectional view of the holesaw assembly of FIG. 12A, taken along line A-A, with the second switch in a second position.

FIG. 15 illustrates a perspective view of another embodiment of a holesaw assembly.

FIG. 16 illustrates a cross-sectional side view of the holesaw assembly of FIG. 15.

FIGS. 17A, 17B, and 17C depict a cross-sectional side view of the holesaw assembly of FIG. 15 in the first, second, and third positions, respectively.

FIGS. 18A to 18D and FIG. 19 illustrate various views of a retention assembly of the holesaw assembly of FIG. 15.

FIG. 20 shows a perspective view of the second collar removed from the holesaw assembly of FIG. 15, showing first and second shelves.

FIGS. 21A-21D illustrate various views of the holesaw assembly of FIG. 15.

FIGS. 22A-22P illustrate various views of example pilot drill bits for use with the example holesaw assemblies disclosed in this application.

FIGS. 23A and 23B illustrate perspective and exploded views, respectively, of another embodiment of a holesaw assembly.

FIG. 24A illustrates a perspective view of the second collar of the holesaw assembly of FIG. 23A.

FIG. 24B illustrates a perspective view of a drive pin of the holesaw assembly of FIG. 23A.

FIGS. 25A and 25B illustrate cross-sectional side views of the holesaw assembly of FIG. 23A with drive pins in retracted and extended positions, respectively, due to the manipulation of the second collar.

FIGS. 26A and 26B illustrate cross-sectional side views of the holesaw assembly of FIG. 23A.

FIGS. 27A through 27E illustrate cross-sectional side views of the holesaw assembly of FIG. 23A in various operational states during a plug ejection process, facilitated by the first actuator or collar.

FIG. 28A illustrates an exploded view of an embodiment of an arbor assembly.

FIG. 28B illustrates an embodiment of a support washer for providing a support surface.

FIG. 28C illustrates a detail view of a portion of the resilient interface of the holesaw assembly of FIG. 28A.

FIG. 28D illustrates another embodiment of a detail view of a portion of a resilient interface.

FIGS. 29A and 29B illustrate another embodiment of a detail view of a portion of a resilient interface.

### DETAILED DESCRIPTION

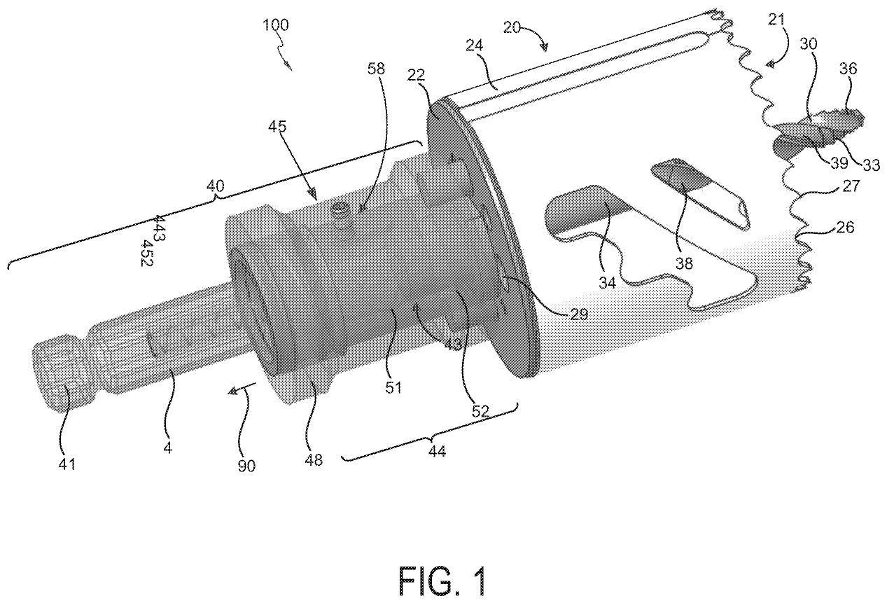

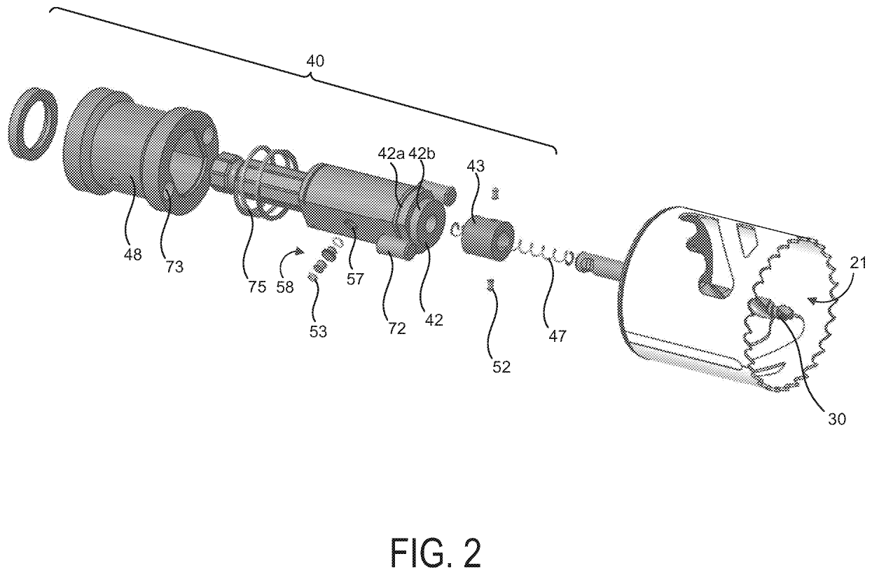

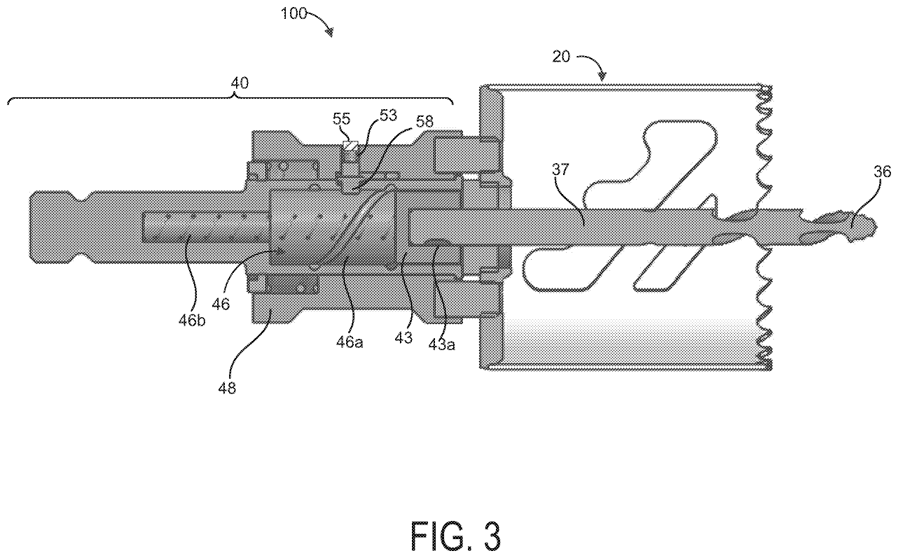

FIGS. 1, 2, and 3 illustrate a perspective, exploded, and cross-sectional view of an example of a holesaw assembly 100, in accordance with embodiments of the present disclosure. Referring to FIGS. 1, 2 and 3, a holesaw assembly 100 includes a holesaw 20, a drill bit 30, an arbor 40. The holesaw 20 includes a base 22 and a wall 24 coupled to the base 22. The wall 24 can include a proximal end coupled to the base 22 and a distal end terminating in a cutting edge 26, which may include a plurality of teeth or cutters 27. The base 22 may include a central opening (not shown), which may be threaded, and one or more lateral openings 29. The base 22 can assume a generally circular shape, and the wall 24 can assume a generally cylindrical form, thus resulting in the holesaw 20 delineating a generally cylindrical internal space 21. When rotatably driven by the arbor 40, the holesaw 20 is configured to form a generally circular hole in a workpiece by removing a resultant plug of material from the workpiece that is received inside the internal space 21 within the wall 24. As described herein, the holesaw assembly 100 can facilitate the ejection of the plug from within the internal space 21, without the use of additional tools.

The drill bit 30 includes a cutting tip 36 and an elongate shaft portion 37. The elongate shaft portion 37 can include a rear end portion couplable to the arbor 40 and an intermediate portion between the rear end portion and the cutting tip 36. The intermediate portion 34 can include at least one helical flute 38 for removing debris and cutting chips or at least one helical land 39 between adjacent turns of the flute 38.

In some cases, the drill bit 30 can be used for both creating a pilot hole in a workpiece and facilitating the ejection of a plug from the internal space 21. For example, during the operation of holesaw 20, the drill bit 30 can create the pilot hole and then retract into arbor 40. Subsequently, the drill bit 30 can be extended or projected from arbor 40 to apply an ejection force on a plug, if present, lodged within internal space 21. In some cases, the drill bit 30 can include textural characteristics 33 configured to mechanically and/or frictionally engage the plug, thereby mitigating the risk of unintended slippage through the pilot hole when exerting the ejection force onto the plug. The textural characteristics 33 can include, but are not limited to, frictional attributes, a stair stepped configuration, a threaded portion, ribs, dimples, coatings, grit, abrasive material, etc. Although illustrated in FIG. 1 as being positioned near the cutting tip 36 of the drill bit 30, it will be appreciated that the textural characteristics 33 may be positioned at various locations along the drill bit 30. For example, the textural characteristics 33 may extend along a portion or an entirety of the length and/or circumference of the intermediate portion 34.

The arbor 40 can include a shank 46 having a rear end 41 and an at least partially hollow front portion 46 with a larger diameter front bore 46a and a smaller diameter rear bore 46b, a holesaw holder 42 coupled to the front portion 46, a drill bit carrier 43 received in the front bore 46a, a biasing member 47 (e.g., a compression spring) received in the rear bore 46b of the hollow front portion 46 and extending partially into the front bore 46a, a retainer 58, and a switch assembly 45 including a collar or switch 48. The rear end 41 of the arbor 40 may be round or polygonal, e.g., hex shaped, in cross section and configured to be received in a tool holder or chuck of a power tool. The holesaw holder 42 can be configured to couple to the holesaw 20. The holesaw holder 42 may include a disc shaped base 42a and a threaded stem 42b coupled to the shank and configured to be received in a threaded opening in the base 22 of the holesaw 20. When the holesaw 20 is threaded onto the threaded stem 42b, the base 22 of the holesaw 20 abuts the disc shaped base 42a of the holesaw holder 42.

The drill bit carrier 43 accommodates the drill bit 30 and is configured to move between an extended position and a retracted position. The drill bit carrier 43 may hold the drill bit 30 non-rotatably in a blind bore 43a, e.g., by a set screw or by a non-circular geometry (e.g., a hex or double-D geometry) so that they rotate in unison. The arbor 40 cooperates with the drill bit carrier 43 through a coordinated interface mechanism 44 to enable and control the translational movement of the drill bit carrier 43, and thus the drill bit 30, relative to the arbor 40. For example, the coordinated interface mechanism 44 can permit the drill bit carrier 43 to move longitudinally within the front bore 46a of the shank 46, facilitating ingress and egress of the drill bit carrier 43, and thus the drill bit 30, in relation to the arbor 40.

The coordinated interface mechanism 44 may include elements such as guiding channels or tracks, aligned with corresponding projections, to support the movement of the drill bit carrier 43 relative to the arbor 40. For example, in referring to FIGS. 1-3, the coordinated interface mechanism 44 includes projections 52 (e.g., extended pins) on the drill bit carrier 43, which interact with a helical channel 51 defined in the front bore 46a within the arbor 40. This interaction is facilitated by the projections 52 engaging with the helical channel 51. As the arbor 40 rotates, the engagement causes the drill bit carrier 43 to follow the helical channel 51 inside the hollow shank 46, effectively converting rotational motion of the arbor 40 into linear movement of the drill bit carrier 43. Such a configuration allows for controlled ingress or egress of the drill bit carrier 43 in relation to the arbor 40. It will be appreciated that the coordinated interface mechanism 44 may vary across embodiments. For instance, in some configurations, the coordinated interface mechanism 44 can include grooves positioned on the drill bit carrier 43 and projections located inside the front bore 46a. Other examples of the coordinated interface mechanism 44 can include, but are not limited to, variations such as gear-like engagements, cam and follower mechanisms, lead screw and nut arrangements, or other configurations for translating rotational motion into linear positioning.

The arbor 40 can include the retainer 58 (e.g., a lateral pin), a lateral biasing member 53 (e.g., a spring and a peg), and a stop member 55 (e.g., a set screw) configured for releasably securing the drill bit carrier 43 in a retracted position. In some embodiments, the biasing member 53 is disposed between the stop member 55 and the retainer 58. Consequently, the biasing member 53 applies a force on the retainer 58, urging it towards the interior of the front bore 46a in the hollow shank 46. As shown, the arbor 40 can include a lateral aperture 57 through its sidewall, allowing access to the front bore 46a. At the outer end of this aperture 57, the stop member 55 is positioned, with the biasing member 53 and retainer 58 situated within the aperture 57.

The drill bit carrier 43 and the retainer 58 interact as the drill bit carrier 43 moves along the channel 51 in the front bore 46a, transitioning between extended and retracted positions. The retainer 58, positioned at an intermediate point within the front bore 46a, may allow movement of the drill bit carrier 43 in its extended position. As the drill bit carrier 43 moves towards the retracted position, the drill bit carrier 43 engages with the retainer 58, causing a temporary displacement of the retainer 58 to allow passage of the drill bit carrier 43. Once the drill bit carrier 43 has passed, the bias of the biasing member 53 biases the retainer 58 back into the front bore 46a, positioning the retainer 58 in front of the drill bit carrier 43, acting as a front stop to inhibit the drill bit carrier from moving back to the extended position. The retainer 58, when released, enables the drill bit carrier 43 to transition from the retracted position to the extended position, facilitating the ejection of a plug from the holesaw.

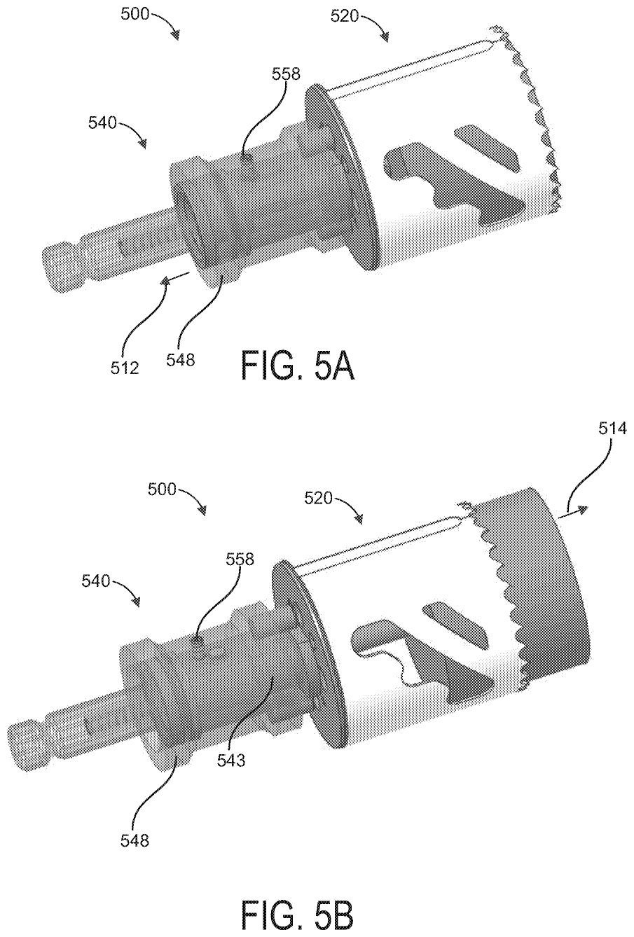

The collar or switch 48 is movably received over the shank 46. The collar or switch 48 is movable by a user axially along the shank 46 in a first direction 90 between a forward position (as shown in FIG. 5A) and a rearward position (as shown in FIG. 5B). The collar or switch 48 can be actuated by moving it in the first direction 90 to disengage the retainer 58, allowing unobstructed movement of the drill bit carrier 43 within the channel 51. In some embodiments, the collar or switch 48 may aid in transitioning the drill bit carrier 43 from a retracted position to an extended position by releasing the retainer 58 (e.g., moving the retainer 58 out of the channel 51).

The switch 48 can be designed for manual activation, which in some implementations involves an action similar to cocking. For example, when an operator manually slides the switch 48 in a first direction 90 along the arbor 40 (e.g., a direction proximal to the cutting edge 26 of the holesaw 20), this action translates into the movement of the retainer 58 relative to the drill bit carrier 43 and the arbor 40. The manual motion of the switch 48 in the first direction 90 causes the displacement of the retainer 58 from its position in the channel 51.

In some cases, as shown in FIGS. 1-3, the switch 48 can be implemented as a collar that at least partially encircles an exterior surface of the arbor 40 and/or the holesaw holder 42. In some such cases, the collar may be moveable between first and second positions, where movement of the collar along the arbor, from the first position to the second position, facilitates the release of the retainer 58. The collar can be removably engageable with a pair of drive pins 72 via apertures 73. The switch 48 and/or the drive pins 72 can be biased axially forward by spring 75, and the drive pins 72 can engage with lateral openings 29 of the base 22 of the holesaw 20. The drive pins 72 can inhibit or reduce the likelihood of the holesaw 20 coming unthreaded from the threaded stem of the holesaw holder 42 and can enhance torque transmission from the arbor 40 to the holesaw 20. The switch 48 can be configured for axial and/or rotational movement to retract the pins from the openings 29, such as to facilitate the disengagement of the retainer 58 and/or the installation or removal of the holesaw onto the holesaw holder 42.

The biasing member 47 can be configured to exert a force on the drill bit carrier 43, urging it towards an extended position. In certain embodiments, the biasing member 47 is implemented as a compression spring, positioned at the base of the rear bore 46b in the hollow shank 46. The drill bit carrier 43 is located atop the biasing member 47, allowing the biasing member 47 to influence the positioning of the drill bit 30. When the drill bit carrier 43 is in the retracted position and the retainer is disengaged from the channel 51 (e.g., via the switch 48), the biasing member 47 can actively bias the drill bit carrier 43 towards the extended position, facilitating the ejection of the plug by the drill bit 30. When the arbor 40 rotates in relation to the drill bit carrier 43, the coordinated interface mechanism 44 activates to facilitate ingress or egress of the drill bit carrier 43 in relation to the arbor 40. In the case of ingress movement, in which the drill bit carrier 43 retracts into the arbor 40, the movement of the drill bit carrier 43 overcomes the biasing force of, and compresses, the biasing member 47.

The characteristics of the biasing member 47, such as wire diameter, spring diameter, number of coils, coil pitch, material, spring index, end type, free length, and spring rate, can vary across embodiments. In some cases, the characteristics are selected to ensure that the biasing member 47 offers enough force to efficiently move the drill bit 30 from a retracted position to an extended position for effective plug ejection, while also preventing excessive force that could break through the plug, for instance, via the pilot hole.

The arbor 40 can operate in at least two modes: a first mode and a second mode. In the first mode, the drill bit carrier 43 and the holesaw holder 42 may be decoupled, allowing them to rotate independently of one another. Generally, since the holesaw holder 42 is held by the drill, the holesaw 20 rotates at the same speed as the drill. In some cases, the decoupling between the drill bit carrier 43 and the holesaw holder 42 allows the drill bit 30 to operate at a reduced rotational velocity relative to the holesaw 20. This difference in rotational speeds may facilitate the retraction of the drill bit 30 into the retracted position while allowing the holesaw 20 to continue rotating. As the drill bit 30 moves into the retracted position, the arbor 40 can operate in the second mode. In the second mode, the drill bit carrier 43 and the holesaw holder 42 are configured to rotate in unison with the arbor 40. In this way, the holesaw 20 and the drill bit carrier 43 rotate together for the subsequent cutting process.

In some embodiments, the first and second modes of the arbor 40 are based on a decoupling mechanism, implemented as a set of engagement members that facilitate the transition between the first and second modes. These engagement members, which may include pins, detents, and other similar components, can exhibit controlled radial and axial movements within the arbor 40. When the user initiates the saw operation by engaging the drill bit 30 with the workpiece, these engagement members spiral downward within the hollow shank 46 under the influence of an axial biasing force, typically provided by a spring. As they reach a predetermined position, they interact with specific features, such as locking notches or engagement grooves, within the hollow shank 46 to establish a securely coupled configuration. This arrangement ensures that the holesaw 20 and drill bit 30 are firmly coupled, allowing them to rotate together during their respective functions, thereby enhancing the efficiency and precision of the cutting process.

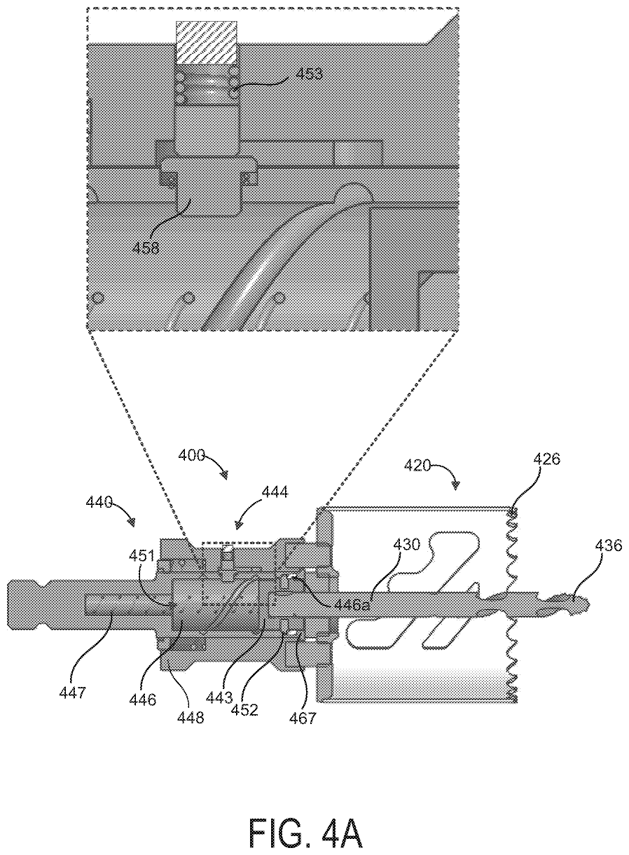

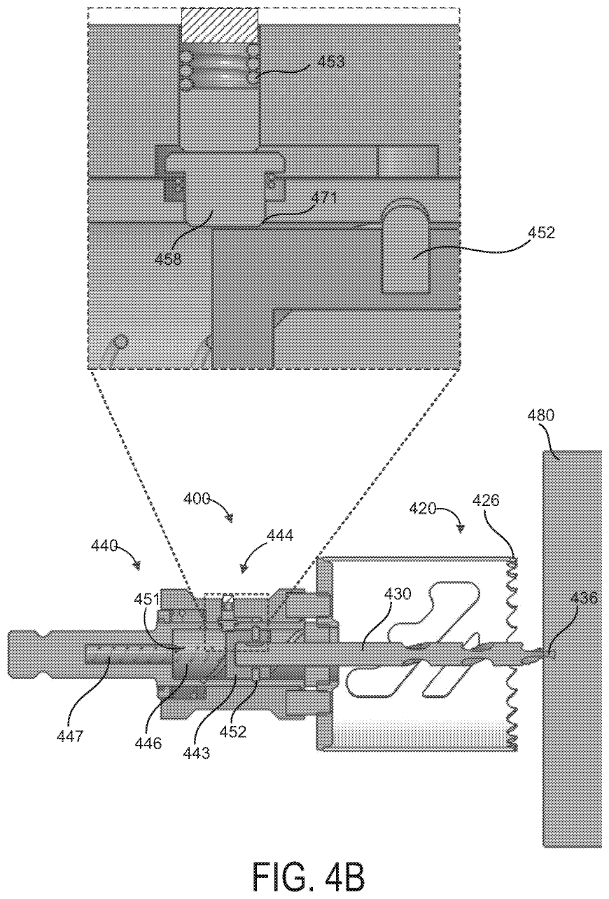

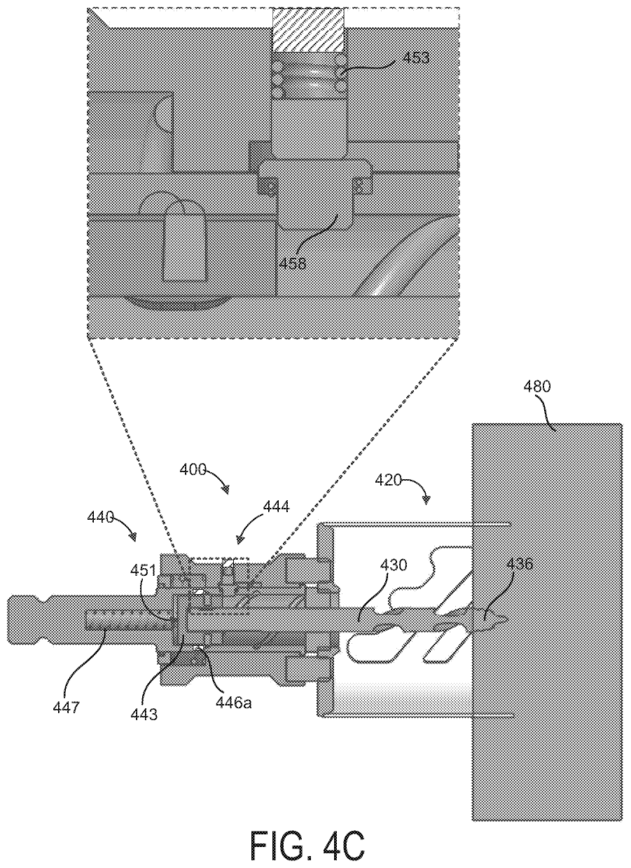

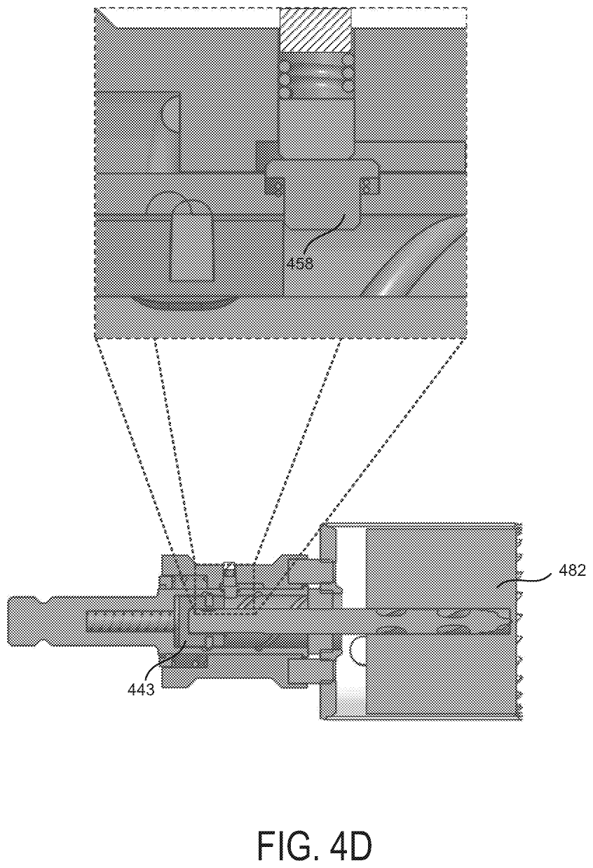

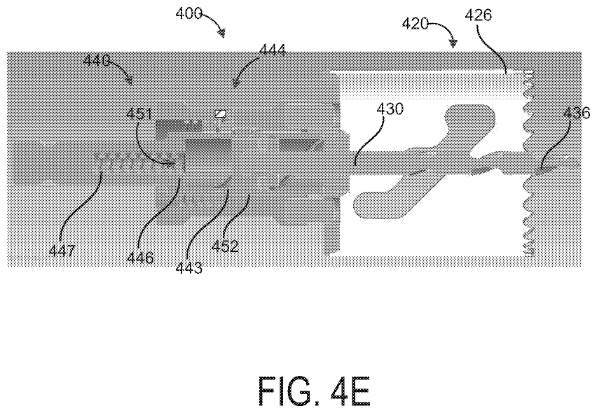

FIGS. 4A-4D illustrate another embodiment of a holesaw assembly 400 that includes a holesaw 420, a drill bit 430, an arbor 440, and a collar or switch 448 which may be similar to embodiments or incorporate features of the holesaw 20, the drill bit 30, the arbor 40, and/or the collar or switch 48 described above and shown in FIGS. 1-3, with reference numbers having a leading 4 indicating similar features except where otherwise indicated or as will be apparent to one of ordinary skill in the art. FIGS. 4A-4D also illustrate a sequential transition of a drill bit carrier 443 and/or a drill bit 430 within a holesaw assembly 400, demonstrating movement from an extended position to a retracted position.

FIG. 4A illustrates the drill bit 430 in an extended position, showing the cutting tip 436 of the drill bit 430 extending past the cutting edge 426 of the holesaw 420. In some cases, the extended position represents a maximum outward extension of the drill bit carrier 443 and the drill bit 430 within their range of motion, positioning the cutting tip 436 beyond the cutting edge 426 for initial engagement with a workpiece. In the extended position, the projections 452 on the drill bit carrier 443 may be situated at a first mechanical end stop within the channel 451 defined by a hollow shank 446 within the arbor 440, indicating the limit of the forward travel of these components. As shown, when in the extended position, the drill bit carrier 443 is located proximate a distal end 467 of the arbor 440 and does not interact with the retainer 458. As such, the retainer 458, biased by the biasing member 453, extends into the channel 451.

As described herein, the drill bit carrier 443 and/or the drill bit 430 are movable between a retracted position and an extended position, which allows the drill bit 430 to be positioned to extend and form a pilot hole or retract to assist in ejecting a resultant plug from the holesaw 420. The configuration of the holesaw assembly 400 in the extended position allows an operator to use the drill bit 430 to create a pilot hole in a workpiece. In an extended position, the drill bit 430 is positioned forward, past the cutting edge 426 of the holesaw 420, to enable it to drill a shallow pilot hole in the workpiece, before the cutting edge 426 of the holesaw 420 engages the workpiece. This initial engagement of the drill bit 430 with the workpiece inhibits wandering or slipping when the cutting edge 426 of the holesaw 420 first makes contact with the workpiece, providing a stable point of entry for the cutting action that follows.

In FIG. 4B, the drill bit 430 is located in an intermediate position between the extended position depicted in FIG. 4A and the retracted position depicted in FIG. 4C. In this configuration, the cutting tip 436 of the drill bit 430 continues to extend beyond the cutting edge 426 of the holesaw 420 while establishing contact with the workpiece 480. The intermediate or partial retraction observed here can be attributed to a reactive force exerted by the workpiece 480 against the drill bit 430 and/or the activation of the coordinated interface mechanism 444. The intermediate or partial retraction is part of the operational process, facilitating the transition from drilling the pilot hole to the commencement of a main cutting action by the holesaw 420.

Upon initiating the cutting operation, the user applies pressure to the drill bit 430 against the workpiece, which actuates the transition (e.g., retraction) of the drill bit 430 from the extended position toward a retracted position. This movement of the drill bit 430 is initiated as the user applies pressure and rotates the drill, which in turn rotates the arbor 440. This rotational force engages the drill bit 430 to retract into the arbor 440 (e.g., toward the power tool).

During retraction, the projections 452 situated on the drill bit carrier 443 follow the course of the channel 451, resulting in the gradual withdrawal of the drill bit carrier 443 along the channel 451. Here, the drill bit carrier 443 has withdrawn into the channel 451 to the point where the drill bit carrier 443 makes contact with the retainer 458, initiating the process of gradually displacing the retainer 458 from its position within the channel 451. In some cases, the contact surface 471 at the juncture of the retainer 458 and the drill bit carrier 443 may include an edged or ramped configuration. In some such cases, when the drill bit carrier 443 encounters the retainer 458 during its motion, the presence of the edged or ramped configuration can enable a controlled interaction. For example, instead of an abrupt collision that might impede the motion of the drill bit carrier 443, the edged or ramped configuration can allow the drill bit carrier 443 to maneuver beneath an edge of the retainer 458. In doing so, the drill bit carrier 443 overcomes the opposing force exerted by the biasing member 453, which functions as a spring pushing the retainer 458 towards the channel 451. This movement results in the upward displacement of the retainer 458 from its position within the channel 451.

FIG. 4C illustrates the drill bit 430 in a retracted position. In some cases, the retracted position represents a state in which both the drill bit carrier 443 and the drill bit 430 have reached their furthest extent into the arbor 440, retracting to the point where the cutting tip 436 of the drill bit 430 no longer extends beyond the cutting edge 426 of the holesaw 420. For instance, the projections 452 within the channel 451 may have reached a second mechanical end stop, signifying the limit of their backward travel.

In the retracted position, the drill bit carrier 443 has descended along the channel 451, moving past the retainer 458. As a result, the drill bit carrier 443 may cease to exert force on the retainer 458, allowing the retainer 458 to move back into the channel 451 as a result of the bias of the biasing member 447. Additionally, the retainer 458 may serve as a stop, inhibiting extension of the drill bit carrier 443 away from the arbor 440, thereby inhibiting movement towards the extended position. In the retracted position, the holesaw 420 remains operable for cutting operations.

In some cases, in the retracted position, the drill bit 430 is retracted to establish a clearance gap between its tip and the workpiece. Such a gap can allow the drill bit 430 to build momentum before impacting the plug, facilitating an effective ejection. In some cases, no clearance gap is created and the tip of the drill bit 430 may remain substantially flush with the material or even partially within the pilot hole, which can facilitate the direct transfer of force to eject the plug.

In FIG. 4D, the spring 53a and the peg 53b of the biasing member 453 bias the pin or retainer 458 radially inward to abut a front end of the drill bit carrier 443. This helps hold the drill bit carrier 443 in the retracted position, so that the drill bit 430 continues to remain in the retracted position, while the holesaw 420 carries on with its cutting operation. This cutting process ultimately leads to the formation and capture of a plug 482 within the holesaw 420. Once the cutting operation is complete, the user can pull the collar or switch 448 axially rearward along arrow C. This causes the spring 53a and the peg 53b of the biasing member 453 to become disengaged from the pin or retainer 458, enabling disengagement of the pin or retainer 458 from the front end of the drill bit carrier 443. Once disengaged, the spring or biasing member 447 pushes the drill bit carrier 443 so that it moves rotationally and axially forward along the channel 451 to help eject the plug 482 from the holesaw 420, as shown in FIG. 4E.

FIGS. 5A and 5B illustrate another embodiment of a holesaw assembly 500 that includes a holesaw 520, a drill bit (hidden), an arbor 540, and a collar or switch 548 which may be similar to embodiments or incorporate features of the holesaw 20, the drill bit 30, the arbor 40, and/or the collar or switch 48 described above and shown in FIGS. 1-3 and/or the holesaw 420, the drill bit 430, the arbor 440, and/or the collar or switch 448 described above and shown in FIGS. 4A-4E, with reference numbers having a leading 5 indicating similar features except where otherwise indicated or as will be apparent to one of ordinary skill in the art.

With the drill bit in a retracted position, similar to the depiction of the holesaw assembly 400 in FIG. 4D, the holesaw assembly 500 may be an embodiment or incorporate features of the holesaw assembly 100 or 400.

Referring to FIG. 5A, the holesaw 520 encases a plug within its interior. Furthermore, the holesaw assembly 500 includes a switch 548 for transitioning the holesaw assembly 500 from a retracted position to an extended position. In this way, the switch 548 may be functional to eject a plug from the internal space of the holesaw.

In this example, the switch 548 is positioned about on the arbor 540 and houses a retainer 558, similar to retainer 558 of FIGS. 5A-5B. The switch 548 can be manually activated. In some implementations, this activation involves an action akin to cocking. For example, when an operator manually slides the switch 548 in a first direction 512 along the arbor, this motion can translate to the movement of the retainer 558 relative to the drill bit carrier 543 and the arbor 540. The movement of the switch 548 in the first direction displaces the retainer 558 from its position in the channel. This displacement enhances functionality of the holesaw assembly, similar to the process illustrated in FIG. 5B.

By shifting the retainer 558, the switch 548 removes the physical constraint that holds the drill bit carrier 543 in its retracted position. This removal is helpful for allowing the drill bit carrier 543 to transition, driven by internal biasing forces, from a retracted state to an extended position. This transition is integral to the next stages of operation of the holesaw assembly, particularly in tasks involving the engagement of the drill bit with the workpiece or the ejection of material from the holesaw.

FIG. 5B illustrates the drill bit in an extended position following the activation of the switch 548. During the transition from the retracted position to the extended position, the drill bit engages with the plug, assisting in the dislodging of the plug from the holesaw 520, pushing the plug in the second direction 514.

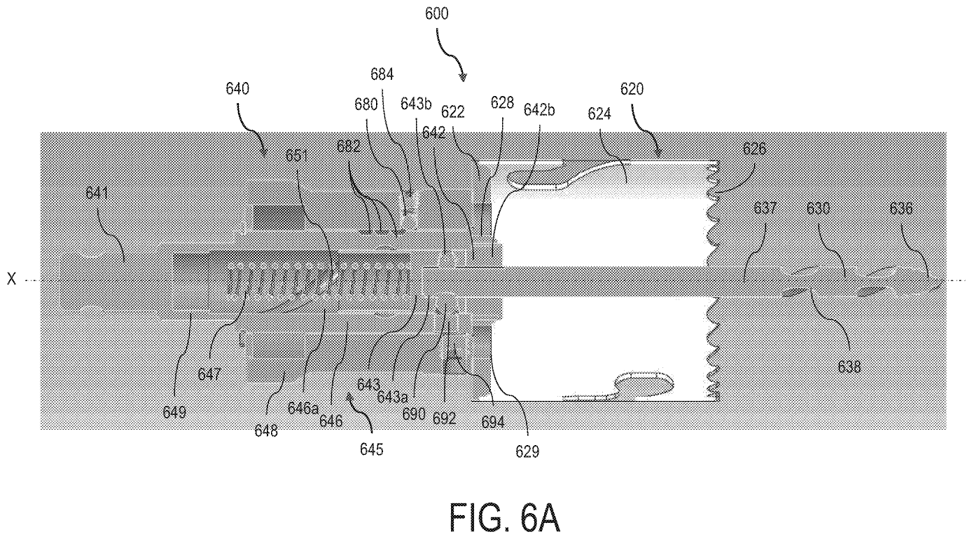

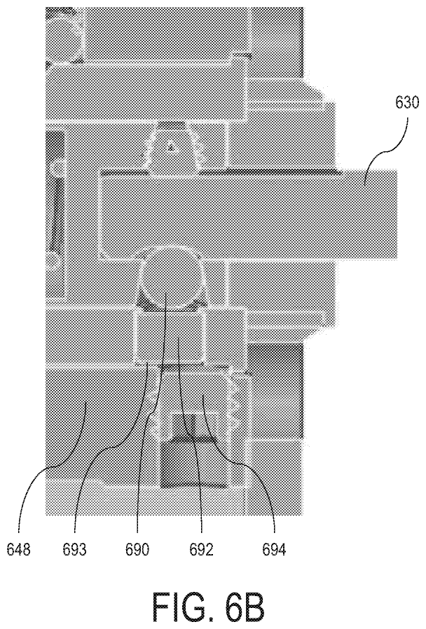

FIGS. 6A-10B illustrate another embodiment of a holesaw assembly 600 that includes a holesaw 620, a drill bit 630, an arbor 640, and a switch assembly 645 including a collar or switch 648, which may be similar to embodiments or incorporate features of the holesaw 20, the drill bit 30, the arbor 40, and the switch assembly 45 including the collar or switch 48 described above and shown in FIGS. 1-3, with reference numbers having a leading 6 indicating similar features except where otherwise indicated or as will be apparent to one of ordinary skill in the art. As described herein, the holesaw assembly 600 can facilitate the ejection of a plug from within an internal space in the holesaw 620 and quick release of the holesaw 620 and the drill bit 630 from the arbor 640, all without the use of additional tools.

The holesaw 620 includes a base 622 and a wall 624 coupled to the base 622. The wall 624 can include a proximal end coupled to the base 622 and a distal end terminating in a cutting edge 626, which may include a plurality of teeth or cutters. The base 622 may include a central opening 628, which may be threaded, and one or more lateral openings 629. The base 622 can assume a generally circular shape, and the wall 624 can assume a generally cylindrical form, thus resulting in the holesaw 620 delineating a generally cylindrical internal space. When rotatably driven by the arbor 640, the holesaw 620 is configured to form a generally circular hole in a workpiece by removing a resultant plug of material from the workpiece that is received inside the internal space within the wall 624.

The drill bit 630 includes a cutting tip 636 and an elongate shaft portion 637. The elongate shaft portion 637 can include a rear end portion couplable to the arbor 640 and an intermediate portion between the rear end portion and the cutting tip 636. The intermediate portion can include at least one helical flute 638 for removing debris and cutting chips. The drill bit 630 can be used for both creating a pilot hole in a workpiece and facilitating the ejection of a plug from the internal space in the holesaw 620. For example, during the operation of holesaw 620, the drill bit 630 can create the pilot hole, the holesaw can engage the workpiece and form a larger hole, and the drill bit can retract into arbor 640. Depending on characteristics of the workpiece, such as hardness, or type of material, the formation of the pilot hole, the engagement of the holesaw with the workpiece, and the retraction of the drill bit into the arbor can occur in any sequence or one or more of these steps may occur simultaneously. Subsequently, the drill bit 630 can be extended or projected from arbor 640 to apply an ejection force on a plug, if present, lodged within internal space. In some cases, the drill bit 630 can include textural characteristics configured to mechanically and/or frictionally engage the plug, thereby mitigating the risk of unintended slippage through the pilot hole when exerting the ejection force onto the plug. The textural characteristics can include, but are not limited to, frictional attributes, a stair stepped configuration, a threaded portion, ribs, dimples, coatings, grit, abrasive material, etc.

The arbor 640 includes a shank 649 having a rear end 641 and an at least partially hollow front portion 646 with a bore 646a, a holesaw holder 642 coupled to the front portion 646, a drill bit carrier 643 received in the front bore 646a, a biasing member 647 (e.g., a compression spring) received in the bore 646a of the hollow front portion 646 and extending partially into the front bore 646a, and a collar or switch 648. The rear end 641 of the arbor 640 may be round or polygonal, e.g., hex shaped, in cross section and configured to be received in a tool holder or chuck of a power tool. The holesaw holder 642 can be configured to couple to the holesaw 620. The holesaw holder 642 may include a disc shaped base and a threaded stem 642b coupled to the shank and configured to be received in a threaded opening 628 in the base 622 of the holesaw 620. When the holesaw 620 is threaded onto the threaded stem 642b, the base 622 of the holesaw 620 abuts the disc shaped base of the holesaw holder 642.

The drill bit carrier 643 accommodates the drill bit 630 in a blind bore 643a and is configured to move between an extended position (as shown in FIG. 6A) and a retracted position (as shown in FIG. 6B). The drill bit carrier 643 non-rotatably holds the drill bit 630 in the blind bore 643a, e.g., by a set screw 643b with a flat surface or by a non-circular geometry (e.g., a hex or double-D geometry) so that they rotate in unison. The drill bit 630 is releasably retained in the drill bit carrier 643 in the axial direction by a retaining ball 690 that engages a groove in the drill bit 630, as described in more detail below.

The arbor 640 cooperates with the drill bit carrier 643 through a coordinated interface mechanism 644 to enable and control the translational movement of the drill bit carrier 643, and thus the drill bit 630, relative to the arbor 640. For example, the coordinated interface mechanism 644 can permit the drill bit carrier 643 to move longitudinally within the bore 646a, facilitating ingress and egress of the drill bit carrier 643, and thus the drill bit 630, in relation to the arbor 640.

The coordinated interface mechanism 644 may include elements such as guiding channels or tracks 651, aligned with corresponding projections, to support the movement of the drill bit carrier 643 relative to the arbor 640. For example, the coordinated interface mechanism 644 includes projections (e.g., extended pins) on the drill bit carrier 643, which interact with the track 651 in the form of a helical channel defined in the bore 646a. As the arbor 640 rotates, the engagement causes the drill bit carrier 643 to follow the track 651 inside the hollow shank 649, effectively converting rotational motion of the arbor 640 into linear movement of the drill bit carrier 643. Such a configuration allows for controlled ingress or egress of the drill bit carrier 643 in relation to the arbor 640. It will be appreciated that the coordinated interface mechanism 644 may vary across embodiments. For instance, in some configurations, the coordinated interface mechanism 644 can include grooves positioned on the drill bit carrier 643 and projections located inside the bore 646a. Other examples of the coordinated interface mechanism 644 can include, but are not limited to, variations such as gear-like engagements, cam and follower mechanisms, lead screw and nut arrangements, or other configurations for translating rotational motion into linear positioning.

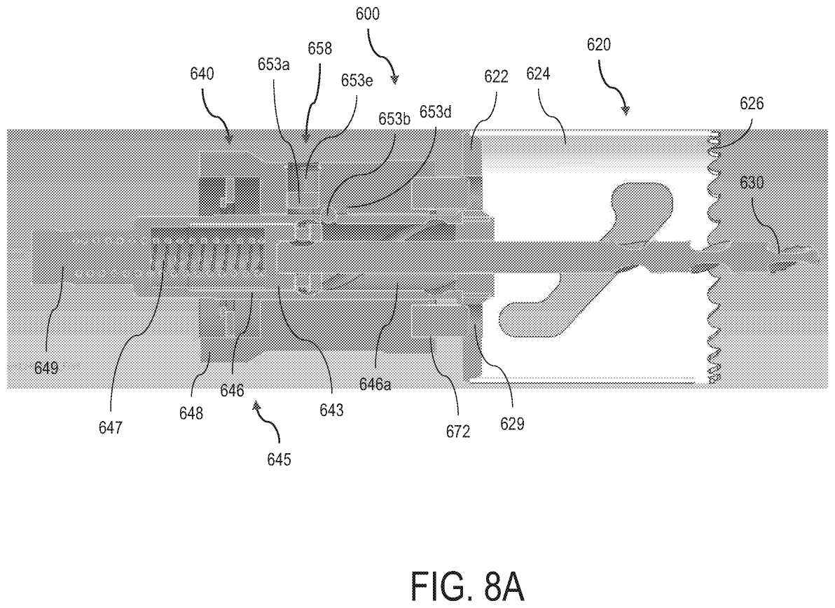

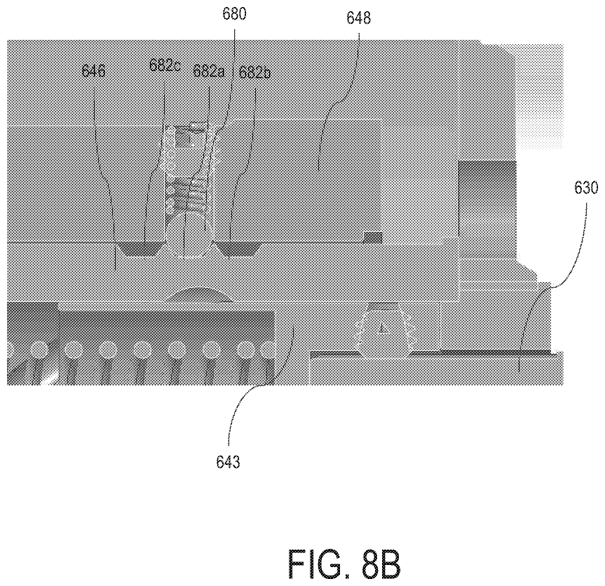

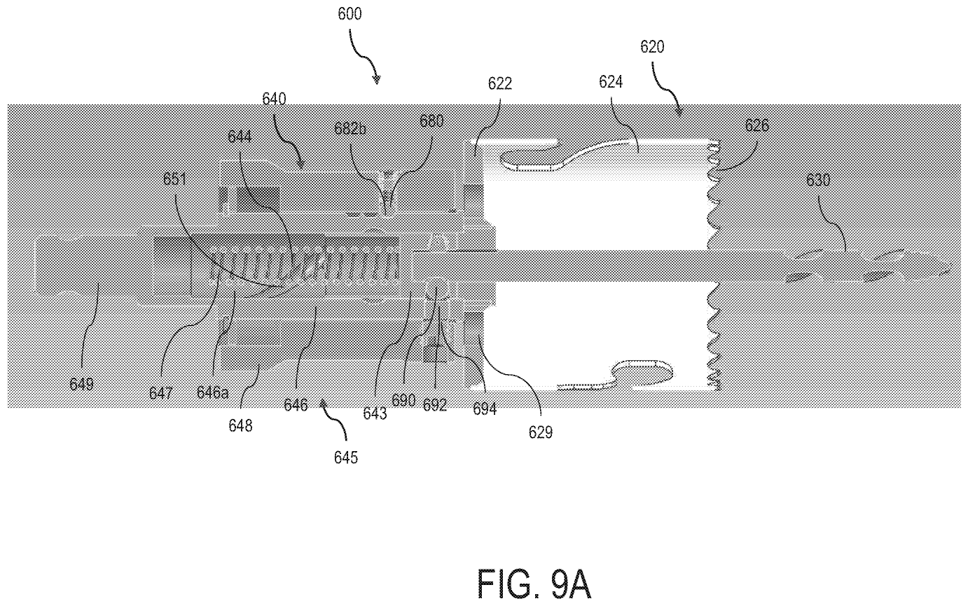

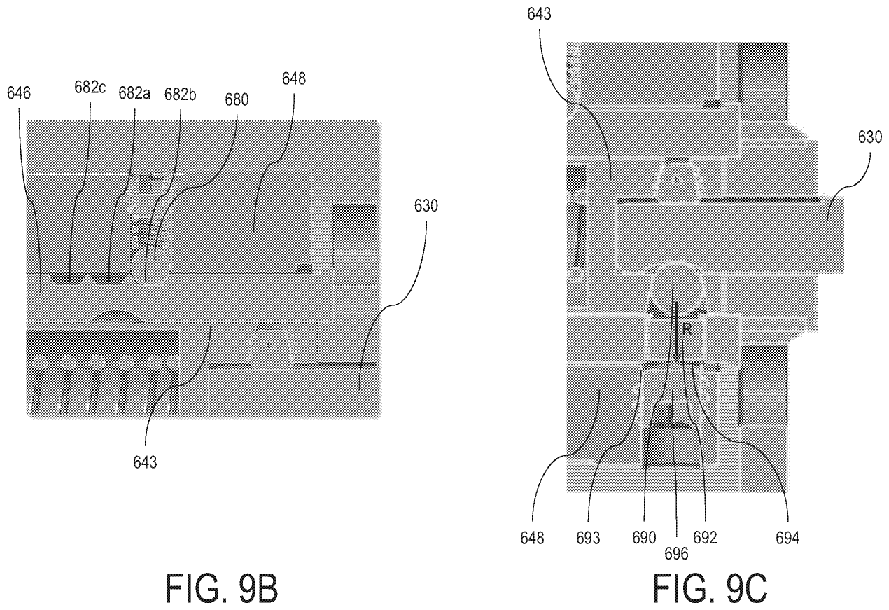

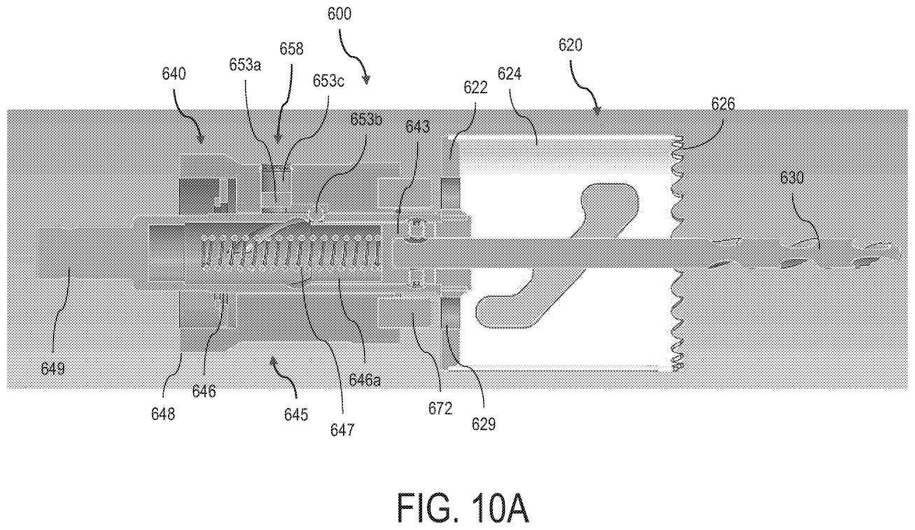

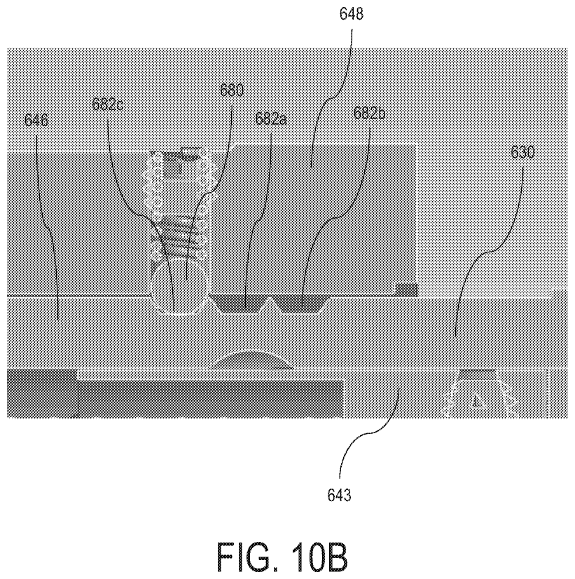

The collar or switch 648 at least partially surrounds the shank 649 and is movably received over the shank 649. The collar or switch 648 is movable by a user axially along the shank 649 along axis X among multiple positions, e.g., a first position (as shown in FIG. 6A), a second position (as shown in FIGS. 8A and 8B), a third position (as shown in FIGS. 9A-9C), and a fourth position (as shown in FIGS. 10A and 10B). The shank 649 may include a plurality of grooves 682 corresponding to these positions (e.g., no groove for the first position, groove 682a for the second position, groove 682b for the third position, and groove 682c for the fourth position) and the collar or switch 648 may carry a ball 680 biased radially inward by a spring 684 to engage the grooves 682 and retain the collar or switch 648 in the desired position. The collar or switch 648 optionally may carry a pair of drive pins 672 that are removably receivable in lateral openings 629 in the base of the holes 620. The drive pins 672 can inhibit or reduce the likelihood of the holesaw 620 coming unthreaded from the threaded stem of the holesaw holder 642 and can enhance torque transmission from the arbor 640 to the holesaw 620. The collar or switch 648 can be configured for axial and/or rotational movement to retract the pins from the openings 629, such as to facilitate installation or removal of the holesaw onto the holesaw holder 642, as discussed further below.

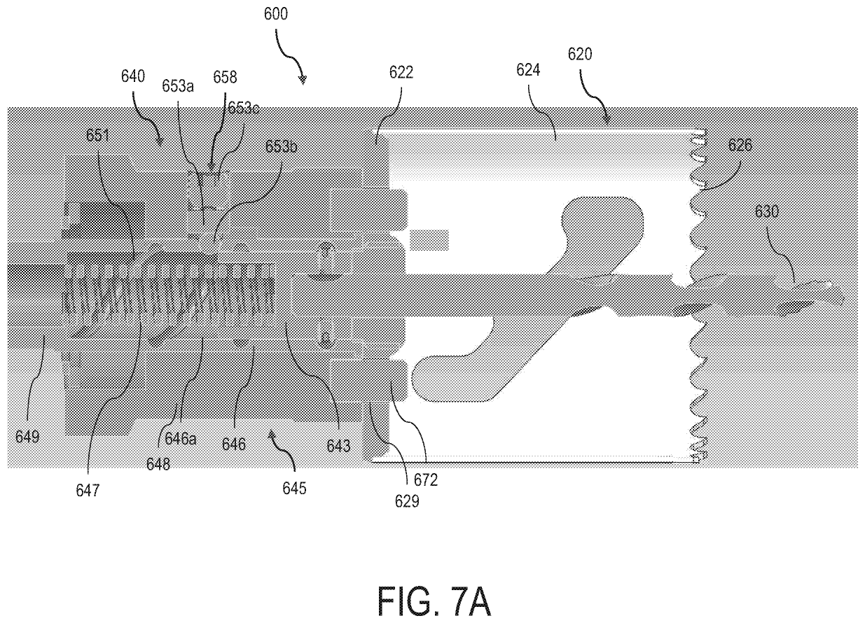

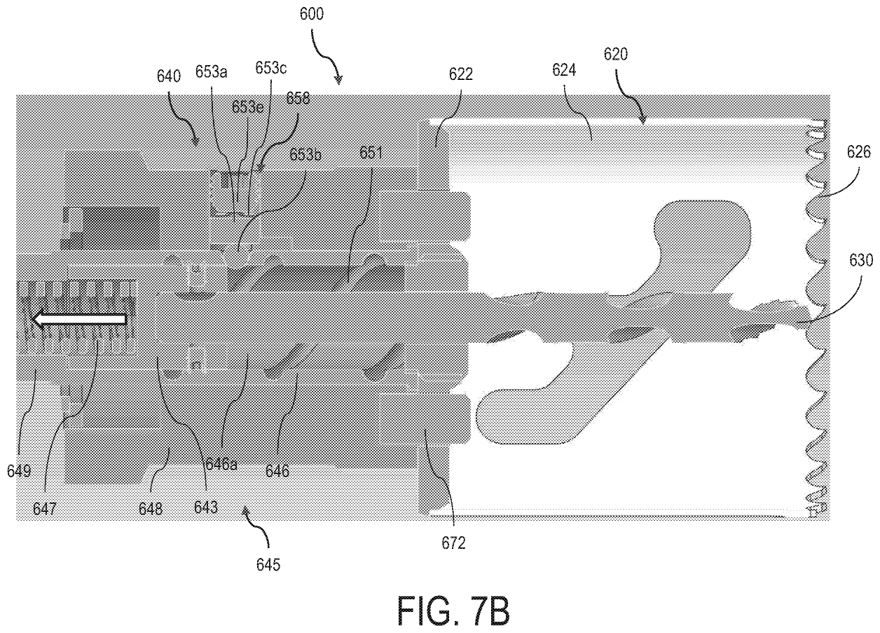

The arbor 640 also may include a retention assembly 658 configured for releasably securing the drill bit carrier 643 in a retracted position. In an example, the retention assembly 658 includes a ball 653b received in a lateral bore in the shank 649, a plunger 653a, a biasing member 653c (e.g., a spring), and a stop member 653e (e.g., a set screw) that retains the plunger 653a and the biasing member 653c in the collar or switch 648. When the collar or switch 648 is in the first position (as shown in FIG. 7A), the biasing member 653c is aligned with the ball 653b to bias the ball radially inward. The drill bit carrier 643 and the retention assembly 658 interact as the drill bit carrier 643 moves along the track 651 in the bore 646a, transitioning between the extended position (FIG. 7A) and the retracted position (FIG. 7B). As the drill bit carrier 643 moves towards the retracted position, the drill bit carrier 643 engages with the ball 653b, causing a temporary displacement of the ball 653b to allow passage of the drill bit carrier 643. Once the drill bit carrier 643 has passed, the bias of the biasing member 653c biases the ball 653b back into the bore 646a, positioning the ball 653b in front of the drill bit carrier 643, acting as a front stop to inhibit the drill bit carrier from moving back to the extended position.

The biasing member 647 can be configured to exert a force on the drill bit carrier 643, urging it towards an extended position. In certain embodiments, the biasing member 647 is implemented as a compression spring, positioned at the base of the bore 646a. The drill bit carrier 643 is located atop the biasing member 647, allowing the biasing member 647 to influence the positioning of the drill bit carrier 643. When the drill bit carrier 643 is in the retracted position and the retainer is disengaged from the track 651 (e.g., via the collar or switch 648, as described below), the biasing member 647 can actively bias the drill bit carrier 643 towards the extended position, facilitating the ejection of the plug by the drill bit 630. When the arbor 640 rotates in relation to the drill bit carrier 643, the coordinated interface mechanism 644 activates to facilitate ingress or egress of the drill bit carrier 643 in relation to the arbor 640. In the case of ingress movement, in which the drill bit carrier 643 retracts into the arbor 640, the movement of the drill bit carrier 643 overcomes the biasing force of, and compresses, the biasing member 647.

The characteristics of the biasing member 647, such as wire diameter, spring diameter, number of coils, coil pitch, material, spring index, end type, free length, and spring rate, can vary across embodiments. In some cases, the characteristics are selected to ensure that the biasing member 647 offers enough force to efficiently move the drill bit carrier 643 and the drill bit 630 from the retracted position to the extended position for effective plug ejection, while also preventing excessive force that could break through the plug, for instance, via the pilot hole.

The holesaw assembly 600 is configured to be operable in four modes that correspond to four positions of the collar or switch 648. In the first mode, the collar or switch 648 is in the first or forwardmost position, as shown in FIGS. 6A-7B. In this mode, the drill bit 630 is axially retained in the drill bit carrier 643 by the ball 690 that engages a groove in the drill bit 630 and a disc 692 that engages the ball 690. The ball 690 is held in the groove by the disc 692 that engages a shoulder on the inside of the collar or switch 648. The holesaw 620 is also retained on the threaded stem 642b of the arbor 640 by the pins 672. In addition, the drill bit carrier 643 and the shank 649 are initially rotationally decoupled, allowing them to rotate independently of one another. The shank 649 is received in and rotated by a tool holder (e.g., a chuck) of a power tool (e.g., a drill, a drill/driver, a screwdriver, or an impact driver) such that the shank 649 and the holesaw 620 rotate at the same speed as the tool holder of the power tool. The rotational decoupling between the drill bit carrier 643 and the shank 649 allows the drill bit 630 to rotate at a different (e.g., reduced) rotational velocity relative to the holesaw 620. This difference in rotational speeds may facilitate the retraction of the drill bit 630 into the retracted position while allowing the holesaw 620 to continue rotating. As the drill bit 630 and drill bit carrier 643 move into the fully retracted position, as shown in FIG. 7B, the ball 653b engages the drill bit carrier 643 to retain the drill bit carrier 643 in the retracted position, allowing the drill bit carrier 643 and the shank 649 to rotate in unison for the subsequent cutting process to form a hole in a workpiece with the holesaw 620.

In the second mode, as shown in FIGS. 8A-8B, the collar or switch 648 is positioned axially in the second position, axially rearward of the first position, so the ball 680 engages the first groove 682b in the shank 649. The holesaw 620 remains retained on the threaded stem 642b of the arbor 640 by the pins 672. In this mode, the biasing member 653c (e.g., a spring) the stop member 653e and the plunger 653a of the retention assembly 658 are no longer aligned with the ball 653b, and the ball is allowed to move radially outward into a pocket 653d in the collar or switch 648. The ball 653b no longer acts as a front stop for the drill bit carrier 643 and allows the drill bit carrier to move forward to the extended position. Once disengaged, the spring or biasing member 647 pushes the drill bit carrier 643 forward so that it moves rotationally and axially forward along the track 651 to help at least partially eject the plug from the holesaw 620.

In the third mode, as shown in FIGS. 9A-9C, the collar or switch 648 is positioned axially in the third position so the ball 680 engages the second groove 682a in the shank 649. As illustrated, the second groove 682b is axially forward of the first groove 682 so that the third position is between the first position and the second position, but in other embodiments, the third position may be rearward of the second position with the second groove rearward of the first groove. The holesaw 620 remains retained on the threaded stem 642b of the arbor 640 by the pins 672. The ball 690 that retains the drill bit 630 in the drill bit carrier 643 in the second position is enabled to move radially outward in the direction R by the disc 692 being able to move radially into a space 694 in front of the shoulder 693, the space 694 being defined by a set screw 696. This movement allows the ball 690 to be disengaged from the groove in the drill bit 630, allowing the drill bit to be removed from the arbor without the use of a secondary tool.

In the fourth mode, as shown in FIGS. 10A-10B, the collar or switch 648 is positioned axially in the fourth position, axially rearward of the third position, so the ball 680 engages the third groove 682c in the shank 649. In this position, the pins 672 on the collar or switch 648 are disengaged from the openings 629 in the base of the holesaw, which allows the holesaw 620 to be unthreaded and removed from the arbor 640.

Numerous modifications may be made to the exemplary implementation of the holesaw assembly 600 described above. For example, the shank may have a fourth groove engageable by the ball 680 to retain the collar or switch 648 in the first position or may have fewer grooves or no grooves and no ball to engage the grooves. One or more of the balls may be replaced or supplemented by other structures such as pins, projections, detents, etc. One or more of the modes may be combinable into a single position or may be re-ordered in sequence. For example, the third mode for ejecting the plug from a holesaw and the fourth mode for removing the holesaw from the arbor may be combined into a single mode and position of the collar and switch. In another example, the second mode for removing the drill bit and the third mode for ejecting a plug may be reversed so that in the second position of the collar, the plug may be ejected and in the third position of the collar, the drill bit may be removable. In yet another embodiment, there may not be a quick change for releasing the drill bit without a secondary tool. In yet another embodiment, the switch assembly may include two or more switches or collars, which may be movable in the same or different directions. These and other implementations are within the scope of this application.

FIGS. 11-14B illustrate another embodiment of a holesaw assembly 700 that includes a holesaw 720, a drill bit 730, and an arbor 740, which may be similar to embodiments or incorporate features of the holesaws 20, 620 the drill bits 30, 630, and the arbors 40, 640, described above, except as otherwise described below, with reference numbers having a leading 7 indicating similar features except where otherwise indicated or as will be apparent to one of ordinary skill in the art. As described herein, the holesaw assembly 700 can facilitate the ejection of a plug from within an internal space in the holesaw 720 and quick release of the holesaw 720 and the drill bit 730 from the arbor 740, all without the use of additional tools.

The holesaw 720 includes a base 722 and a wall 724 coupled to the base 722. The wall 724 can include a proximal end coupled to the base 722 and a distal end terminating in a cutting edge 726, which may include a plurality of teeth or cutters. The base 722 may include a central opening 728, which may be threaded, and one or more lateral openings 729. The base 722 can assume a generally circular shape, and the wall 724 can assume a generally cylindrical form, thus resulting in the holesaw 720 delineating a generally cylindrical internal space. When rotatably driven by the arbor 740, the holesaw 720 is configured to form a generally circular hole in a workpiece by removing a resultant plug of material from the workpiece that is received inside the internal space within the wall 724.

The drill bit 730 includes a cutting tip 736 and an elongate shaft portion 737. The elongate shaft portion 737 can include a rear end portion couplable to the arbor 740 and an intermediate portion between the rear end portion and the cutting tip 736. The intermediate portion can include at least one helical flute 738 for removing debris and cutting chips. The drill bit 730 can be used for both creating a pilot hole in a workpiece and facilitating the ejection of a plug from the internal space in the holesaw 720. For example, during the operation of holesaw 720, the drill bit 730 can create the pilot hole, the holesaw can create a larger hole, and the drill bit can retract into arbor 740. Depending on characteristics of the workpiece, such as hardness, or type of material, the formation of the pilot hole, the engagement of the holesaw with the workpiece, and the retraction of the drill bit into the arbor can occur in any sequence or one or more of these steps may occur simultaneously. Subsequently, after completion of the operation on the workpiece, the drill bit 730 can be extended or projected from arbor 740 to apply an ejection force on a plug, if present, lodged within internal space. In some cases, the drill bit 730 can include textural characteristics configured to mechanically and/or frictionally engage the plug, thereby mitigating the risk of unintended slippage through the pilot hole when exerting the ejection force onto the plug. The textural characteristics can include, but are not limited to, frictional attributes, a stair stepped configuration, a threaded portion, ribs, dimples, coatings, grit, abrasive material, etc.

The arbor 740 includes a shank 749 having a rear end 741 and an at least partially hollow front portion 746 with a bore 746a, a holesaw holder 742 coupled to the front portion 746, a drill bit carrier 743 received in the front bore 746a, a biasing member 747 (e.g., a compression spring) received in the bore 746a of the hollow front portion 746 and extending partially into the front bore 746a, and a switch assembly 745 including a first collar or switch 748 and a second collar or switch 702. The rear end 741 of the arbor 740 may be round or polygonal, e.g., hex shaped, in cross section and configured to be received in a tool holder or chuck of a power tool. The holesaw holder 742 can be configured to couple to the holesaw 720. The holesaw holder 742 may include a disc shaped base and a threaded stem 742b coupled to the shank and configured to be received in a threaded opening 728 in the base 722 of the holesaw 720. When the holesaw 720 is threaded onto the threaded stem 742b, the base 722 of the holesaw 720 abuts the disc shaped base of the holesaw holder 742.

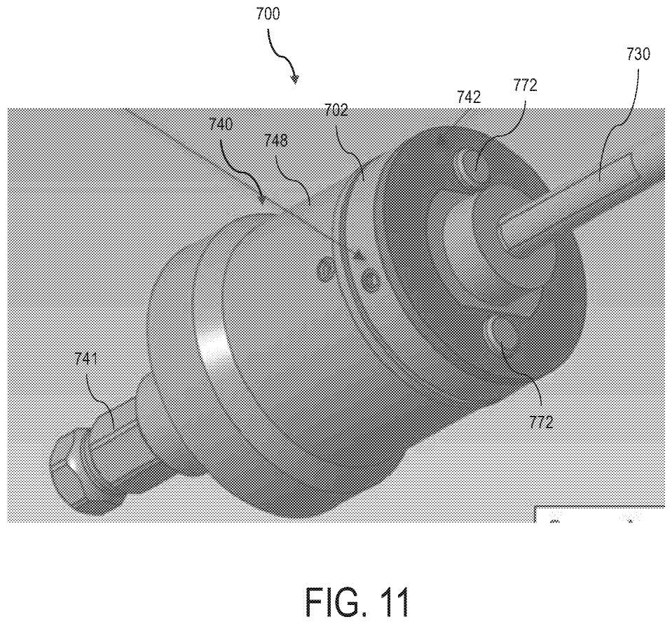

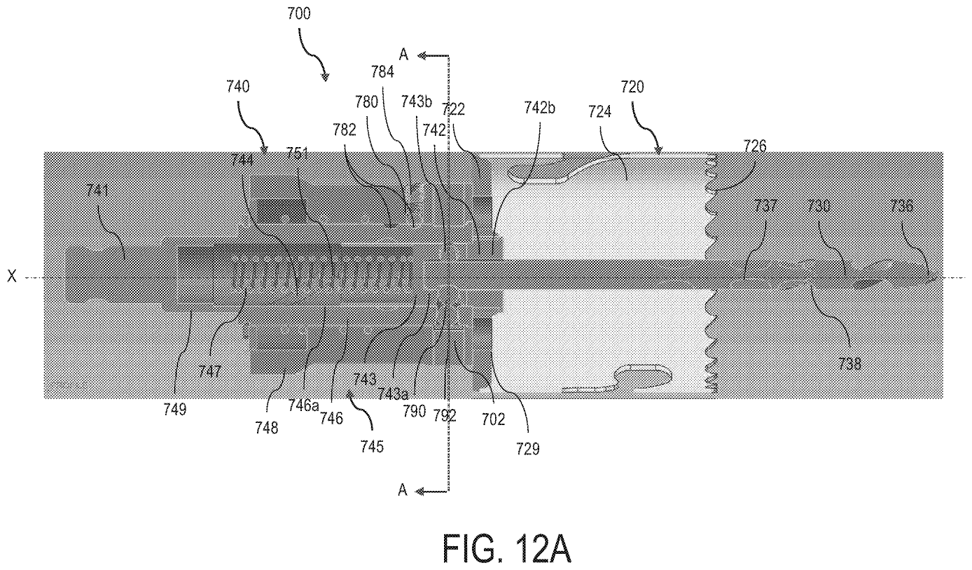

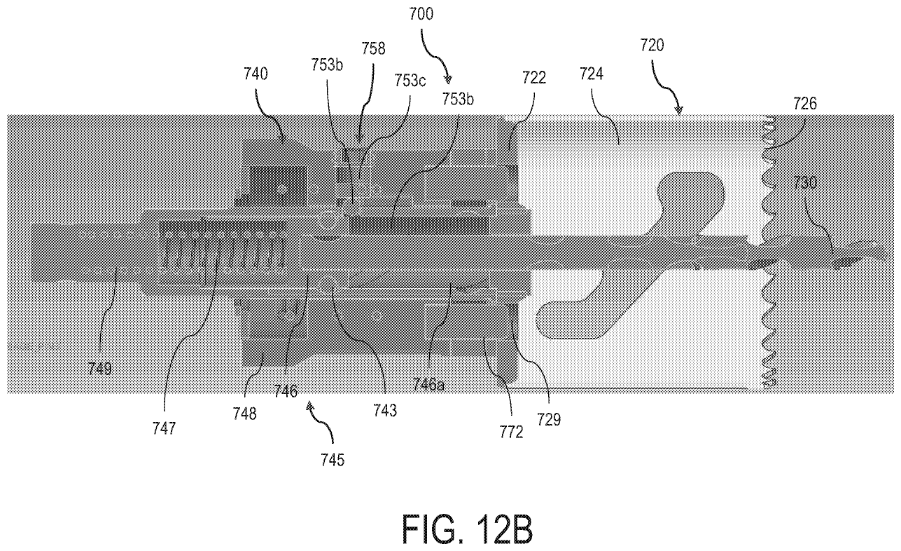

The drill bit carrier 743 accommodates the drill bit 730 in a blind bore 743a and is configured to move between an extended position (as shown in FIG. 12A) and a retracted position (as shown in FIG. 12B). The drill bit carrier 743 non-rotatably holds the drill bit 730 in the blind bore 743a, e.g., by a set screw 743b with a flat surface or by a non-circular geometry (e.g., a hex or double-D geometry) so that they rotate in unison. The drill bit 730 is releasably retained in the drill bit carrier 743 in the axial direction by a retaining ball 790 that engages a groove in the drill bit 730, as described in more detail below.

The arbor 740 cooperates with the drill bit carrier 743 through a coordinated interface mechanism 744 to enable and control the translational movement of the drill bit carrier 743, and thus the drill bit 730, relative to the arbor 740. For example, the coordinated interface mechanism 744 can permit the drill bit carrier 743 to move longitudinally within the bore 746a, facilitating ingress and egress of the drill bit carrier 743, and thus the drill bit 730, in relation to the arbor 740.

The coordinated interface mechanism 744 may include elements such as a guiding channel or track 751, aligned with corresponding projections, to support the movement of the drill bit carrier 743 relative to the arbor 740. For example, the coordinated interface mechanism 744 includes projections (e.g., extended pins) on the drill bit carrier 743, which interact with the example channel or track 751 in the form of a helical channel defined in the bore 746a. As the arbor 740 rotates, the engagement causes the drill bit carrier 743 to follow the channel or track 751 inside the hollow front portion 746, effectively converting rotational motion of the arbor 740 into linear movement of the drill bit carrier 743. Such a configuration allows for controlled ingress or egress of the drill bit carrier 743 in relation to the arbor 740. It will be appreciated that the coordinated interface mechanism 744 may vary across embodiments. For instance, in some configurations, the coordinated interface mechanism 744 can include grooves positioned on the drill bit carrier 743 and projections located inside the bore 746a. Other examples of the coordinated interface mechanism 744 can include, but are not limited to, variations such as gear-like engagements, cam and follower mechanisms, lead screw and nut arrangements, or other configurations for translating rotational motion into linear positioning.

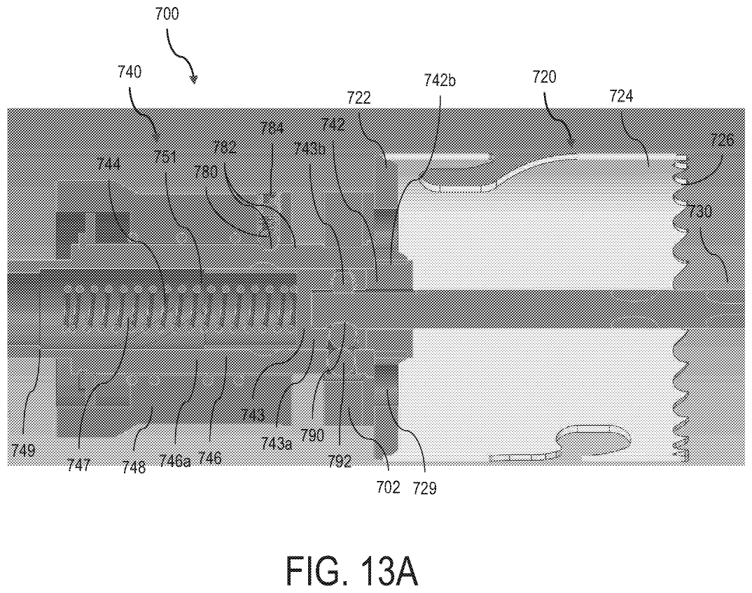

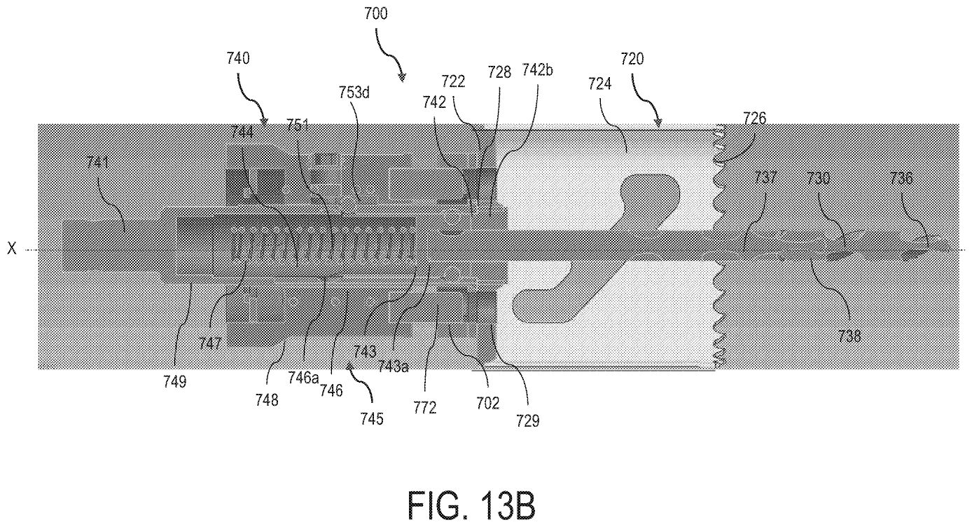

The first collar or switch 748 at least partially surrounds the shank 749 and is movably received over the shank 749. The collar or switch 748 is movable by a user axially along the shank 749 along axis X among at least two positions, e.g., a first position (as shown in FIGS. 12A and 12B) and a second position (as shown in FIGS. 13A and 13B). The shank 749 may include one or more grooves 782 corresponding to these positions (e.g., no groove 782a for the first position and no groove or groove 782b for the second position). The first collar or switch 748 may carry a ball 780 biased radially inward by a spring 784 to engage the grooves 782a, 782b and retain the collar or switch 748 in the desired position. The collar or switch 748 optionally may carry a pair of drive pins 772 that are removably receivable in lateral openings 729 in the base of the holesaw 720. The drive pins 772 can inhibit or reduce the likelihood of the holesaw 720 coming unthreaded from the threaded stem of the holesaw holder 742 and can enhance torque transmission from the arbor 740 to the holesaw 720. Axial movement of the switch 748 from the first position to the second position causes the pins 772 to retract from the openings 729 to facilitate installation or removal of the holesaw onto the holesaw holder 742.

The biasing member 747 can be configured to exert a force on the drill bit carrier 743, urging it towards an extended position. In certain embodiments, the biasing member 747 is implemented as a compression spring, positioned at the base of the bore 746a. The drill bit carrier 743 is located atop the biasing member 747, allowing the biasing member 747 to influence the positioning of the drill bit carrier 743. When the drill bit carrier 743 is in the retracted position and the retainer is disengaged from the channel or track 751 (e.g., via the switch 748, as described below), the biasing member 747 can actively bias the drill bit carrier 743 towards the extended position, facilitating the ejection of the plug by the drill bit 730. When the arbor 740 rotates in relation to the drill bit carrier 743, the coordinated interface mechanism 744 activates to facilitate ingress or egress of the drill bit carrier 743 in relation to the arbor 740. In the case of ingress movement, in which the drill bit carrier 743 retracts into the arbor 740, the movement of the drill bit carrier 743 overcomes the biasing force of, and compresses, the biasing member 747.

The characteristics of the biasing member 747, such as wire diameter, spring diameter, number of coils, coil pitch, material, spring index, end type, free length, and spring rate, can vary across embodiments. In some cases, the characteristics are selected to ensure that the biasing member 747 offers enough force to efficiently move the drill bit carrier 743 and the drill bit 730 from the retracted position to the extended position for effective plug ejection, while also preventing excessive force that could break through the plug, for instance, via the pilot hole.

The arbor 740 also may include a retention assembly 758 configured for releasably securing the drill bit carrier 743 in a retracted position. In an example, the retention assembly 758 includes a ball 753b received in a lateral bore in the shank 749 and a biasing member 753a (e.g., a spring) and a stop member 753c (e.g., a set screw) that retains the biasing member 753a in the first collar or switch 748. When the switch 748 is in the first position (as shown in FIG. 12A), the biasing member 753a is aligned with the ball 753b to bias the ball radially inward. The drill bit carrier 743 and the retention assembly 758 interact as the drill bit carrier 743 moves along the channel or track 751 in the bore 746 a, transitioning between the extended position (FIG. 12A) and the retracted position (FIG. 12B). As the drill bit carrier 743 moves towards the retracted position, the drill bit carrier 743 engages with the ball 753b, causing a temporary displacement of the ball 753b to allow passage of the drill bit carrier 743. Once the drill bit carrier 743 has passed, the bias of the biasing member 753a biases the ball 753b back into the bore 746a, positioning the ball 753b in front of the drill bit carrier 743, acting as a front stop to inhibit the drill bit carrier from moving back to the extended position.

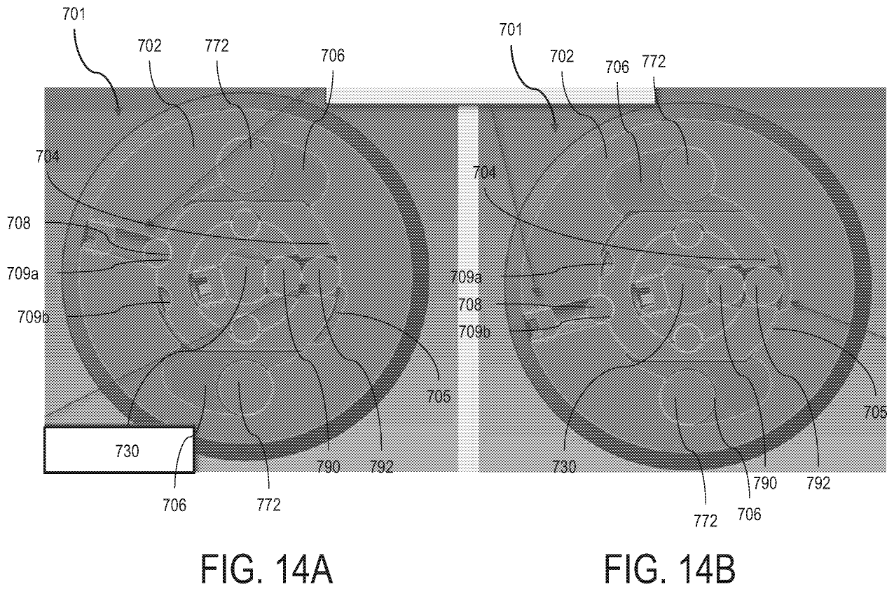

The arbor 740 also includes a quick release bit holder assembly 701 for releasably retaining the drill bit 730 in the drill bit carrier 743 and enabling removal of the drill bit 730 without use of a secondary tool. The quick release bit holder assembly 701 includes the second collar or switch 702, a primary retaining ball 790 that engages a groove in the drill bit 730 and a secondary retaining ball 792 that engages the primary retaining ball 790. The second collar or switch 702 surrounds the front portion 746 of the shank 749 and is rotatable about the axis X between a first locked position that retains the drill bit 730 in the drill bit carrier 743 (FIG. 14A) and a second unlocked position that enables removal of the drill bit 730 from the drill bit carrier 743 (FIG. 14B). The second collar or switch 702 includes a circumferential inner wall 704 with an arcuate recess 705. When the second collar or switch 702 is in the first position, the inner wall 704 engages the secondary retaining ball 792, which in turn pushes the primary retaining ball 790 radially inward to engage a groove in the drill bit to retain the drill bit in the drill bit carrier. When the second collar or switch 702 is in the second position, the arcuate recess 705 is aligned with the secondary retaining ball 792, enabling the secondary retaining ball 792 and the primary retaining ball 790 to move radially outward so that the drill bit 730 is removable from the drill bit carrier. The second collar or switch 702 also includes a pair of curved slot portions 706 that receive the pins 772, where the pins act as stops to prevent over-rotation of the second collar or switch 702 between the first and second positions. In addition, the second collar or switch 702 carries a detent ball 708 that is biased radially inward by a spring (not shown) and configured to engage with one or more detent grooves 709a, 709b in the exterior wall of the shank 749 to retain the second collar or switch 702 in the first and/or second positions.

The holesaw assembly 700 is configured to be operable in four modes that correspond to two positions of the first collar or switch 748 and the two positions of the second collar or switch 702. In the first mode, the first collar or switch 748 is in its first position, as shown in FIGS. 12A-12B and the second collar or switch 702 is in its first position, as shown in FIG. 14A. In this mode, the drill bit 730 is axially retained in the drill bit carrier 743 by the retaining ball 790 that engages a groove in the drill bit 730, the holesaw 720 is retained on the threaded stem 742b of the arbor 740 by the pins 772, and the drill bit carrier 743 and the shank 749 are initially rotationally decoupled, allowing them to rotate independently of one another. The shank 749 is received in and rotated by a tool holder (e.g., a chuck) of a power tool (e.g., a drill, a drill/driver, a screwdriver, or an impact driver) such that the shank 749 and the holesaw 720 rotate at the same speed as the tool holder of the power tool. The rotational decoupling between the drill bit carrier 743 and the shank 749 allows the drill bit 730 to rotate at a different (e.g., reduced) rotational velocity relative to the holesaw 720. This difference in rotational speeds may facilitate the retraction of the drill bit 730 into the retracted position while allowing the holesaw 720 to continue rotating. As the drill bit 730 and drill bit carrier 743 move into the fully retracted position, as shown in FIG. 12B, the ball 753b engages the drill bit carrier 743 to retain the drill bit carrier 743 in the retracted position, allowing the drill bit carrier 743 and the shank 749 to rotate in unison for the subsequent cutting process to form a hole in a workpiece with the holesaw 720.

In the second mode, the first collar or switch 748 is positioned axially in its second position, axially rearward of the first position, so the ball 780 engages the first groove 782b in the shank 749, as shown in FIGS. 13A-13B, and the second collar or switch 702 is in its first position, as shown in FIG. 14A. In this mode, the biasing member 753a (e.g., a spring) and the stop member 753c (e.g., a set screw) of the retention assembly 758 are no longer aligned with the ball 753b, and the ball is allowed to move radially outward into a pocket 753d in the collar or switch 748. The ball 753b no longer acts as a front stop for the drill bit carrier 743 and allows the drill bit carrier to move forward to the extended position. Once disengaged, the spring or biasing member 747 pushes the drill bit carrier 743 forward so that it moves rotationally and axially forward along the channel or track 751 to help at least partially eject the plug from the holesaw 720. In addition, the pins 772 are retracted from the openings 729 in the holesaw 720, allowing the holesaw to be removed from the threaded stem 742b of the arbor 740.

In the third mode, the first collar or switch 748 is in its first position, as shown in FIGS. 12A-12B and the second collar or switch 702 is in its second position, as shown in FIG. 14B. In this mode the holesaw 720 is retained on the threaded stem 742b of the arbor 740 by the pins 772 (as shown in FIGS. 12A-12B) and the arcuate recess 705 is aligned with the secondary retaining ball 792, enabling the secondary retaining ball 792 and the primary retaining ball 790 to move radially outward so that the drill bit 730 is removable from the drill bit carrier.

In the fourth mode, the first collar or switch 748 is in its second position, as shown in FIGS. 13A-13B and the second collar or switch 702 is in its second position, as shown in FIG. 14B. In this mode, the pins 772 are retracted from the openings 729 in the holesaw 720, allowing the holesaw to be removed from the threaded stem 742b of the arbor 740 and the arcuate recess 705 is aligned with the secondary retaining ball 792, enabling the secondary retaining ball 792 and the primary retaining ball 790 to move radially outward so that the drill bit 730 is removable from the drill bit carrier and the arcuate recess 705 is aligned with the secondary retaining ball 792, enabling the secondary retaining ball 792 and the primary retaining ball 790 to move radially outward so that the drill bit 730 is removable from the drill bit carrier.

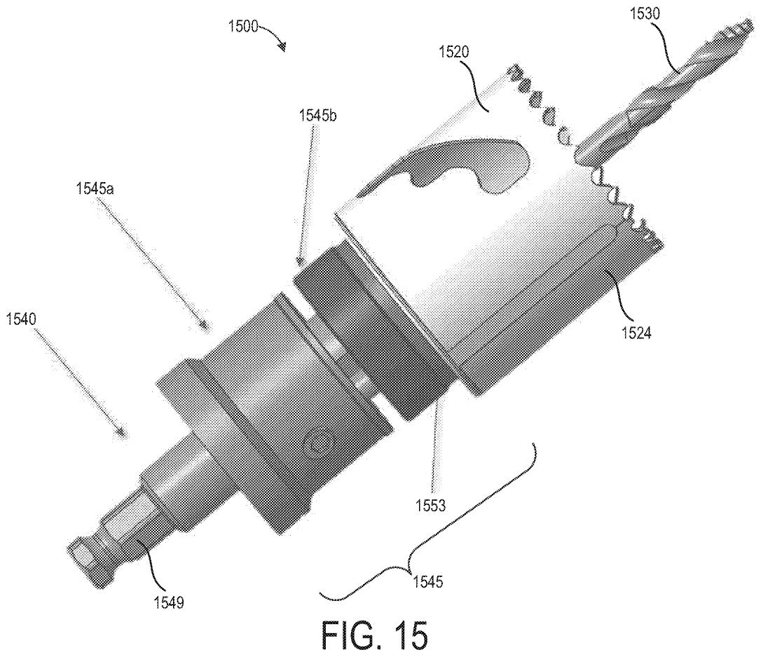

FIGS. 15-22B illustrate another embodiment of a holesaw assembly 1500 that includes a holesaw 1520, a drill bit 1530, an arbor 1540, and an actuator or switch assembly 1545. FIG. 15 illustrates a perspective view of the holesaw assembly 1500. The holesaw assembly 1500, the holesaw 1520, the drill bit 1530, the arbor 1540, and the switch assembly 1545, may be similar to embodiments or incorporate features of the holesaw assembly 100, 400, 500, 600, 700; holesaw 20, 420, 520, 620, 720; drill bit 30, 430, 630, 730; arbor 40, 440, 540, 640, 740; or switch assembly 45, 645, 745, respectively, described herein and shown across FIGS. 1-14, with reference numbers having a leading 15 indicating similar features except where otherwise indicated or as will be apparent to one of ordinary skill in the art. The holesaw assembly 1500 illustrates the switch assembly 1545 as including separate collars or switches (e.g., a first actuator or collar 1545a and second actuator or collar 1545b), each of which may be similar to embodiments or incorporate features of collar or switch 48, 448, 548, 648, 748, described herein and shown across FIGS. 1-14.

The holesaw assembly 1500 can facilitate the at least partial ejection of a plug from within an internal space in the holesaw 1520 and/or quick release of the holesaw 1520 or the drill bit 1530 from the arbor 1540, all without the use of additional tools. For example, the first actuator or collar 1545a may facilitate the removal of plugs from the internal space of the holesaw 1520 and/or the release of the holesaw 1520, and the second actuator or collar 1545b may facilitate the release of the drill bit 1530 from the arbor 1540.

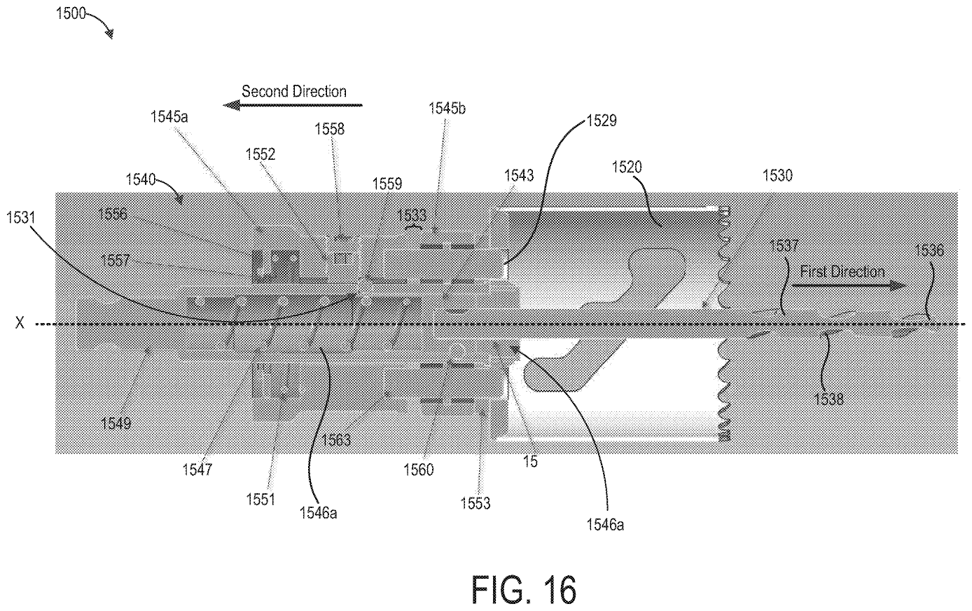

FIG. 16 illustrates a cross-sectional side view of the holesaw assembly 1500 of FIG. 15. The holesaw 1520 can assume a generally cylindrical form, thus resulting in the holesaw 1520 delineating a generally cylindrical internal space. When rotatably driven by the arbor 1540, the holesaw 1520 is configured to form a generally circular hole in a workpiece by removing a resultant plug of material from the workpiece that is received inside the internal space within the wall 1524.

The drill bit 1530 includes a cutting tip 1536 and an elongate shaft portion 1537. The elongate shaft portion 1537 can include a rear end portion couplable to the arbor 1540 and an intermediate portion between the rear end portion and the cutting tip 1536. The intermediate portion can include at least one helical flute 1538 for removing debris and cutting chips. The drill bit 1530 can be used for both creating a pilot hole in a workpiece and facilitating the ejection of a plug from the internal space 1522 in the holesaw 1520. In some cases, the design ensures that the length of the drill bit 1530 and the travel of the drill bit carrier 1543 allow a user to create a pilot hole that extends beyond the thickness of the plug formed by the holesaw 1520.

Depending on the embodiment and/or on characteristics of the workpiece, the formation of the pilot hole, the engagement of the holesaw 1520 with the workpiece, the retraction of the drill bit 1530 into the arbor 1540, and/or the transition of the first actuator or collar 1545a into the second position can occur in any sequence or one or more of these steps may occur concurrently. For example, the drill bit 1530 can first be positioned on the workpiece at the desired location, and pressure can be applied to the drill to bring the holesaw 1520 closer to the workpiece to reach a second position. Upon activation of the drill, the drill bit 1530 may begin forming a pilot hole in the workpiece, while the holesaw 1520 engages the surface of the workpiece either concurrently or shortly thereafter. Subsequently, the drill bit 1530 can be extended or projected from the arbor 1540 by actuating (pulling back) the first actuator or collar 1545a, allowing the drill bit 1530 to apply an ejection force to a plug, if present, lodged within the internal space 1522. As another example, the drill bit 1530 and the drill bit carrier 1543 can first be retracted into the rearward position, followed by the axial movement of the first collar 1545a in the first direction to lock the drill bit carrier 1543. Subsequently, the holesaw 1520 can engage the workpiece and begin cutting to form the hole.

The arbor 1540 includes an at least partially hollow front portion with a front bore 1546a, a holesaw holder 1542, a drill bit carrier 1543 received in the front bore 1546a, and a biasing member 1547 (e.g., a compression spring) received in the front bore 1546a. A rear end of the shank 1549 may be received in a tool holder or chuck of a power tool. The holesaw holder 1542 can be configured to couple to the holesaw 1520.

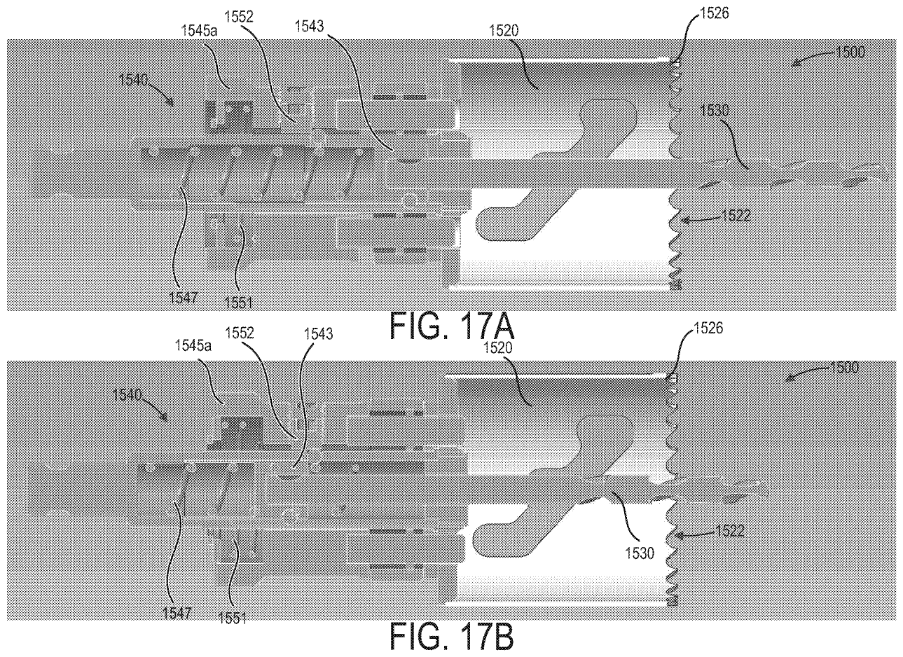

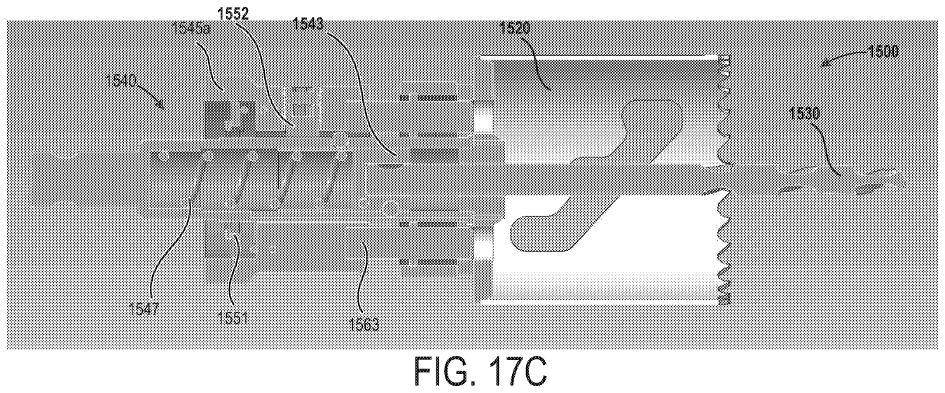

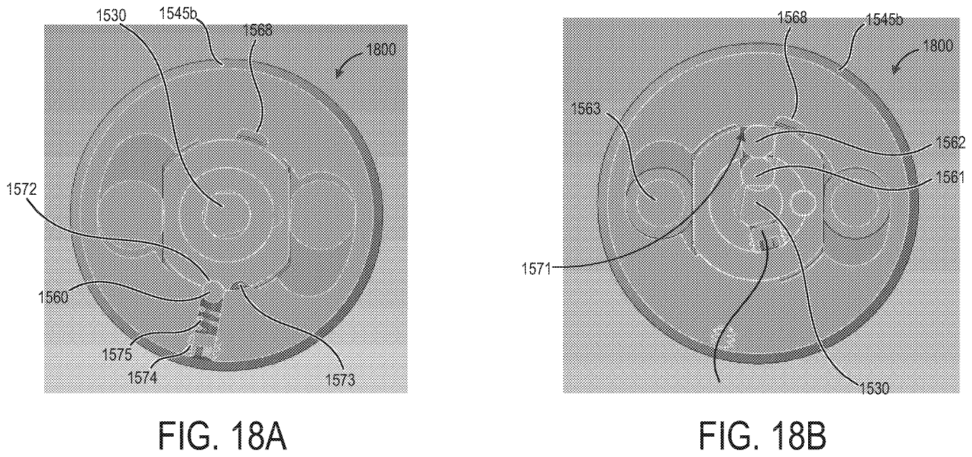

The drill bit carrier 1543 accommodates the drill bit 1530 and is configured to move between an extended position (e.g., as shown in FIG. 17A) and a retracted position (e.g., as shown in FIGS. 17B or 17C). The drill bit carrier 1543 can non-rotatably hold the drill bit 1530, e.g., by retaining balls 1561 and 1562 so that they rotate in unison. In some cases, a set screw 1597 (FIG. 18B) may serve as the primary mechanism for rotatably coupling the drill bit 1530 with the carrier 1543. The drill bit 1530 is releasably retained in the drill bit carrier 1543 along the axial direction by the retaining balls 1561 and 1562, which engage a groove in the drill bit 1530, as further described herein, for example, with respect to FIG. 18B.

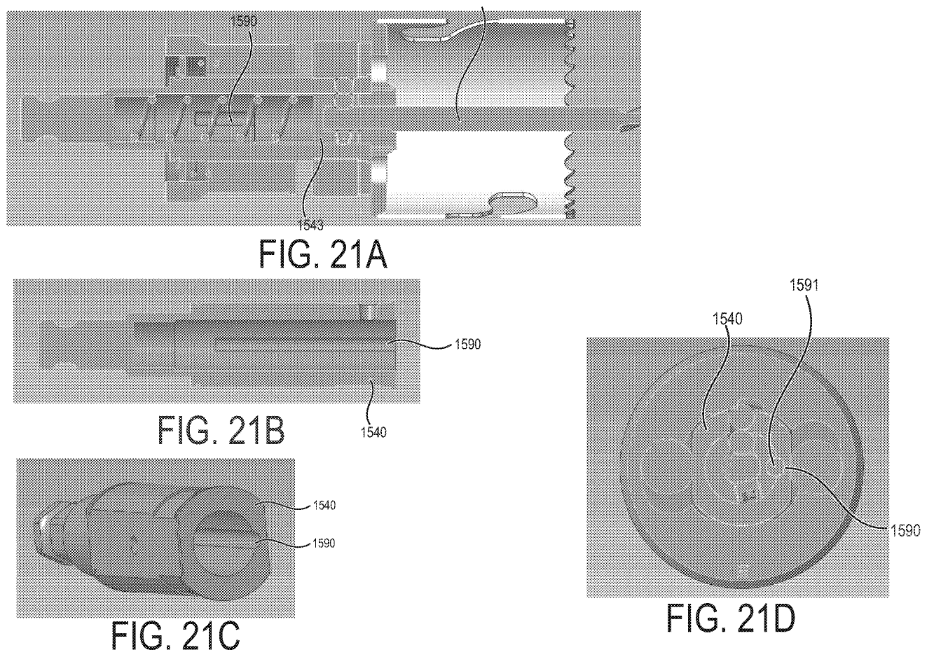

The arbor 1540 cooperates with the drill bit carrier 1543 through a coordinated interface mechanism to enable and control the translational movement of the drill bit carrier 1543, and thus the drill bit 1530, relative to the arbor 1540. Additionally, this interface mechanism can facilitate the transmission of torque between the arbor 1540 and the drill bit carrier 1543, thereby enabling the rotation of the drill bit 1530. In some cases, the coordinated interface mechanism includes first and second alignment features 1590, 1591, such as grooves and retaining elements that guide the longitudinal movement of the drill bit carrier 1543 within the front bore 1546a, facilitating controlled extension and retraction of the drill bit carrier 1543 and the drill bit 1530 within the arbor 1540, as further described herein, for example, with respect to FIGS. 21A-21D.

The base support plate 1553 can help limit the ingress of material into the arbor 1540, reducing the likelihood of functionality deterioration. Additionally, the base support plate 1553 can serve as a bearing surface for the drive pins, aiding their alignment with lateral openings 1529 in the base of the holesaw 1520 and assisting in transferring torque from the first actuator or collar 1545a to the holesaw 1520. The holesaw holder 1542 can retain the biasing member 1547 within the arbor 1540, restrict axial movement of the holesaw in both directions, and provide a position for the drill bit carrier 1543, supporting axial displacement and engagement with the plug during ejection. The holesaw holder 1542 can mitigate material ingress into the internal bore of the arbor 1540 during operation and, in some cases, transfer minimal torque from the arbor 1540 to the holesaw 1520, with a torque transfer achieved through the drive pins 1563. Furthermore, the holesaw holder 1542 can align the pilot drill retaining balls 1561 and 1562 when the carriage is in the forward-most position.

The base support plate 1553 can facilitate structural support to the pins and the drill bit carrier 1543, while also limiting the ingress of debris or particles from the workpiece into the arbor 1540, thereby contributing to the proper operation of the assembly. The holesaw holder 1542 can retain the biasing member 1547 within the arbor 1540 and provide a position for the drill bit carrier 1543, facilitating axial displacement and engagement with the plug during ejection.

### Example Plug-Eject Collar

The first actuator or collar 1545a (sometimes referred to as a plug-eject actuator or collar) facilitates the at least partial removal of plugs from the internal space 1522 of the holesaw 1520. The first actuator or collar 1545a is positioned at least partially around the arbor 1540 and is movably received over the shank 1549. The first actuator or collar 1545a can be manually moved axially along the shank 1549, along the axis X, through multiple positions. For example, the first actuator or collar 1545a may be moveable to a first position (e.g., as shown in FIG. 17A), a second position (e.g., as shown in FIG. 17B), and/or a third position (e.g., as shown in FIG. 17C).

The first actuator or collar 1545a is biased in the first direction by a biasing member 1551 (e.g., a spring) housed within the first actuator or collar 1545a, which exerts a constant force urging the first actuator or collar 1545a in the first direction (e.g., towards the cutting tip 1536 of the drill bit 1530). The first actuator or collar 1545a includes a set screw 1558, a positioning screw 1552, and a locking bearing 1559, which facilitate the positioning of the first actuator or collar 1545a. The locking bearing 1559 is moveable between a slot 1531 formed in the side of the shank 1549 and the front bore 1546a within the shank 1549. The first actuator or collar 1545a can also include a collar retaining washer 1556 and a collar retaining ring 1557.

FIGS. 17A, 17B, and 17C depict a cross-sectional side view of the holesaw assembly 1500 in the first, second, and third positions, respectively. In the first position, as shown in FIG. 17A, the first actuator or collar 1545a is in a retracted state, with the biasing member 1551 compressed. In the first position, the locking bearing 1559 is partially positioned within the slot 1531 on the side of the shank 1549, with a portion of the locking bearing 1559 extending beyond an exterior surface of the shank 1549. This protruding portion of the locking bearing 1559 intersects a path of the positioning screw 1552, which, if taken, would allow the first actuator or collar 1545a to move in the first direction to the second position. The biasing member 1551 urges the first actuator or collar 1545a in the first direction, but the locking bearing 1559 temporarily retains the first actuator or collar 1545a in the first position, restricting its axial movement. This restriction is maintained until the locking bearing 1559 is removed from the path of the positioning screw 1552, allowing the first actuator or collar 1545a to move in the first direction. In some cases, when the holesaw assembly 1500 is in the first position, there is a gap 1533 between the first actuator or collar 1545a and the second actuator or collar 1545b, which provides room for the first actuator or collar 1545a to move axially in the first direction.

When the holesaw assembly 1500 is in the first position and the drill bit 1530 is pressed into a workpiece, the drill bit carrier 1543 (containing the drill bit 1530) retracts. The retraction compresses the biasing member 1547 (e.g., a compression spring) and moves the drill bit carrier 1543 in the second direction, towards the rear of the arbor 1540. As the drill bit carrier 1543 reaches a retraction threshold, which may correspond to the drill bit carrier 1543 sliding past the locking bearing 1559, the drill bit carrier 1543 clears space for the locking bearing 1559 to move into the front bore 1546a of the shank 1549. The movement of the locking bearing 1559 at least partially into the front bore 1546a removes the protruding portion of the locking bearing 1559 from the biased path of the positioning screw 1552, causing the first actuator or collar 1545a to move forward into the second position under the bias exerted by the biasing member 1551.

In the second position, as shown in FIG. 17B, the drill bit carrier 1543 is in a retracted state, with the biasing member 1547 compressed. In this position, the locking bearing 1559 at least partially protrudes into the front bore 1546a, acting as a mechanical stop by intersecting the path of the drill bit carrier 1543. This prevents the drill bit carrier 1543 from moving further in the first direction, though the biasing member 1547 urges the drill bit carrier 1543 in the first direction. Thus, in the second position, the locking bearing 1559 restricts the forward axial movement of the drill bit carrier 1543. This restriction remains until the locking bearing 1559 is cleared from the path of the drill bit carrier 1543 by pulling the first actuator or collar 1545a in the second direction, relative to the arbor 1540.

In the second position, the holesaw assembly 1500 is ready for a cutting operation. As described herein, the drill bit carrier 1543 is in a retracted state, with the biasing member 1547 compressed. The cutting tip 1536 of the drill bit 1530, which is supported by the drill bit carrier 1543, is positioned just beyond a cutting edge 1526 of the holesaw 1520, to facilitate creation of a pilot hole in the workpiece. As the holesaw assembly 1500 is rotated by the arbor 1540, the holesaw 1520 engages the workpiece and begins to cut. The cutting action of the holesaw 1520 facilitates the formation of a plug, which is captured within the internal space 1522 of the holesaw 1520. The plug remains in this state until it is ejected or otherwise removed.

In the second position, moving the first actuator or collar 1545a in the second direction, relative to the arbor 1540, moves the positioning screw 1552 in the second direction. As the positioning screw 1552 reaches an ejection threshold, which may correspond to the positioning screw 1552 sliding past the locking bearing 1559, space is cleared for the locking bearing 1559 to move radially outward. This motion allows the locking bearing 1559 to move back into the same position it occupied in the first position, at least partially within the path of the positioning screw 1552. As the locking bearing 1559 moves into this position, it is removed from the biased path of the drill bit carrier 1543, enabling the drill bit carrier 1543 to move forward in the first direction under the bias of the biasing member 1547. This forward motion of the drill bit carrier 1543 causes the drill bit 1530 to engage a plug, if present within the internal space 1522 of the holesaw 1520, and can at least partially eject the plug from the holesaw 1520. Thus, the axial displacement of the first actuator or collar 1545a in the second direction facilitates the release of the drill bit carrier 1543 from its retracted position and facilitates the ejection of the plug.

The first actuator or collar 1545a can include a pair of drive pins 1563, which are removably received in lateral openings 1529 in the base of the holesaw 1520. The drive pins 1563 can help reduce the likelihood of the holesaw 1520 becoming unthreaded from the threaded stem of the holesaw holder 1542. Additionally, the drive pins 1563 can assist in transmitting torque from the shank 1549, through the first collar 1545a, to the holesaw 1520. As shown in FIGS. 17A and 17B, the drive pins 1563 may be normally engaged with lateral openings 1529 in the base of the holesaw 1520.

FIG. 17C illustrates a cross-sectional view of the holesaw assembly 1500 in a third position. In the third position, the drive pins 1563 are retracted as a result of the first actuator or collar 1545a being moved further along its axial path in the second direction, as compared to the first position shown in FIG. 17A. This retraction of the drive pins 1563 allows the holesaw 1520 to be unthreaded from the threaded stem of the holesaw holder 1542. The retracted position of the drive pins 1563 facilitates the disengagement of the holesaw 1520 by preventing the drive pins 1563 from obstructing the unthreading process.

### Example Quick Change Collar

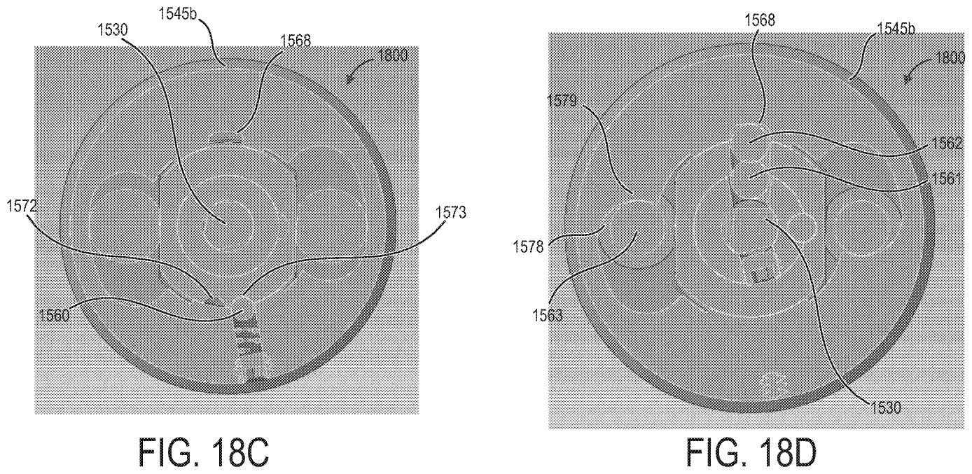

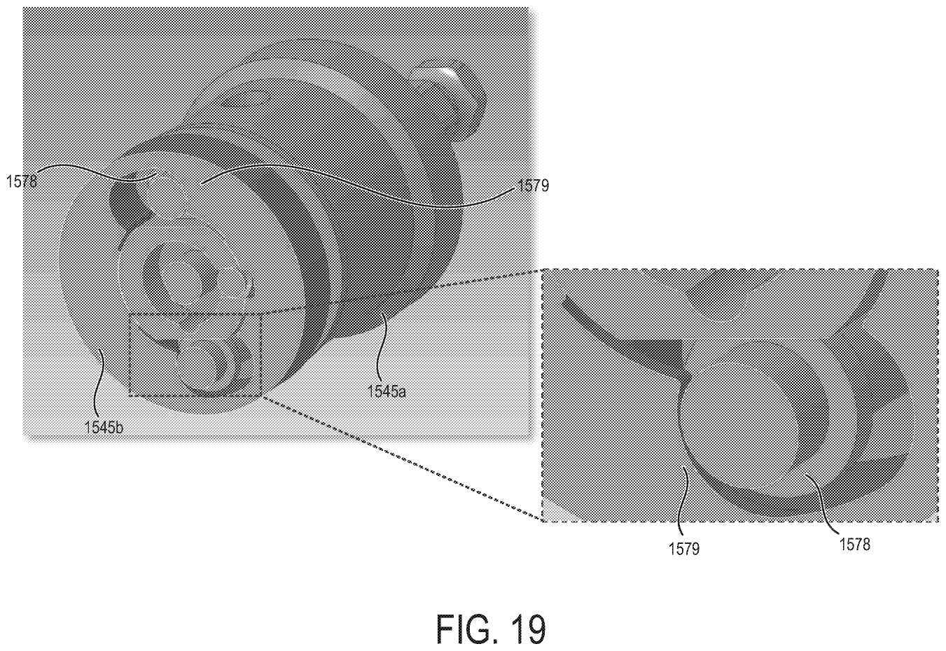

Referring back to FIGS. 15 and 16, the second actuator or collar 1545b (sometimes referred to as a quick change actuator or collar) facilitates tool-free attachment and detachment of the drill bit 1530. The second actuator or collar 1545b is positioned at least partially around the arbor 1540 and is movably received over the shank 1549. The second actuator or collar 1545b can be manually moved rotationally about the shank 1549, through multiple positions. For example, the second actuator or collar 1545b can be rotatable between a first position (e.g., as shown in FIGS. 18A and 18B) and a second position (e.g., as shown in FIGS. 18C, 18D, and 19).

FIGS. 18A to 18D and FIG. 19 illustrate various views of a retention assembly 1800 of the holesaw assembly 1500 of FIG. 15. The retention assembly 1800 facilitates the selective retention and release of the drill bit 1530 and coordinates the release of the drill bit 1530 with the operation of the first actuator or collar 1545a. As described herein, this coordination reduces the likelihood of the first actuator or collar 1545a being unintentionally actuated (and the drill bit 1530 ejected) while the retention assembly 1800 is in an unlocked state, thereby improving the operation and control of the holesaw assembly 1500.

The second actuator or collar 1545b is rotatable about its axis to transition between operational positions, each corresponding to a specific alignment or misalignment of the recess 1568 with the retaining balls 1561, 1562. The retention assembly 1800 can include a second actuator or collar 1545b, locking detent balls 1562, a recess 1568 within the second actuator or collar 1545b, a groove on the drill bit 1530, a first actuator or collar 1545a, drive pins 1563, a detent mechanism including a detent bearing 1560, a biasing member 1575, and additional structural elements such as the collar retaining washer 1556, collar retaining ring 1557, and a positioning screw 1552.

FIGS. 18A and 18B illustrate cross-sectional views of the holesaw assembly 1500 with the second actuator or collar 1545b in a first rotational position, showing the second actuator or collar 1545b at different cross-sectional levels. FIG. 18A provides a more focused view of the interaction between a detent bearing 1560 and a first detent 1572 of the drill bit carrier 1543. FIG. 18B provides a more focused view of the interaction between an interior surface 1571 of the second actuator or collar 1545b and retaining balls 1561, 1562.

FIGS. 18C and 18D illustrate cross-sectional views of the holesaw assembly 1500 with the second actuator or collar 1545b in a second rotational position, showing the second actuator or collar 1545b at different cross-sectional levels. FIG. 18C provides a more focused view of the interaction between the detent bearing 1560 and the second detent 1573 of the drill bit carrier 1543. FIG. 18D provides a more focused view of the interaction between the interior surface 1571 of the second actuator or collar 1545b and the retaining balls 1561, 1562.

FIGS. 18A and 18C illustrate cross-sectional views of a multi-position detent system associated with the rotational positioning of the second actuator or collar 1545b within the retention assembly 1800. As shown, the drill bit carrier 1543 includes a first detent 1572 and a second detent 1573 formed on the exterior surface of the arbor 1540. The detent bearing 1560 is positioned to interact with these detents and is biased radially inward by a biasing member 1575 (e.g., a spring), which is housed within a bore and secured by a set screw 1574. The biasing member 1575 applies a consistent biasing force to the detent bearing 1560, enabling the detent bearing 1560 to engage with the first detent 1572 (see e.g., FIG. 18A) or the second detent 1573 (see e.g., FIG. 18C), depending on the position of the second actuator or collar 1545b.

FIG. 18A depicts the second actuator or collar 1545b in the first rotational position, where the detent bearing 1560 resides in the first detent 1572. In this configuration, the recess 1568 of the second actuator or collar 1545b is misaligned with the retaining balls 1561, 1562. This misalignment causes the interior surface 1571 of the second actuator or collar 1545b to press the retaining balls 1561, 1562 radially inward, engaging a circumferential groove formed on the drill bit 1530. This engagement inhibits axial movement of the drill bit 1530 within the retention assembly 1800, thereby securely retaining the drill bit 1530 during cutting operations.

FIG. 18C illustrates the second actuator or collar 1545b in the second rotational position, where the detent bearing 1560 resides in the second detent 1573. As the second actuator or collar 1545b transitions between the first rotational position, corresponding to the engagement of the detent bearing 1560 with the first detent 1572, and its second rotational position, corresponding to the engagement of the detent bearing 1560 with the second detent 1573, the radial displacement of the detent bearing 1560 is facilitated by the compressive force of the biasing member 1575.

FIGS. 18B and 18D illustrate cross-sectional views of the interaction of the second actuator or collar 1545b and the retaining balls 1561, 1562. FIG. 18B illustrates the first rotational position of the second actuator or collar 1545b, where the recess 1568 of the second actuator or collar 1545b does not align with the retaining balls 1561, 1562. Instead, the interior surface 1571 of the second actuator or collar 1545b exerts an inward force on the retaining balls 1561, 1562, biasing them radially inward. This inward movement of the retaining balls 1561, 1562 engages a groove on the drill bit 1530, securing the drill bit 1530 axially within the retention assembly 1800. This configuration locks the drill bit 1530 in place for operational stability during cutting tasks.

FIG. 18D illustrates the second rotational position of the second actuator or collar 1545b, where the recess 1568 of the second actuator or collar 1545b aligns with the retaining balls 1561, 1562. This alignment relieves the inward bias exerted by the interior surface 1571, allowing the retaining balls 1561, 1562 to move radially outward. In this position, the retaining balls 1561, 1562 disengage from the groove on the drill bit 1530, enabling axial movement of the drill bit 1530 for removal or replacement. The transition between these positions is facilitated by the radial displacement of the detent bearing 1560 as it moves between the first detent 1572 and the second detent 1573, under the consistent force provided by the biasing member 1575.

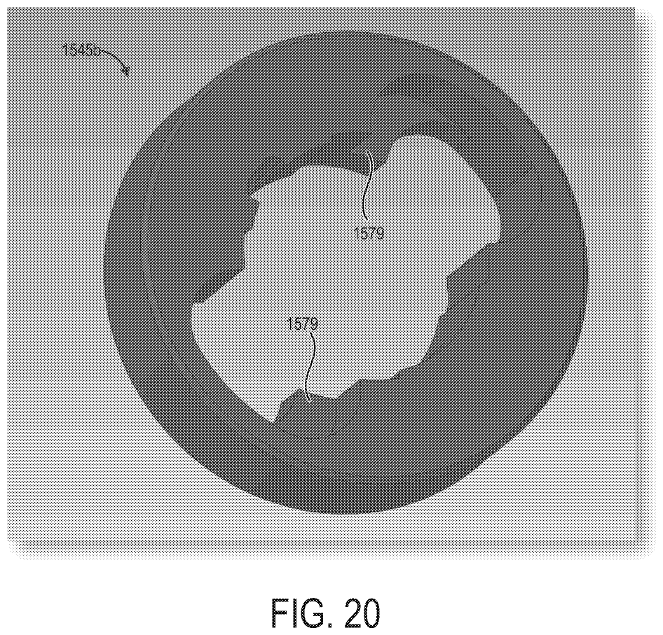

FIG. 19 illustrates a perspective view and a detailed inset view of a portion of the holesaw assembly 1500, highlighting the interaction between a first shelf 1578 formed on the drive pins 1563 and a second shelf 1579 formed on the second actuator or collar 1545b. FIG. 20 shows a perspective view of the second actuator or collar 1545b removed from the holesaw assembly 1500, showing the first and second shelves 1578, 1579. The shelves 1578, 1579 are configured to cooperate within the retention assembly 1800 to control the axial movement of the first actuator or collar 1545a during defined operational states. The first shelf 1578 on the drive pins 1563 engages the second shelf 1579 on the second actuator or collar 1545b in specific positions (e.g., the second rotational position), thereby providing a mechanical barrier that regulates the forward movement (towards the second actuator or collar 1545b) of the drive pins 1563 and restricts unintended actuation of the first actuator or collar 1545a.

The inset portion of FIG. 19 provides a more detailed view of the interaction between these components. The first shelf 1578 on the drive pins 1563 is configured as a circumferential shelf that extends at least partially around the circumference of the drive pins 1563. This circumferential shelf is positioned along the length of the drive pins 1563 to align with the second shelf 1579 on the second actuator or collar 1545b. When the second actuator or collar 1545b is in the second rotational position, the first shelf 1578 engages with the second shelf 1579, forming a mechanical barrier that inhibits the forward axial movement of the drive pins 1563. This engagement restricts the actuation of the first actuator or collar 1545a, preventing its motion while the second actuator or collar 1545b remains in the second rotational position. FIG. 18D complements FIG. 19 illustration by showing the physical interaction between the first shelf 1578 on the drive pins 1563 and the second shelf 1579.

Referring back to FIG. 18B, when the second actuator or collar 1545b is rotated into the first rotational position, the first shelf 1578 on the drive pins 1563 does not engage with the second shelf 1579 on the second actuator or collar 1545b. In this configuration, the first actuator or collar 1545a is free to move forward, allowing it to be actuated for plug ejection. As mentioned herein, the implementation of the first shelf 1578 and the second shelf 1579 reduces the likelihood of the first actuator or collar 1545a being inadvertently activated while the drill bit 1530 is in an unlocked state, thereby reducing the likelihood of the drill bit 1530 being unintentionally ejected along with the plug.

### Example Alignment Groove

FIGS. 21A-21D illustrate various views of the holesaw assembly 1500 of FIG. 15, which includes a first alignment feature 1590 and a second alignment feature 1591 to facilitate controlled movement of the drill bit 1530 within the arbor 1540. FIG. 21A illustrates a side cross-sectional view of the holesaw assembly 1500, while FIGS. 21B and 21C provide side cross-sectional and perspective views, respectively, of the arbor 1540 of the holesaw assembly 1500. FIG. 21D illustrates a transverse cross-sectional view of the arbor 1540.

The holesaw assembly 1500 includes a drill bit 1530 that has an elongate shaft portion configured for both rotational and axial movement. The drill bit 1530 is supported by a drill bit carrier 1543, which is translatable along an axial direction within the arbor 1540. The first alignment feature 1590 and the second alignment feature 1591 work together to guide the movement of the drill bit carrier 1543 and facilitate proper positioning of the drill bit 1530.

The first alignment feature 1590 may be located along an interior surface of the arbor 1540. For example, the arbor 1540 can include a hollow portion configured to receive the drill bit carrier 1543, with the first alignment feature 1590 being formed along the interior surface of this hollow portion. The second alignment feature 1591 can be located or formed along an exterior surface of the drill bit carrier 1543. In some embodiments, the second alignment feature 1591 may engage with the first alignment feature 1590 to guide the axial movement of the drill bit carrier 1543 within the arbor 1540, allowing for controlled translation while maintaining rotational stability.

In FIGS. 21A-21D, the first alignment feature 1590 is illustrated as a groove, and the second alignment feature 1591 is illustrated as a projection. However, it will be appreciated that the implementation of the first and second alignment features 1590, 1591 can vary across embodiments. For example, in some cases, both the first and second alignment features 1590, 1591 can each include a groove, with a ball positioned between the grooves to facilitate alignment and smooth axial movement. In other cases, the second alignment feature 1591 can include a groove, and the first alignment feature 1590 can include a projection, or vice versa. It will be appreciated that the first and second alignment elements can include any coinciding alignment features, including, but not limited to, a pin and a slot, a projection and a recess, a bearing and a channel, or any similar complementary features that facilitate the guided axial movement of the drill bit carrier 1543 within the arbor 1540. The first alignment feature 1590 can function as a track or set of aligned segments. For example, the first alignment feature 1590 can serve as a path for the alignment feature 1591. The first alignment feature 1590 can be designed as a track or set of aligned segments.

The position of the first alignment feature 1590 can vary across embodiments. For example, in some cases, the first alignment feature 1590 is formed on the interior surface of the arbor 1540. This first alignment feature 1590 can be designed as a track or set of aligned segments. When formed on the arbor 1540, the first alignment feature 1590 can serve as a path for the alignment feature 1591, which is typically associated with the drill bit carrier 1543. This arrangement can allow for axial movement of the drill bit carrier 1543, while the first alignment feature 1590 can help keep the drill bit carrier aligned during operation, which can reduce the likelihood of undesired rotational movement.

The first alignment feature 1590 and the second alignment feature 1591 cooperate to form a controlled path for the axial movement of the drill bit carrier 1543 within the arbor 1540. For example, the first alignment feature 1590 can function as a track or set of aligned segments, guiding the movement of the second alignment feature 1591, which guides the drill bit carrier 1543, thereby stabilizing the axial movement of the drill bit 1530. In some cases, the alignment features 1590, 1591 can help create a straight channel or linear guide that facilitates smooth and consistent axial translation of the drill bit carrier 1543. This interaction between the alignment features 1590, 1591 can assist in keeping the drill bit carrier 1543 on a generally straight axial path during movement, reducing lateral deviation.

### Example Drill Bit Mechanical Engagement Surface

Some aspects of the inventive concepts described herein address challenges associated with removing plugs formed during cutting operations in holesaw assemblies. As described herein, a plug formed within the internal space 1522 of the holesaw may become lodged and difficult to remove. To facilitate ejection of the plug, a drill bit may be configured to apply an axial force to the plug. In some cases, the drill bit includes a mechanical engagement surface along its elongate shaft portion. The mechanical engagement surface may include threads, a roughened surface, dimples, grooves, ridges, or other types of positive or frictional engagement structures or surfaces formed on the outer surface of the drill bit shaft and/or the outer surface of the helical flutes. These surfaces help the drill bit mechanically engage the surface of the pilot hole formed by the drill bit in the plug. The mechanical engagement surface may include a change in diameter that creates a mechanical engagement with the plug, creating a physical interaction that reduces the likelihood of the drill bit breaking or sliding through the pilot hole without ejecting the plug from the internal space 1522. By engaging the plug more securely, the mechanical engagement surface can improve the transfer of the applied ejection force, potentially assisting in dislodging the plug in a controlled and reliable manner.

As described herein, a plug may be formed within the internal space of the holesaw, and the first actuator or collar can facilitate application of an ejection force onto the plug via the drill bit. For example, the first actuator or collar may be manually actuated or spring-biased to assist in a plug ejection process, in which the drill bit is moved from a retracted position to an extended position.

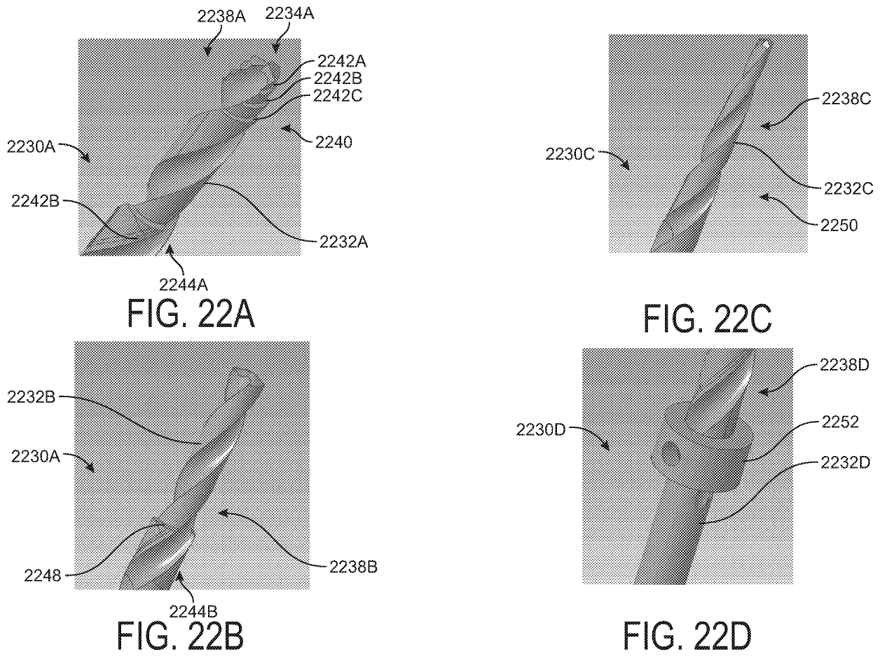

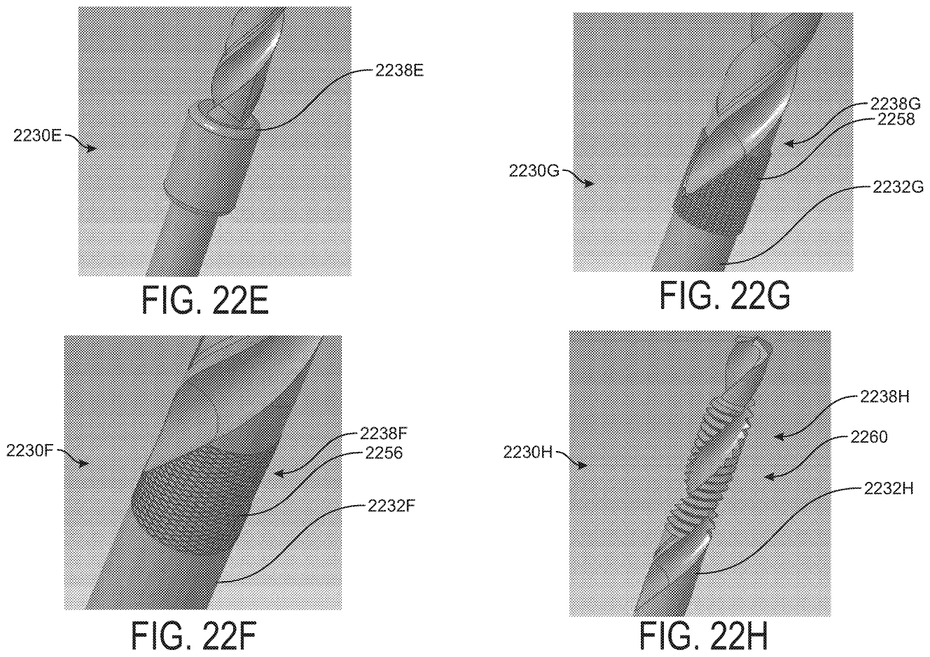

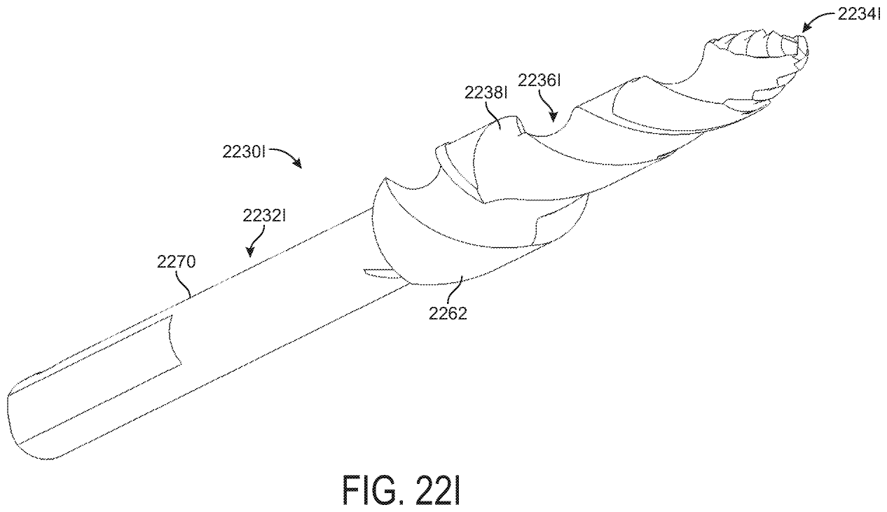

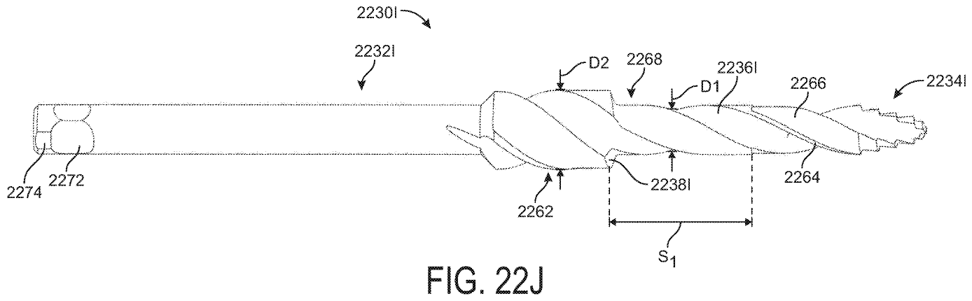

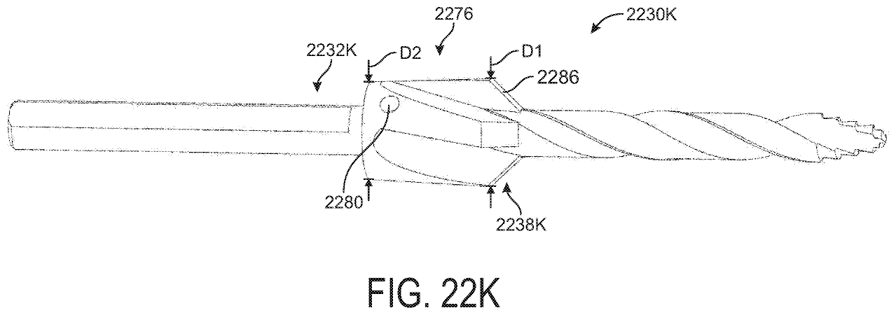

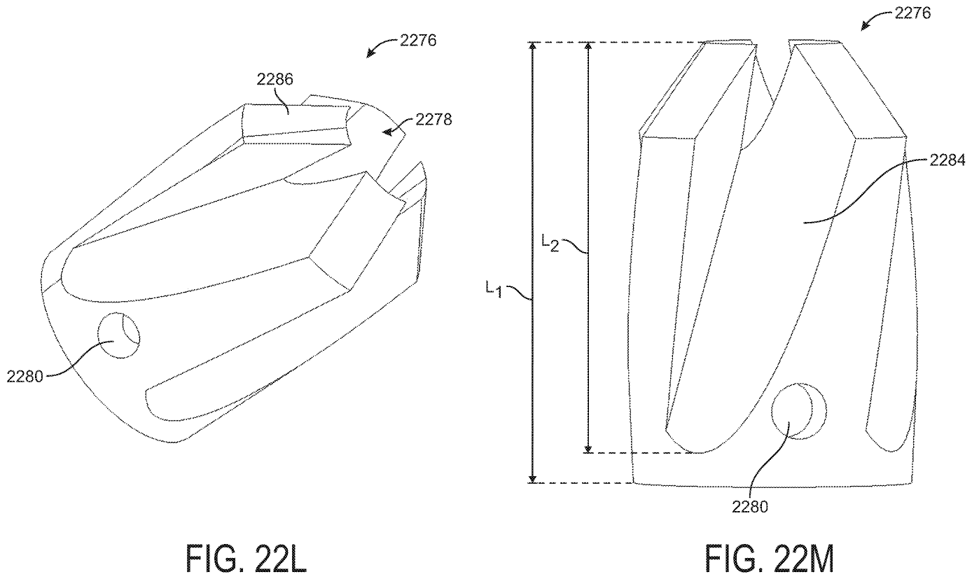

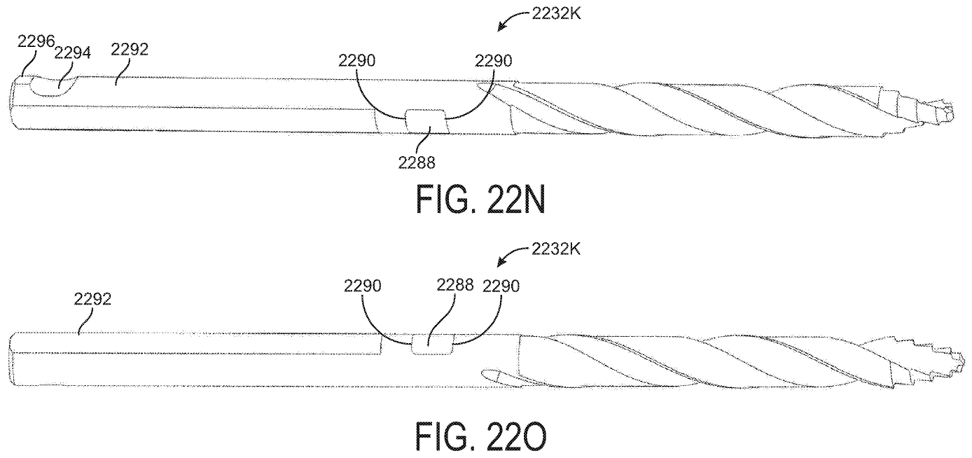

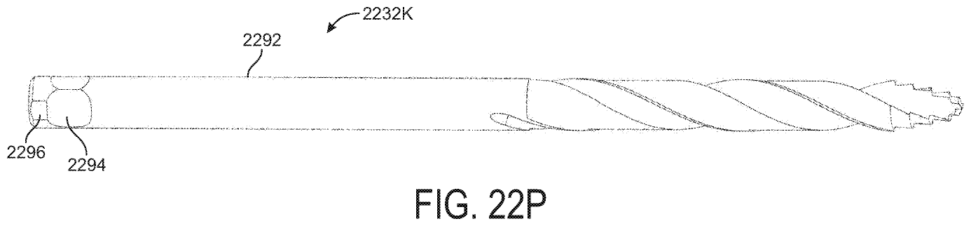

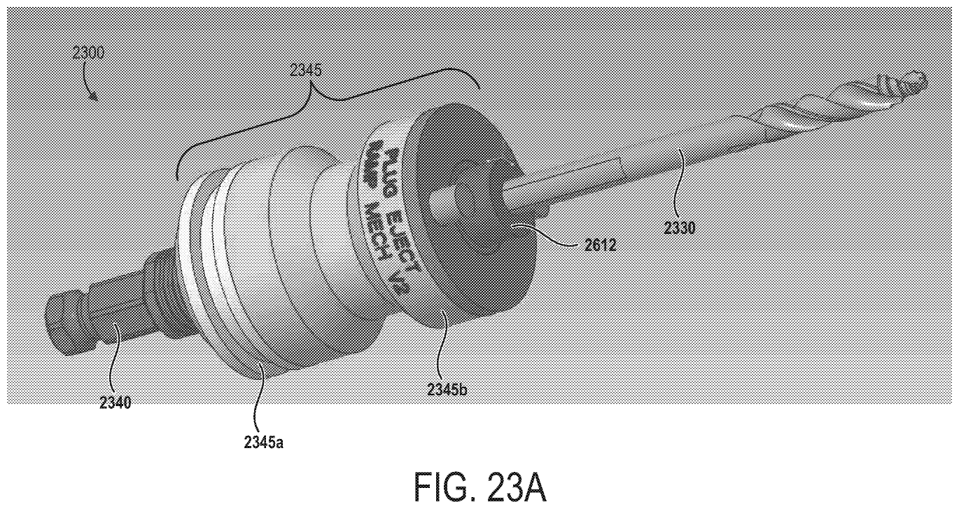

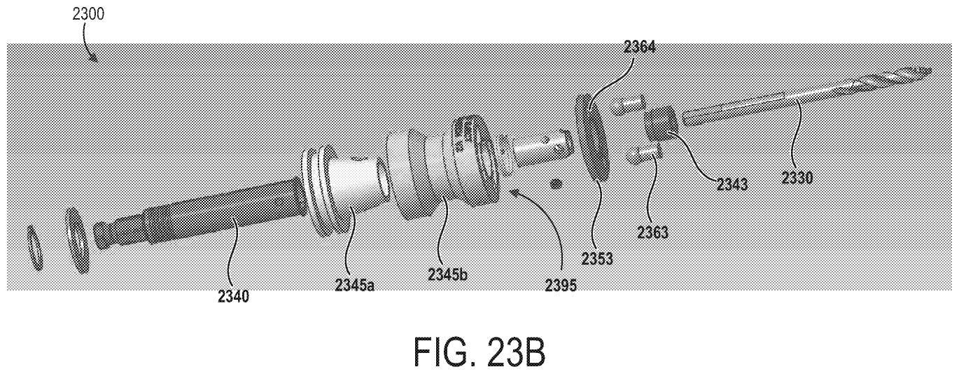

FIGS. 22A-22P illustrate various views of example drill bits and drill bit assemblies, which may may be used as pilot drill bits with the holesaw assemblies disclosed in this application, including but not limited to the holesaw assemblies of FIGS. 1-21D, described above, and FIGS. 23A-29B, described below. The drill bits and drill bit assemblies 2230A-2230K (also individually or collectively referred to as drill bit 2230) can include features that facilitate improved interaction with a plug during a plug ejection process or provide additional operational benefits for a holesaw assembly, such as any holesaw assembly described herein. For example, a mechanical engagement surface 2238A-2238K can reduce the likelihood of the drill bit 2230 sliding or breaking through a pilot hole created by the drill bit 2230 in the plug when an ejection force is applied.

FIG. 22A illustrates an example drill bit 2230A with an example mechanical engagement surface 2238A. As shown, the mechanical engagement surface 2238A can include a stepped geometry 2240, including multiple steps distributed along an elongate shaft 2232A. A step 2242 or radial projection extends outward from the elongate shaft 2232A of the drill bit 2230A to engage with the inner surface of a pilot hole of the plug. In some cases, the radial extension of the step may vary depending on the design, for example, extending partially outward from the shaft 2232A to provide sufficient contact with the edges of the pilot hole in the plug without interfering with the cutting operation. For example, the step 2242 of the mechanical engagement surface 2238A may range from subtle extensions designed to engage smaller plugs to more pronounced projections capable of handling larger or more robust materials.

As shown in FIG. 22A, in some cases, the drill bit 2230A can include three steps 2242A, 2242B, 2242C near a cutting tip 2234A and a fourth step 2242D positioned near a midpoint 2244A of the shaft 2232A, which can improve engagement with a pilot hole in the plug during the ejection process. The steps 2242A-2242D can provide a secure interface with the plug, improving the transfer of ejection forces. In some configurations, the radial extensions of the steps 2242A-2242D may be designed to accommodate plugs of varying materials and sizes, from small plugs to more robust workpieces.

FIG. 22B illustrates an example drill bit 2230B with an example mechanical engagement surface 2238B. As shown, the mechanical engagement surface 2238B can include a single step 2248 located near a midpoint 2244B of a shaft 2232B. In some cases, this single step 2248 configuration can simplify the geometry while maintaining effective engagement with the pilot hole of the plug. The single step 2248 may extend radially outward from the shaft 2232B to form the mechanical engagement surface 2238B that interacts with the edges of the plug. This design can reduce manufacturing complexity while providing sufficient contact to reliably transfer ejection forces.

FIG. 22C illustrates an example drill bit 2230C with an example mechanical engagement surface 2238C. As shown, the mechanical engagement surface 2238C can include a tapered shaft 2232C. In some cases, the tapered geometry gradually increases the diameter of the shaft 2232C along its length, creating a progressively tighter interaction with the edges of the pilot hole during the ejection process. The tapering may provide improved mechanical and/or frictional engagement with the plug while reducing the likelihood of slippage. In certain implementations, the tapered geometry of the shaft 2232C may include gradual transitions.

FIG. 22D illustrates an example drill bit 2230D with an example mechanical engagement surface 2238D. As shown, the mechanical engagement surface 2238D can include a removable stop collar 2252 positioned along a shaft 2232D. In some cases, the removable stop collar 2252 can be configured to slide or be secured at various locations on the shaft 2232D, allowing customization based on, for example, the thickness or material characteristics of the plug. In some cases, the removable stop collar 2252 may include radial projections, friction-enhancing surfaces, or tapered edges to facilitate secure engagement with the plug. In certain embodiments, the removable stop collar 2252 may be removable and reusable, enabling it to be repositioned or replaced as necessary for different operational requirements.

FIG. 22E illustrates an example drill bit 2230E with an example mechanical engagement surface 2238E. As shown, the mechanical engagement surface 2238E can include an integrated bearing geometry. In some cases, the integrated bearing geometry may include any of the functionality or advantages of the removable stop collar 2252 described above, but may be unitary with the drill bit 2230E, instead of removable.

FIG. 22F illustrates an example drill bit 2230F with an example mechanical engagement surface 2238F. As shown, the mechanical engagement surface 2238F can include a knurled surface 2256 applied to a shaft 2232F. In some cases, the knurled surface 2256 can form the mechanical engagement surface 2238F that improves interaction with the plug during ejection. The knurled surface 2256 can increase the contact area between the drill bit 2230F and the plug, reducing the likelihood of slipping or misalignment when an ejection force is applied. In some embodiments, the pattern and depth of the knurled surface 2256 may vary to accommodate specific plug materials or operational requirements.

FIG. 22G illustrates an example drill bit 2230G with an example mechanical engagement surface 2238G. As shown, the mechanical engagement surface 2238G can include dimples 2258 applied to a shaft 2232G. In some cases, the dimples 2258 may create localized friction points along the surface, improving the ability of the drill bit 2230G to securely grip the plug during the ejection process. The dimples 2258 can be uniformly distributed or selectively positioned along the shaft 2232G to facilitate interaction with the plug's pilot hole. In certain configurations, the size and spacing of the dimples 2258 may be adjusted to enhance engagement with plugs of varying dimensions or materials.

FIG. 22H illustrates an example drill bit 2230H with an example mechanical engagement surface 2238H. As shown, the mechanical engagement surface 2238H can include a threaded section 2260 along a shaft 2232H. In some cases, the threaded section 2260 may engage the edges of the pilot hole in the plug, providing a secure and adjustable interface for the ejection process. The threaded section 2260 can improve the ability of the drill bit 2230H to grip the plug. In some cases, the thread pitch and depth may be designed to accommodate a variety of plug sizes and material types.

Referring to FIGS. 22I and 22J, a perspective view and a side view of an example drill bit 2230I are illustrated. As illustrated, the drill bit 2230I has a unitary, one-piece construction and may be formed, for example, by casting, forging, or being machined from a stock of raw material. In other implementations, the drill bit 2230I may be composed of multiple components of similar or different materials, which are joined, e.g., by welding, brazing, or other mechanical connections. The drill bit 2230I may be utilized interchangeably with any of the holesaw arbors described herein.

A distal end of the drill bit 2230I includes a cutting tip 2234I, an elongate shaft 2232I, and helical flutes 2236I. The drill bit 2230I further includes a margin 2264 and a recessed portion 2266 adjacent a trailing edge of the margin 2264. The margin 2264 is a raised edge along the helical flutes 2236I, while the recessed portion 2266 defines a body clearance (or radial clearance) configured to reduce friction between the body of the drill bit 2230I and a workpiece. To improve structural durability during high-stress operations, the margin 2264 may terminate forward of a shoulder 2268 (or step feature) located along the elongate shaft 2232I. For example, a proximal end of the margin 2264 may be spaced from the shoulder 2268 by a distance, S1, which may be in the range of approximately 1 mm to approximately 7 mm and in some examples, greater than approximately 5 mm. By providing a margin terminating forward of the shoulder 2268, the cross-sectional area of the drill bit 2230I is maximized at a potential stress riser associated with the shoulder 2268 to reduce the likelihood of breakage.

Moving proximally, the drill bit 2230I includes an increased diameter portion 2262 which may be integrally formed with the elongate shaft 2232I and that defines a mechanical engagement surface 2238I. The mechanical engagement surface 2238I of the increased diameter portion 2262 may engage an inner surface of a pilot hole. This engagement is configured to frictionally or mechanically engage the plug material rather than allowing the drill bit 2230I to slide through the plug material, which enables the drill bit to impart an axial force to forcefully eject the plug from the holesaw. In an example, an outer diameter, D1, of a leading end portion or distal end portion of the drill bit 2230I may be less than approximately 70% of an outer diameter, D2, of the increased diameter portion 2262, and in some examples, D1 may be less than approximately 60% of D2.

At a proximal end, the drill bit 2230I includes a rear shank 2270 and a portion with a non-circular cross-section, e.g., a retention groove 2272, used to axially and non-rotationally secure the drill bit 2230I within an arbor. The rear shank 2270 optionally further includes a rear flat 2274 adjacent and, for example, proximal of, the retention groove 2272 to accommodate burr formation. During rapid plug ejection cycles, the inertia of the drill bit 2230I pulling forward against a retention bearing may create a burr on the rear shank 2270. The rear flat 2274 provides a reduced-diameter clearance area that allows this burr to form without expanding the outer diameter of the rear shank 2270, ensuring the drill bit 2230I remains easily removable after repeated use.

Referring to FIG. 22K, a side view of an example drill bit assembly 2230K is illustrated. The drill bit assembly 2230K includes at least two pieces comprising an elongate shaft 2232K and a separate collar 2276. By employing a separate collar 2276 that slides over the elongate shaft 2232K, rather than forming a larger diameter portion integral with the drill bit, a total volume of raw material required may be reduced, which can improve manufacturing efficiency and lower costs.

FIGS. 22L and 22M are a perspective view and a side view of the collar 2276. The collar 2276 defines a central bore 2278 configured to receive the elongate shaft 2232K. The collar 2276 also may include a lateral aperture 2280 configured to receive a set screw (not shown) to retain the collar 2276 on the shaft. In other examples, the collar 2276 may be retained on the shaft, e.g., by welding, brazing, or other mechanical connection. The example collar 2276 is fluted, including one or more flutes 2284. The collar 2276 has a total axial length L1, and the flutes 2284 have an axial length L2. In an example, the flute length (L2) may be substantially the same as the length, L1, of the collar 2276, which can provide an increased volume of the flute 2284 which can facilitate material removal during a cutting operation. In an example, the length, L2, of the one or more flutes 2284 may be at least approximately 70%, and in some examples, at least approximately 75% of the length, L1, of the collar 2276.

In an example, the one or more flutes 2284 may define respective volumes. In an example, a ratio of total volume of the one or more flutes 2284 to an axial length of the collar 2276 may be at least approximately 0.24 inch\hat{ }3/inch, which may facilitate material removal during a drilling operation. For example, an implementation of the collar 2276 having a length, L1, of 1.5 inches, the one or more flutes 2284 may have a total volume of approximately 0.36 inches'and in the illustrated example of four flutes 2284, the volume of each flute 2284 may be approximately 0.09 inches\hat{ }3.

The length and volume of the one or more flutes 2284 may be greater than the length and volume of the flutes on a conventional countersink drill bit or countersink collar due to the deeper drilling operation performed by the drill bit assembly 2230K as compared to a conventional countersink, in which a substantial portion or a majority or all of the length, L1, of the collar 2276 may be inserted or drilled into the workpiece.

The example collar 2276 may define at least one stepped surface 2286, which forms a mechanical engagement surface 2238K used to physically engage a plug. In an example, the stepped surface 2286 is transverse to a rotational axis of the drill bit assembly 2230K and performs a cutting operation.

In an example, the collar 2276 has a tapered body that includes a first outer diameter D1 proximate a trailing or proximal end of the at least one stepped surface 2286 (the leading surface) and a second outer diameter D2 that is less than the first outer diameter D1 at a back end or proximal end of the collar 2276. The reduced diameter taper of the outer diameter of the collar 2276 advantageously provides a radial clearance to reduce friction during rotation which is beneficial when a portion, such as a substantial portion of a length of the body of the collar 2276 is drilled into a workpiece.

FIGS. 22N, 22O, and 22P illustrate first, second, and third side views of the elongate shaft 2232K. To withstand the high torque and axial forces generated during deep drilling, the elongate shaft 2232K includes a secondary flat 2288 and one or more lip features 2290. The set screw 2282 passes through the aperture 2280 of the collar 2276 and securely engages the secondary flat 2288 to lock the collar 2276 rotationally, effectively transmitting the required torque. Additionally, the lip features 2290 act as mechanical stops to inhibit axial movement of the collar 2276 relative to the elongate shaft 2232K during operation.

At a proximal end, the elongate shaft 2232K includes a rear shank portion 2292 and a retention groove 2294 used to axially secure the elongate shaft 2232K within an arbor. The rear shank portion 2292 further includes a rear flat 2296 to accommodate burr formation. The rear flat 2296 is located adjacent to or beneath or proximal the retention groove 2294. During rapid plug ejection cycles, the inertia of the drill bit assembly 2230K pulling forward against a retention bearing may create a burr on the rear shank portion 2292. The rear flat 2296 provides a reduced-diameter clearance area that allows this burr to form without expanding the outer diameter of the rear shank portion 2292, ensuring the elongate shaft 2232K remains easily removable after repeated use.

These configurations of the drill bits 2230A-2230K, including stepped geometries 2240, tapered shafts 2232C, removable stop collars 2252, integrated bearing geometries 2254, integral wider portions 2262, collars 2276, and/or frictional surfaces such as knurled surfaces 2256, dimples 2258, and threaded sections 2260, can improve interaction with the plug during the ejection process. In some cases, these features can increase the likelihood of reliable plug removal while providing adaptability for a range of workpiece and plug materials.

### Example Controlled Drive Pin Actuation

In other embodiments, a holesaw assembly may include a twist collar configured to facilitate controlled actuation of drive pins between retracted and extended positions. Such a holesaw assembly can facilitate a quick-change arrangement for selective engagement and disengagement of the pilot drill and/or the holesaw. For example, the twist collar can include a helical ramp configuration interacting with the drive pins to guide their movement, providing secure positional feedback through detents. In some cases, the holesaw assembly includes a pull collar configured to interact with a drill bit carrier, facilitating controlled axial displacement for plug ejection.

FIGS. 23A-27E illustrate another embodiment of a holesaw assembly 2300 with the holesaw removed. FIGS. 23A and 23B illustrate perspective and exploded views, respectively, of the holesaw assembly 2300, which includes a drill bit 2330, an arbor 2340, and a switch assembly 2345. The holesaw assembly 2300, the drill bit 2330, the arbor 2340, and the switch assembly 2345, may be similar to embodiments or incorporate features of the holesaw assembly 100, 400, 500, 600, 700, 1500; drill bit 30, 430, 630, 730, 1530; arbor 40, 440, 540, 640, 740, 1540; or switch assembly 45, 645, 745, 1575, respectively, described herein and shown across FIGS. 1-22B, with reference numbers having a leading 23 indicating similar features except where otherwise indicated or as will be apparent to one of ordinary skill in the art. Similar to FIGS. 15-22B, the holesaw assembly 2300 illustrates the switch assembly 2345 as including separate collars or switches (e.g., a first collar 2345a and second collar 2345b), each of which may be similar to embodiments or incorporate features of collar or switch 48, 448, 548, 648, 748, 1545a, 1545b described herein and shown across FIGS. 1-22B.

The holesaw assembly 2300 can facilitate the ejection of a plug from within an internal space in the holesaw (not shown) and/or quick release of the holesaw or the drill bit 2330 from the arbor 2340, all without the use of additional tools. For example, the first collar 2345a can be a pull collar that facilitates the removal of plugs from the internal space of a holesaw (not shown), and the second collar 2345b can be a twist collar that facilitates the release of the holesaw and/or the drill bit 2330 from the arbor 2340.

In this embodiment, similar to the holesaw assembly 1500 of FIG. 15, the holesaw assembly 2300 includes a first collar 2345a that serves as a pull collar for facilitating the removal of plugs from the internal space of the holesaw, and a second collar 2345b that serves as a twist collar for facilitating the release of the drill bit 2330 from the arbor 2340. However, here, as compared to the holesaw assembly 1500 of FIG. 15, the drive pins 2363 are not attached to the first collar 2345a. Instead, to facilitate axial movement of the drive pins 2363, the drive pins 2363 interact with the second collar 2345b. In particular, the second collar 2345b incorporates a helical ramp structure 2395, which allows the twisting action of the second collar 2345b to move the drive pins 2363 axially, facilitating secure engagement or retraction of the drive pins 2363. In this way, the second collar 2345b facilitates the release of the holesaw from the holesaw assembly 2300.

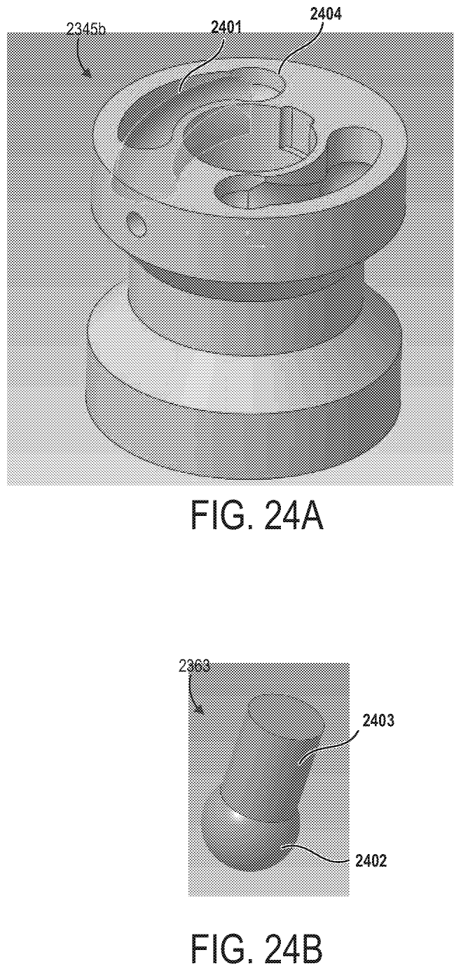

FIG. 24A illustrates a perspective view of the second collar 2345b of the holesaw assembly 2300 of FIG. 23A. The second collar 2345b is generally cylindrical and includes an internal ramp 2401 formed along its inner surface. The internal ramp 2401 has a continuous curved profile with varying heights for guiding the axial movement of the drive pins 2363 when the second collar 2345b is rotated. The collar 2345b includes a radial opening 2404 to accommodate the insertion of the drive pins 2363 and allow for their interaction with the internal ramp 2401.

FIG. 24B illustrates a perspective view of a drive pin 2363 of the holesaw assembly 2300 of FIG. 23A. The drive pin 2363 includes a cylindrical shaft portion 2403 and a rounded ball-shaped end portion 2402. The ball-shaped end portion 2402 is sized and shaped to fit along the internal ramp 2401 of the second collar 2345b, allowing the drive pin 2363 to travel along the internal ramp 2401 as the second collar 2345b is rotated. The shaft portion 2403 extends axially and is configured to engage with openings in a holesaw base when in an extended position.

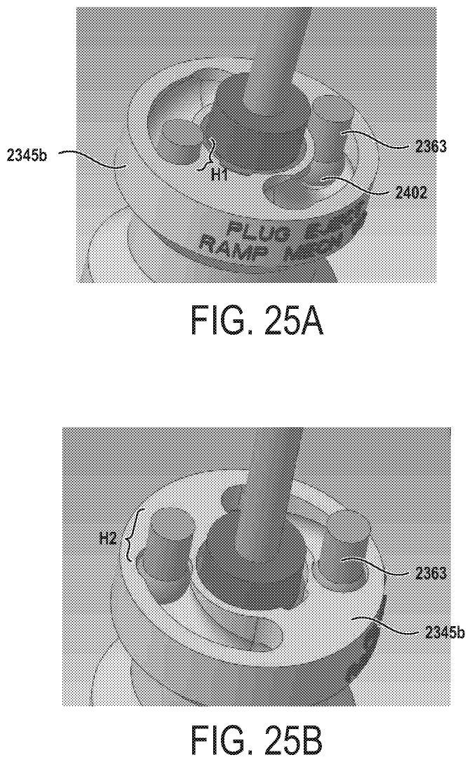

FIGS. 25A and 25B illustrate cross-sectional side views of the holesaw assembly 2300 with drive pins 2363 in retracted and extended positions, respectively, due to the manipulation of the second collar. In the retracted position of the drive pins 2363, as shown in FIG. 25A, the second collar 2345b is positioned such that the helical ramp 2401 aligns the drive pins 2363 with a drive pin height, H1. As mentioned, the internal ramp 2401 includes an internal surface contour within the second collar 2345b, with a gradient or sloped profile that interacts with the ball-shaped end portions 2402 of the drive pins 2363. The drive pin height of H1 allows the drive pins 2363 to rest in a retracted position, further from the holesaw. In this position, the cylindrical shaft portions 2403 of the drive pins 2363 are drawn inward, retracting into radial openings formed in the arbor. This retraction disengages the drive pins 2363 from the holesaw base, creating clearance that facilitates removal of the holesaw.

In some cases, the second collar 2345b includes an integrated detent mechanism that provides tactile or audible feedback to indicate when the drive pins 2363 are fully retracted, fully extended, or some position in-between. The detent mechanism may include a spring-biased ball or a similar component that engages a recess or notch in the second collar 2345b to lock the position temporarily.

In the extended position of the drive pins 2363, as shown in FIG. 25B, the second collar 2345b is repositioned such that the internal ramp 2401 moves the drive pins 2363 axially outward. The relatively higher ramp height, H2, of the helical ramp 2401 forces the ball-shaped end portions 2402 of the drive pins 2363 outward along the sloped surface, causing the cylindrical shaft portions 2403 of the drive pins 2363 to further extend axially outward. This axial extension aligns the drive pins 2363 with corresponding receptacles or openings in the base of the holesaw. In this position, the drive pins 2363 serve to secure the holesaw to the arbor, transmitting torque from the arbor during operation. In some cases, a torsional spring is mechanically coupled to the second collar 2345b, applying a biasing force that naturally urges the collar toward this extended position. This bias may help maintain engagement between the drive pins 2363 and the holesaw under normal operating conditions.

The ball-shaped end portions 2402 of the drive pins 2363 can ride smoothly along the ramp surface of the internal ramp 2401, with the spherical geometry facilitating consistent contact with the helical contours. Although the drive pins 2363 are illustrated as having ball-shaped end portions 2402, it will be appreciated that alternative geometries of the drive pins can include non-spherical configurations, such as, but not limited to, cylindrical, conical, or other shaped ends, to provide similar functionality in interacting with the ramp surface. As another example, the drive pins 2363 can include a cylindrical shaft with a wider, flat flange at one end, designed to engage with the helical ramp. Such a configuration can allow the flange to effectively translate the rotational motion of the twist collar into controlled axial movement of the pins. These variations can facilitate controlled forward and backward motion of the drive pins 2363 along the internal ramp 2401. The internal ramp 2401 itself can be shaped to provide a controlled transition between ramp heights H1 and H2. In some cases, the cylindrical shaft portions 2403 of the drive pins 2363 may fit snugly within the radial openings 2404 of the second collar 2345b and/or the radial openings 2364 of a base support plate 2353 (e.g., shown in FIG. 23B), limiting lateral play while allowing unrestricted axial motion as guided by the internal ramp 2401.

In some cases, the second collar 2345b transitions between the first and second position with relatively little rotational input from the user. For example, in some cases, the second collar 2345b can transition between the first and second positions using less than or equal to one full rotation of the second collar 2345b, such as approximately half or three-quarters of a rotation.

While the holesaw assembly 2300 is depicted with the first collar 2345a configured to provide the plug ejection feature, it should be understood that alternative embodiments of a holesaw assembly may include the second collar 2345b configured to retract the drive pins through rotational motion, without including a collar dedicated to a plug ejection feature.

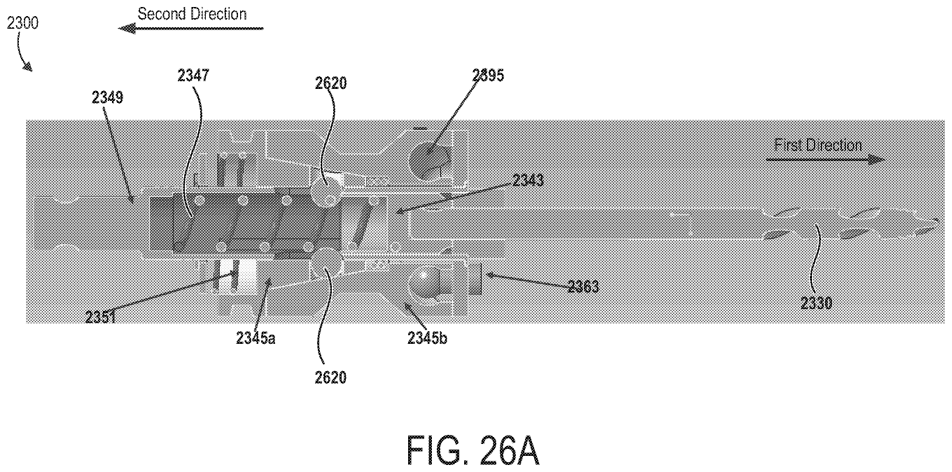

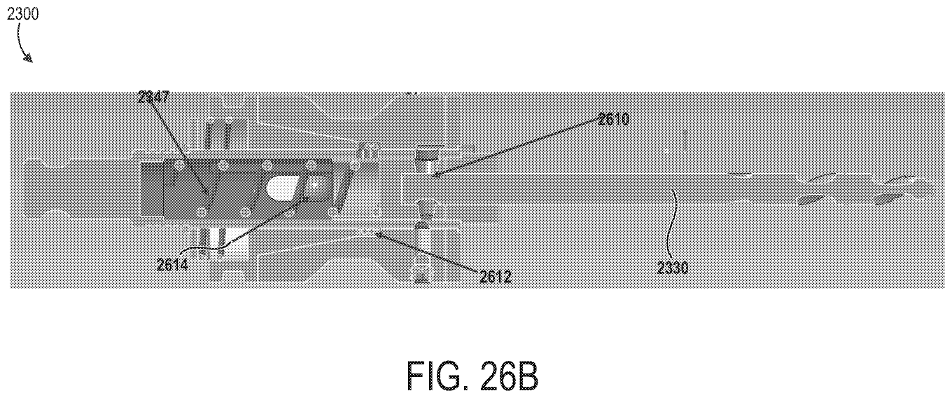

FIGS. 26A and 26B illustrate cross-sectional side views of the holesaw assembly 2300 of FIG. 23A. The holesaw assembly 2300 can include a drill bit 2330, drive pins 2363, a first collar 2345a, a second collar 2345b with a helical ramp structure 2395, a drill bit carrier 2343, a biasing member 2351 (e.g., a spring) housed within the first collar 2345a, and a biasing member 2347 (e.g., a spring) housed within the second collar 2345b, a ball detent 2614 for the first collar 2345a, a torsional spring 2612, and a detent system 2610.

The drill bit 2330 includes a cutting tip and an elongated shaft configured to engage a workpiece. The shaft portion has a rear end couplable to the drill bit carrier 2343, allowing for axial displacement during operation. The drill bit 2330 facilitates both pilot hole creation and plug ejection from the internal space of the holesaw (not shown). The arbor 2340 includes an at least partially hollow front portion configured to house the drill bit carrier 2343 and includes an interface for coupling to a power tool via the shank 2349.

The drill bit carrier 2343 houses the drill bit 2330 and is configured to translate between retracted and extended positions within the arbor 2340. The drill bit carrier 2343 can operate in conjunction with the first collar 2345a, which is axially movable, and/or the second collar 2345b, which includes a helical ramp structure 2395 for drive pin 2363 manipulation. In some cases, the twisting motion of the second collar 2345b not only manipulates the drive pins 2363 via the helical ramp structure 2395 but also engages or disengages a detent mechanism within the drill bit carrier 2343. This detent mechanism can facilitate simultaneous locking and unlocking of the pilot bit 2330 as the drive pins 2363 are manipulated. This combined twisting action can provide coordinated functionality for the manipulation of both the drive pins 2363 and the pilot bit 2330.

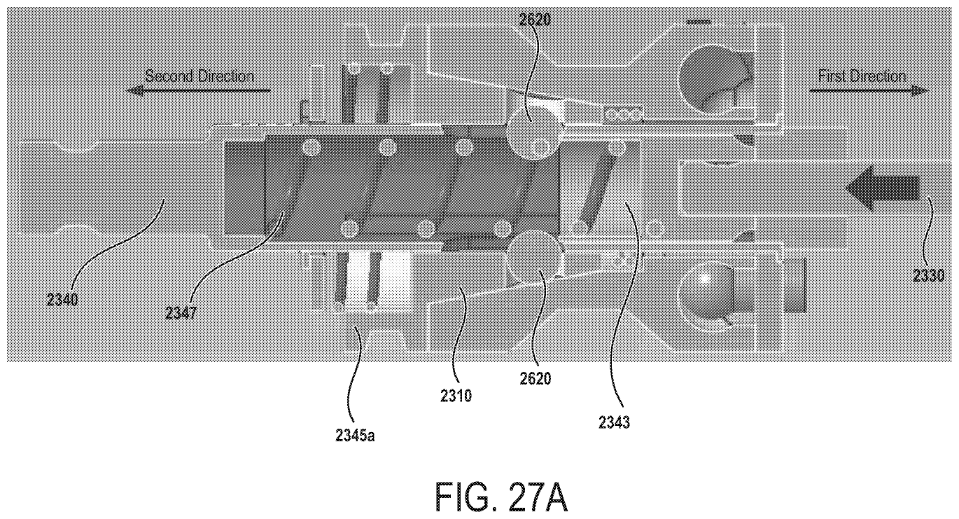

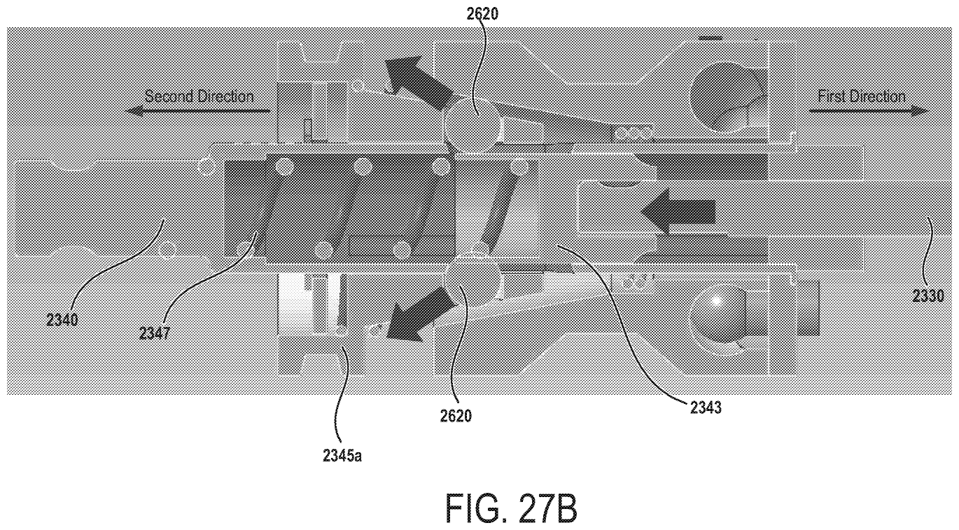

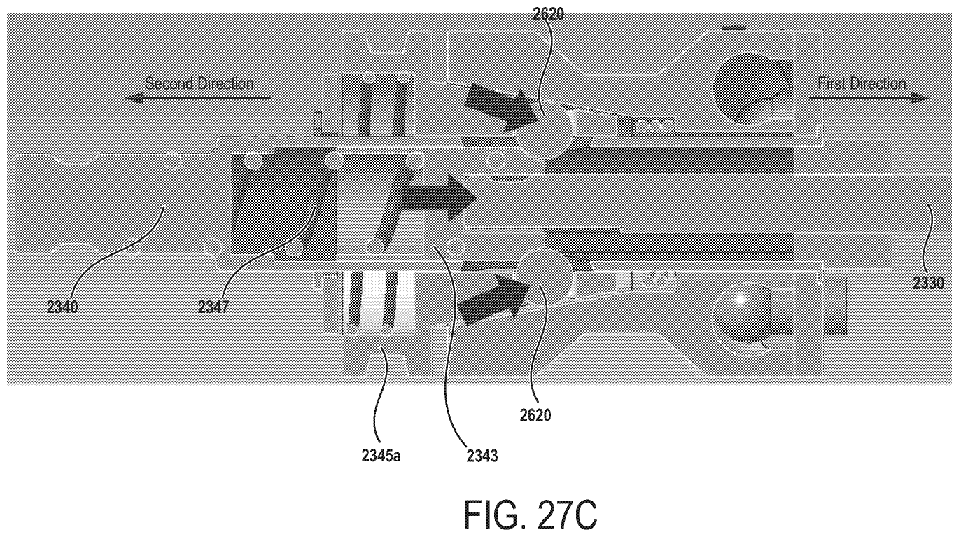

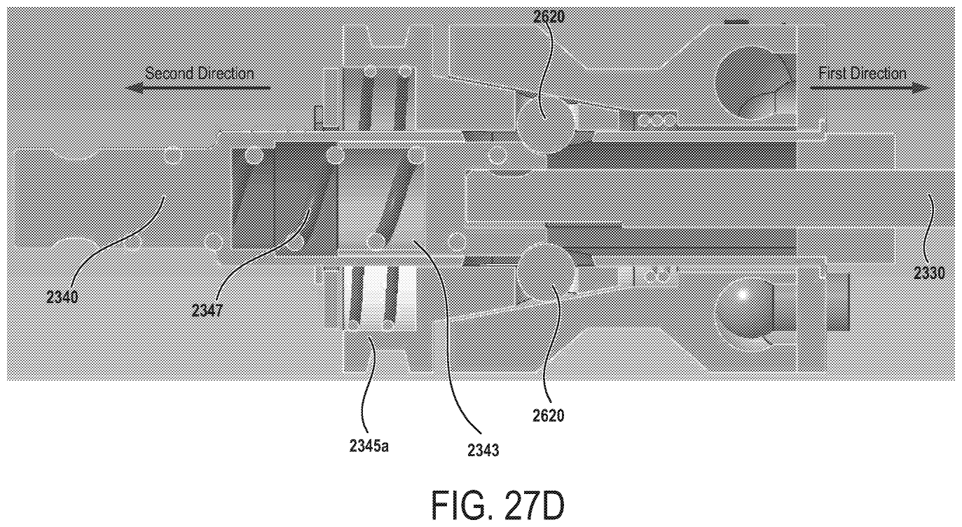

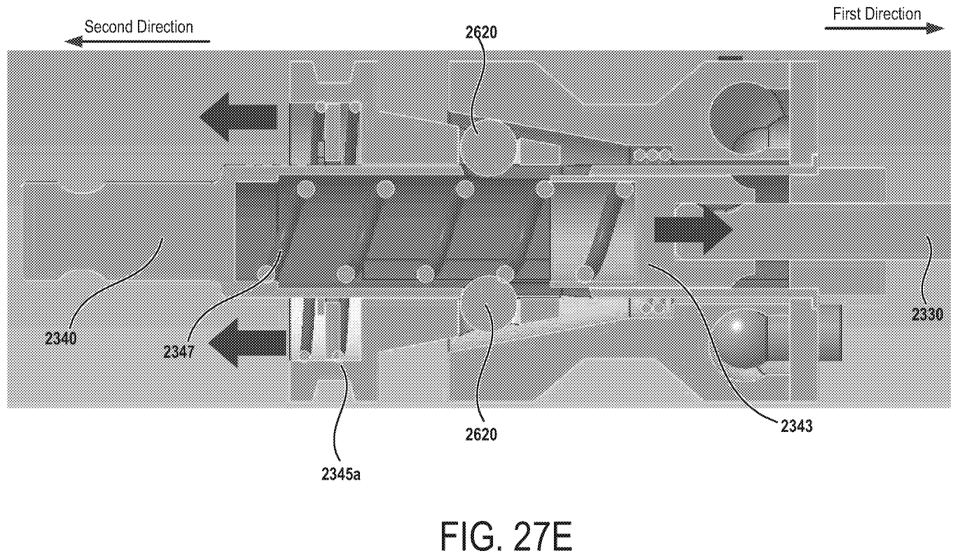

FIGS. 27A through 27E illustrate cross-sectional side views of the holesaw assembly 2300 in various operational states during a plug ejection process, facilitated by the first collar 2345a.

FIG. 27A depicts a first position of the holesaw assembly 2300. Here, the drill bit carrier 2343 is positioned forward (e.g., towards the drill bit), with the first collar 2345a also in a forward position. When the holesaw assembly 2300 is in the first position and the drill bit 2330 is pressed into a workpiece, the drill bit carrier 2343 (containing the drill bit 2330) retracts. The retraction compresses the biasing member 2347 and moves the drill bit carrier 2343 in the second direction, towards the rear of the arbor 2340.

FIG. 27B depicts a second position, which can be an intermediate position as the drill bit carrier 2343 transitions to a fully retracted state. As shown, when the drill bit 2330 retracts, it pushes the drill bit carrier 2343 rearward against the spring bias provided by the biasing member 2347. As the drill bit carrier 2343 slides in the second direction, the detent balls 2620 move radially outward along the tapered interface 2310 of the first collar 2345a. This outward radial movement is accommodated by the geometry of the tapered interface 2310, allowing the drill bit carrier 2343 to move rearward without obstruction by the detent balls 2620.

FIG. 27C illustrates a third position in which the drill bit carrier 2343 has moved sufficiently in the second direction to allow the detent balls 2620 to move radially inward, around the edge of the drill bit carrier 2343, and seat themselves as at least partially protruding into the opening of the arbor 2340. This positioning of the detent balls 2620 blocks the drill bit carrier 2343 from moving in the first direction.

FIG. 27D illustrates a fourth position in which the holesaw assembly 2300 is primed for plug ejection. When in the fourth position, the operator can manually pull the first collar 2345a rearward in the second direction, slightly displacing the drill bit carrier 2343 further rearward. FIG. 27E illustrates a fifth position. As shown in FIG. 27E, this pulling motion of the first collar 2345a rearward in the second direction provides clearance for the detent balls 2620 to move radially outward once again, unlocking the drill bit carrier 2343. This unlocking action allows release of the spring energy stored in the spring member 2347, which causes the drill bit carrier 2343 to move forward in the first direction. This forward motion of the drill bit carrier 2343 causes the drill bit 2330 to engage a plug, if present within the internal space of the holesaw, and can at least partially eject the plug from the holesaw.

### Holesaw Seating and Drive Pin Engagement

In some holesaw assemblies, the base of a holesaw is threaded onto an arbor body so that the holesaw base comes into contact with the arbor for stable coupling and effective torque transfer. The holesaw advances along the arbor threads until the base approaches a seating position, at which point drive pins of the arbor are received within corresponding apertures in the base of the holesaw to resist relative rotation. In practice, the holesaw is typically tightened until its base contacts the arbor surface. However, alignment between the apertures in the holesaw base and the drive pins of the arbor may not occur at this fully tightened position. To achieve alignment, a user may loosen the holesaw slightly so that the apertures align with the pins, thereby allowing the pins to be fully received. This loosening action can create a gap between the base of the holesaw and the arbor surface. The presence of such a gap may reduce stability of the connection and permit relative movement during cutting. Furthermore, in some cases a user may apply excessive tightening force in an attempt to force alignment, which can increase wear on the arbor components and reduce assembly efficiency.

Some inventive concepts described herein relate to providing a resilient interface between the arbor and the base of the holesaw that allows controlled axial compliance during installation. In some embodiments, a resilient member, such as an elastomeric O-ring, is positioned between a support surface of the arbor body (e.g., a support washer) and a base support plate. The base support plate defines openings through which drive pins of the arbor extend. As the holesaw is threaded onto the arbor, the base of the holesaw advances toward the base support plate. Depending on tolerances, the base of the holesaw may engage the base support plate and begin to compress the resilient member as threading approaches the seated position. Compression of the resilient member provides a degree of axial play, which can in some cases allow a user to continue rotating the holesaw a portion of a turn (e.g., up to about 90°, 120°, or 180°) until apertures in the base align with the drive pins. The resilient member biases the base support plate toward the holesaw base so that, after the holesaw is seated, the base is held firmly against the arbor, providing a stable connection that resists wobble and vibration while still permitting controlled compliance during installation.

By introducing elastomeric compliance at this interface, the assembly allows the holesaw to be secured in a way that reduces the likelihood of excessive tightening and reduces the potential for gaps between the holesaw base and the base support plate. This configuration facilitates proper seating even in the presence of thread tolerances and provides a connection that promotes reliable torque transfer and cutting stability while supporting durability of arbor components.

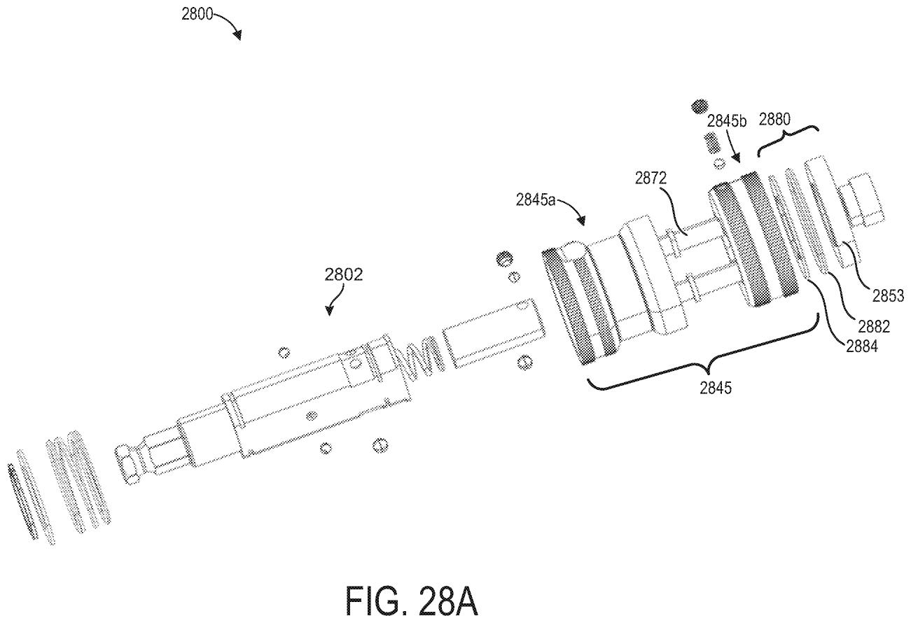

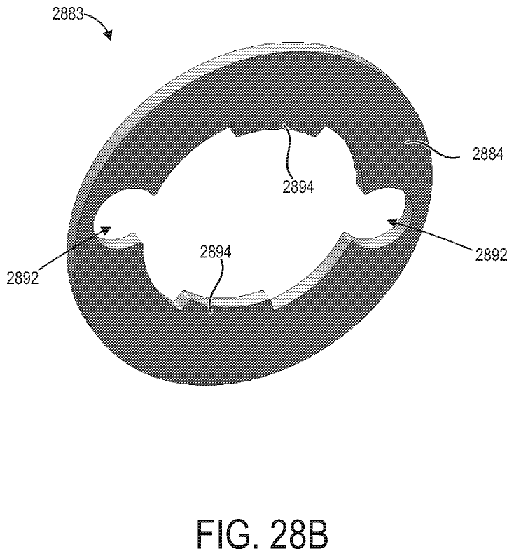

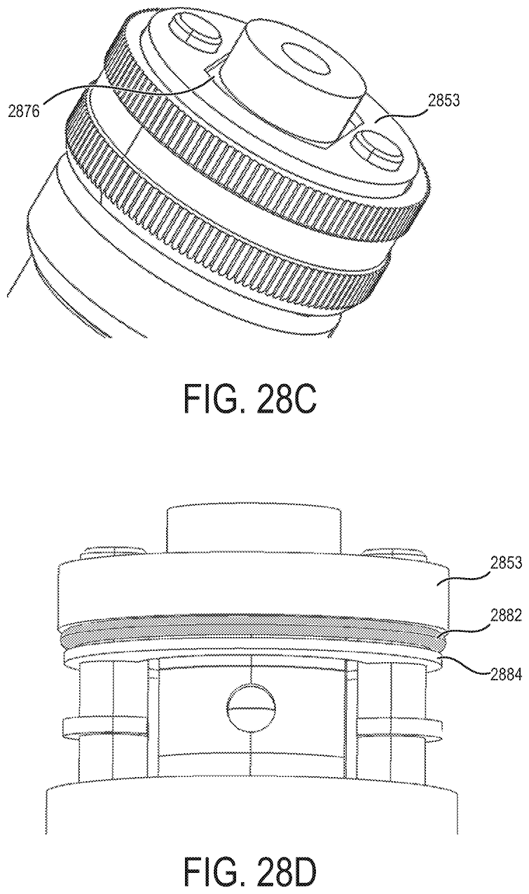

FIG. 28A illustrates an exploded view of another embodiment of an arbor assembly 2800. The arbor assembly 2800 includes an arbor body 2802, a plurality of drive pins 2872, a switch assembly 2845, and a resilient interface 2880 configured to provide controlled axial compliance between the arbor assembly 2800 and a holesaw (not shown). The drive pins 2872 extend through openings in the resilient interface 2880 and are receivable in apertures of a holesaw (not shown).

The arbor assembly 2800 illustrates a switch assembly 2845 that includes separate collars or actuators, such as a first actuator or collar 2845a and a second actuator or collar 2845b, either of which may be similar to embodiments or incorporate features of collar or switch 48, 448, 548, 648, 748, described herein and shown across FIGS. 1-14, and/or a first actuator/collar 1545a or 2345a (plug-eject) and/or a second actuator/collar 1545b or 2345b (quick-change), described herein and shown across FIGS. 15-27E.

In some embodiments, the drive pins 2872 may be retractable to facilitate installation and removal of a holesaw from the arbor assembly 2800. For example, one or both of the actuator or collar 2845a or 2845b may be similar to or an embodiment of the second actuator/collar 1545a or 1545b, described herein. In some cases, the collar positioned closest to the shank (e.g., actuator or collar 2845a) actuates the drive pins. For example, axial displacement of the actuator or collar 2845a or 2845b can cause the drive pins 2872 to withdraw at least partially through openings in the base support plate 2853, also disengaging from apertures in the base of a holesaw when the holesaw is attached. This retracted position permits the holesaw to be threaded on or off the arbor assembly 2800 without obstruction from the pins, while the extended position of the pins facilitates torque transfer during cutting operations.

The resilient interface 2880 can include a base support plate 2853, a support surface 2884, and a resilient member 2882 disposed between the support surface 2884 and the base support plate 2853. The base support plate 2853 is disposed adjacent the arbor body 2802 and defines a plurality of openings through which the drive pins 2872 extend. The base support plate 2853 can serve as a bearing surface for the drive pins 2872, aiding their alignment with lateral openings in the base of the holesaw 1520. A portion of the arbor assembly 2800 may extend through an opening in the base support plate 2853 to maintain concentric alignment of the base support plate within the arbor assembly 2800. The base support plate 2853 is supported for axial movement relative to the arbor body 2802 and is biased toward the holesaw by the resilient member 2882. As the base of a holesaw progresses through contact with the base support plate 2853, the resilient member 2882 is compressed between the base support plate 2853 and the support surface 2884. The base support plate 2853 translates axially in response to compression, providing controlled compliance that compensates for thread tolerances (e.g., when engagement between the arbor assembly 2800 and the holesaw is a threaded connection) and permits limited rotational adjustment of the holesaw until apertures in the holesaw base align with the drive pins 2872. Once alignment is achieved, the biasing force of the resilient member 2882 continues to urge the base support plate 2853 into firm engagement with the holesaw base, thereby promoting stable seating, reliable torque transfer, and reduced vibration during cutting.

The resilient member 2882 of the resilient interface 2880 may be formed of an elastomeric material, such as, but not limited to, an O-ring, a rubber ring, coil springs, wave springs, or compressible pads. The resilient member 2882 is disposed between the base support plate 2853 of the resilient interface 2880 and the support surface 2884 of the resilient interface 2880 and provides a biasing force that urges the base support plate 2853 toward the base of a holesaw (not shown) during installation and operation. By applying this bias, the resilient member 2882 introduces controlled axial compliance into the resilient interface 2880, allowing the base support plate 2853 to compress under load while maintaining continuous contact with the holesaw base. This compliance accommodates variations in thread tolerances, reduces the likelihood of gaps or excessive tightening, and permits limited rotational play that assists in aligning apertures of the holesaw base with the drive pins 2872. During cutting, the resilient member 2882 maintains preload at the resilient interface 2880, thereby promoting stable seating, reliable torque transfer, reduced vibration, and increased durability of the arbor assembly 2800 components.

The axial compliance afforded by the resilient member 2882 of the resilient interface 2880 can provide a controlled range of rotational “play” during the final portion of installation of a holesaw (not shown). In some embodiments, compression of the resilient member 2882 allows the holesaw to continue rotating by a limited fraction of a turn after the base of the holesaw first contacts the base support plate 2853. For example, the additional rotation may be on the order of about 30°, 45°, 60°, 90°, 120°, 180°, or even a full turn, depending on the thickness and stiffness of the resilient member 2882 and the pitch of the threaded connection between the arbor body 2802 and the holesaw. This rotational play permits the apertures in the base of the holesaw to align with the drive pins 2872 at or near the seating condition, even in the presence of thread or manufacturing tolerances. By providing this compliance, the resilient interface 2880 facilitates consistent alignment, promotes firm contact between the holesaw base and arbor-side components such as the support surface 2884 and base support plate 2853, and reduces the likelihood of gaps or excessive tightening otherwise required to achieve engagement.

The support surface 2884 of the resilient interface 2880 provides a fixed reaction structure against which the resilient member 2882 is compressed. In the illustrated embodiment, the support surface 2884 is provided by a washer that is secured relative to the arbor body 2802 so that it is held in place during installation and operation. In this position, the support surface 2884 establishes a stable wall that resists axial displacement and allows the resilient member 2882 to develop a consistent biasing force. In some embodiments, the support surface 2884 may be provided by a discrete washer component. In some embodiments, the support surface 2884 may be formed as part of the arbor body 2802. The support surface 2884 contributes to the controlled axial compliance of the resilient interface 2880 and provides a stable foundation for load transfer during use. In contrast to some prior designs that may position an elastomeric element behind a movable plate, the resilient interface 2880 provides compliance by locating the resilient member 2882 between a fixed support surface 2884 and a base support plate 2853 through which drive pins 2872 extend. This configuration stabilizes the base support plate while still permitting axial displacement and alignment, thereby ensuring consistent seating and reliable torque transfer.

Although the resilient interface 2880 is discussed herein in connection with an arbor assembly 2800 that includes one or more collars or actuators (e.g., collars 2845a, 2845b), it should be appreciated that the concepts of the resilient interface 2880 are not limited to such configurations. The resilient interface 2880 may be implemented in a wide range of arbor assemblies, including arbor assemblies that omit collars or actuators entirely, as well as arbor assemblies incorporating any of the collar or switch configurations described herein (e.g., collars or switches 48, 448, 548, 648, 748 and collars 1545a, 1545b, 2345a, 2345b). More generally, the resilient interface 2880 may be applied in connection with any of the arbor assemblies or holesaw assemblies described herein, providing controlled axial compliance to improve seating, alignment, and/or stability during use.

FIG. 28B illustrates an embodiment of a support washer 2883, which provides a support surface 2884. The support washer 2883 defines one or more through holes 2892 that permit the drive pins 2872 to extend forwardly through the support washer 2883 toward the base of a holesaw. The support washer 2883 includes protrusions 2894 configured to engage corresponding features of the arbor body 2802 so that the support washer 2883 is held in place relative to the arbor body 2802. In this manner, the support washer 2883 establishes a generally fixed axial reaction surface against which the resilient member 2882 (FIG. 28A) is compressed when the base support plate 2853 is urged rearward. By providing this stable reaction surface, the support washer 2883 allows the resilient member 2882 to deliver a substantially consistent biasing force and controlled axial compliance within the resilient interface 2880.

FIG. 28C illustrates a detail view of a portion of the resilient interface 2880 of the holesaw assembly 2800 of FIG. 28A, showing the resilient member 2882 compressed between the base support plate 2853 and the support surface 2884. FIG. 28D illustrates another detail view of a portion of the resilient interface 2880. In this condition, the resilient member 2882 provides a biasing force that urges the base support plate 2853 forward toward the base of a holesaw (not shown) while still permitting limited axial displacement of the base support plate 2853 relative to the arbor body 2802. FIG. 28C illustrates a protrusion 2876 formed on the base support plate 2853, the protrusion being configured to engage with a corresponding feature of the arbor body 2802 so as to limit axial travel and provide a reaction surface that allows compression of the resilient member 2882.

In the illustrated embodiment, the base support plate 2853 includes a protrusion 2876 extending above a forward-most surface of the arbor body that is generally parallel to the base of the holesaw. This protrusion 2876 provides an initial forward offset of the base support plate 2853 relative to the arbor body surface so that, when no holesaw is attached, the base support plate projects axially outward. As a holesaw is threaded onto the arbor, the base of the holesaw engages the protruding base support plate 2853 prior to contacting the parallel arbor body surface. In this way, the base of the holesaw begins to compress the resilient member 2882 as the saw advances toward a fully seated position. The protrusion 2876 thus defines a reaction surface that allows the resilient member 2882 to be compressed during installation. In some cases, if the base support plate 2853 did not initially protrude relative to the arbor body surface, the holesaw would advance directly to the fully seated position against the arbor body without compression of the resilient member 2882, thereby negating the compliant effect provided by the resilient interface 2880.

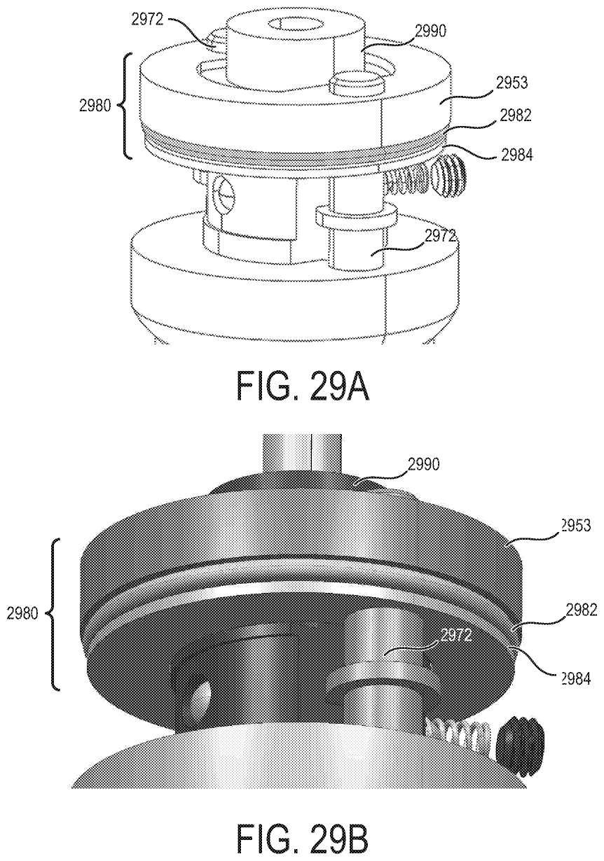

FIGS. 29A and 29B illustrate another embodiment of a resilient interface 2980 in which a base support plate 2953 is biased toward the base of a holesaw by a resilient member 2982 positioned against a support surface 2984. Drive pins 2972 extend through the base support plate 2953 for engagement with apertures in a holesaw (not shown), while a portion of the arbor body 2990 extends centrally through the base support plate 2953.

### Example Embodiments

Embodiments of the present disclosure can be described in view of the following clauses:

Clause 1. A hole cutting assembly comprising:
a cutting tool defining an internal space configured to receive a plug of material formed during a cutting operation, the cutting tool having a cutting edge and a base;
an arbor coupled to the cutting tool and configured to rotate the cutting tool during the cutting operation;
a drill bit having a cutting tip configured to create a pilot hole in a workpiece and a shaft configured to be coupled to the arbor, the drill bit movable relative to the arbor along a longitudinal axis between an extended position and a retracted position;
a retainer associated with the arbor and configured to selectively maintain the drill bit in the retracted position;
a biasing member configured to exert a force on the drill bit to move the drill bit toward the extended position when the retainer is disengaged; and a release actuator operable to release the retainer, wherein movement of the drill bit toward
the extended position causes the drill bit to apply an ejection force to at least partially dislodge the plug from the internal space of the cutting tool.

Clause 2. The hole cutting assembly of clause 1, wherein the arbor comprises a helical channel and a drill bit carrier to which the drill bit is configured to be coupled, the drill bit carrier having at least one projection configured to engage with the helical channel, such that rotation of the arbor relative to the drill bit carrier facilitates the movement of the drill bit along the longitudinal axis between the extended position and the retracted position.

Clause 3. The hole cutting assembly of any of the preceding clauses, wherein the arbor comprises an axial channel and a drill bit carrier to which the drill bit is configured to be coupled, the drill bit carrier having at least one projection configured to engage with the axial channel, wherein the axial channel facilitates movement of the drill bit along the longitudinal axis between the extended position and the retracted position through compression of the drill bit or release of the retainer.

Clause 4. The hole cutting assembly of any of the preceding clauses, further comprising a visual indicator disposed on the arbor, the visual indicator providing an indication of whether the drill bit is in the extended position or the retracted position.

Clause 5. The hole cutting assembly of any of the preceding clauses, wherein the retainer includes at least one projection that engages a recess within the arbor to maintain the drill bit in the retracted position, and wherein disengagement of the projection allows movement of the drill bit toward the extended position.

Clause 6. The hole cutting assembly of any of the preceding clauses, wherein the release actuator comprises a collar positioned about the arbor, the collar being movable along the longitudinal axis of the arbor to actuate the release of the retainer.

Clause 7. The hole cutting assembly of any of the preceding clauses, wherein the biasing member comprises a compression spring configured to exert an axial force on the drill bit to move the drill bit toward the extended position upon release of the retainer.

Clause 8. The hole cutting assembly of any of the preceding clauses, wherein the cutting tool comprises a holesaw with a cylindrical wall extending from the base, the wall defining the internal space, and wherein the drill bit is configured to mechanically and/or frictionally engage the plug during movement toward the extended position to facilitate at least partially dislodging the plug.

Clause 9. The hole cutting assembly of any of the preceding clauses, wherein the cutting tool further comprises a plurality of teeth on the cutting edge, the teeth configured to form a cylindrical cut in a workpiece during rotation by the arbor.

Clause 10. The hole cutting assembly of any of the preceding clauses, wherein the arbor further includes a quick-release actuator configured to facilitate removal of at least one of the cutting tool or the drill bit without requiring additional tools.

Clause 11. The hole cutting assembly of any of the preceding clauses, wherein the quick-release actuator comprises a collar positioned about the arbor, the collar being rotatable about the arbor to actuate the release of the drill bit.

Clause 12. The hole cutting assembly of any of the preceding clauses, wherein the retainer is biased into an engaged position by a retainer spring.

Clause 13. The hole cutting assembly of any of the preceding clauses, wherein the release actuator is operable to provide a plurality of modes including a first mode for retaining the drill bit in the retracted position, a second mode for releasing the drill bit to move toward the extended position, and a third mode for allowing removal of the drill bit from the arbor.

Clause 14. The hole cutting assembly of any of the preceding clauses, wherein the drill bit further comprises a textured surface configured to enhance frictional engagement with the plug.

Clause 15. The hole cutting assembly of any of the preceding clauses, wherein the arbor and the holesaw are configured to rotate in unison during the cutting operation, and wherein the drill bit is configured to rotate independently of the arbor when in the extended position.

Clause 16. The hole cutting assembly of any of the preceding clauses, wherein at least one of an exterior surface of the drill bit carrier or an interior surface of the arbor defines a groove, and wherein the hole cutting assembly further comprises an alignment element configured to engage with the groove, the alignment element being operatively coupled to the other of the drill bit carrier or the arbor, such that the groove and the alignment element cooperate to rotationally fix the drill bit carrier relative to the arbor while permitting axial movement of the drill bit carrier and the drill bit supported therein.

Clause 17. The hole cutting assembly of clause 16, wherein the alignment element comprises a bearing, pin, or projection extending radially from the surface opposite the groove.

Clause 18. The hole cutting assembly of clause 16, wherein the groove extends substantially parallel to an axis of the arbor and is configured to allow axial translation of the drill bit carrier within the arbor.

Clause 19. A holesaw arbor assembly, comprising:
a shank including:
a first portion couplable to a tool holder of a power tool,
a second portion couplable to a holesaw;
a drill bit carrier movably coupled to the shank and configured to be couplable to a drill bit, the drill bit carrier configured to move relative to the shank between an extended position and a retracted position, the drill bit carrier being closer to the first portion of the shank in the retracted position than in the extended position; and
a retainer configured to selectively maintain the drill bit carrier in the retracted position, wherein release of the retainer permits movement of the drill bit carrier toward the extended position.

Clause 20. The holesaw arbor assembly of clause 19, further comprising a biasing member configured to exert an ejection force on the drill bit carrier upon release of the retainer when the drill bit is in the retracted position, the ejection force being sufficient to move the drill bit carrier toward the extended position and at least partially eject a plug from the holesaw.

Clause 21. The holesaw arbor assembly of any of clauses 19 to 20, further comprising a release actuator including a collar positioned about an exterior surface of the shank, the collar being movable between at least a first position and a second position, the second position corresponding to the release of the retainer.

Clause 22. The holesaw arbor assembly of any of clauses 19 to 21, wherein the shank includes a helical channel, and wherein the drill bit carrier includes at least one projection engageable with the helical channel, such that rotation of the shank relative to the drill bit carrier causes retraction of the drill bit carrier from the extended position toward the retracted position.

Clause 23. The holesaw arbor assembly of any of clauses 19 to 22, wherein the shank includes an axial channel, and wherein the drill bit carrier includes at least one projection engageable with the axial channel, wherein the axial channel facilitates movement of the drill bit along the longitudinal axis between the extended position and the retracted position through compression of the drill bit or release of the retainer.

Clause 24. The holesaw arbor assembly of any of clauses 19 to 23, further comprising a visual indicator positioned on the arbor, the visual indicator configured to provide an indication of whether the drill bit is in the extended position or the retracted position.

Clause 25. The holesaw arbor assembly of any of clauses 19 to 24, wherein the retainer includes at least one projection cooperatively engageable with a recess in the arbor, and wherein release of the retainer comprises movement of the at least one projection from an engaged position with the recess to a non-engaged position.

Clause 26. The holesaw arbor assembly of any of clauses 19 to 25, wherein the drill bit is configured to form a pilot hole in a workpiece when in the extended position, and wherein rotation of the arbor facilitates movement of the drill bit from the extended position to the retracted position for subsequent cutting by the holesaw.

Clause 27. A holesaw arbor assembly comprising:
a shank extending along a longitudinal axis and having a proximal end configured to be coupled with a tool holder of a power tool and a distal end configured to be coupled with a holesaw;
a drill bit carrier at least partially received within the shank, the drill bit carrier movable between a retracted position and an extended position along the longitudinal axis relative to the shank;
a drill bit couplable to the drill bit carrier and configured to extend axially from the shank;
a collar movable between a first position and a second position;
a lock configured to selectively restrict axial movement of the drill bit carrier when the drill bit carrier is in the first position; and
a spring configured to bias the drill bit carrier toward the second position,
wherein the collar, when moved to the second position, releases the lock and allows the drill bit carrier and drill bit to move toward the extended position to at least partially eject a plug formed in the holesaw.

Clause 28. A holesaw arbor assembly comprising:
a shank including a proximal end configured to couple with a tool holder of a power tool and a distal end configured to be coupled with a holesaw;
a collar rotationally coupled to the shank;
a lock operatively coupled to the collar, the lock configured to move radially to engage or release a drill bit; and
a detent configured to define at least two rotational positions of the collar, wherein: in a first rotational position, the lock is configured to secure the drill bit within the shank; and
in a second rotational position, the lock is configured to release the drill bit.

Clause 29. A holesaw arbor assembly comprising:
a shank extending along a longitudinal axis and configured to couple with a tool holder of a power tool;
a base coupled to the shank and configured to couple with a holesaw;
a drill bit carrier at least partially received within the shank, the drill bit carrier coupleable to a drill bit and movable between a retracted position and an extended position;
a plug eject actuator operatively coupled to the shank and movable between a first position to retain the drill bit carrier in the retracted position and a second position to enable movement of the drill bit carrier toward the extended position to at least partially eject a plug formed in the holesaw; and
a drill bit release actuator operatively coupled to the shank and movable between a locked position to couple the drill bit to the drill bit carrier and an unlocked position to release the drill bit from the drill bit carrier.

Clause 30. The holesaw arbor assembly of clause 29, further comprising a detent system operatively associated with the drill bit release actuator and the plug eject actuator, the detent system configured to inhibit movement of the plug eject actuator when the drill bit release actuator is in the unlocked position, and inhibit movement of the drill bit release actuator to the unlocked position when the plug eject actuator is in a second position.

Clause 31. A drill bit for use in a holesaw assembly, comprising:
an elongate shaft having a cutting tip at a first end, a shank at a rear end, and a shaft extending rearward from the cutting tip toward the shank, the shaft having an outer surface and at least one flute formed in the shaft; and
a mechanical engagement surface formed on a portion of the shaft, the mechanical engagement surface distinct from the outer surface and the at least one flute of the shaft, wherein the mechanical engagement surface is configured to mechanically and/or frictionally engage an inner surface of a pilot hole of a plug formed within a holesaw, wherein the mechanical engagement surface provides frictional engagement that inhibits the drill bit from sliding entirely through the pilot hole and facilitates at least partial ejection of the plug from the holesaw when the drill bit is moved axially relative to the holesaw.

Clause 32. The drill bit of clause 31, wherein the mechanical engagement surface comprises threads.

Clause 33. The drill bit of clause 31, wherein the mechanical engagement surface comprises a roughened surface.

Clause 34. The drill bit of clause 31, wherein the mechanical engagement surface comprises one or more ridges or grooves.

Clause 35. A holesaw assembly comprising:
an arbor having a proximal end configured to engage a power tool and a distal end configured to receive a holesaw;
a holesaw removably coupled to the distal end of the arbor, the holesaw including a base with a plurality of openings;
a collar rotatably coupled to the arbor, the collar comprising an internal ramp extending between a first ramp height corresponding to a retracted position and a second ramp height corresponding to an extended position;
a plurality of drive pins coupled to the collar and configured to interact with the ramp of the collar; and
wherein rotational movement of the collar causes movement of the drive pins between the retracted position and the extended position, such that in the retracted position, the drive pins are aligned with the first ramp height, causing the drive pins to at least partially retract and disengage from the openings in the holesaw; and in the extended position, the drive pins are aligned with the second ramp height, causing the drive pins to extend outward from the arbor and engage the openings in the holesaw.

Clause 36. The holesaw assembly of clause 35, wherein the holesaw is threadably coupled to the distal end of the arbor, and the drive pins provide additional engagement to resist rotational decoupling of the holesaw during operation.

Clause 37. The holesaw assembly of any of clauses 35 to 36, wherein the extended position and the retracted position of the drive pins are separated by less than a full turn of the collar about the arbor.

Clause 38. The holesaw assembly of any of clauses 35 to 37, wherein the extended position and the retracted position of the drive pins are separated by less than a half turn of the collar about the arbor.

Clause 39. The holesaw assembly of any of clauses 35 to 38, wherein the extended position and the retracted position of the drive pins are separated by less than a quarter turn of the collar about the arbor.

Clause 40. The holesaw assembly of any of clauses 35 to 39, wherein the retracted position of the drive pins corresponds to a configuration in which the rotational movement of the collar also disengages the drill bit from a drill bit carrier, enabling removal of the drill bit from the arbor.

Clause 41. The holesaw assembly of any of clauses 35 to 40, wherein the collar is a first collar, wherein the holesaw assembly further comprises a second collar configured to provide a plug ejection feature to at least partially eject a plug from an internal space of the holesaw.

Clause 42. A drill bit for use in a holesaw assembly, comprising: an elongate shaft having a cutting tip at a distal end and a rear shank at a proximal end, the elongate shaft defining at least one flute; and an increased diameter portion that extends from a shoulder located along the elongate shaft and that defines a mechanical engagement surface configured to engage a plug formed within a holesaw to facilitate at least partial ejection of the plug.

Clause 43. The drill bit of clause 42, wherein the rear shank includes a retention groove and a rear flat located adjacent to the retention groove, the rear flat configured to accommodate burr formation without expanding an outer diameter of the rear shank.

Clause 44. The drill bit of clause 42, further comprising a recessed portion adjacent a trailing edge of the flute, the recessed portion defining a radial clearance configured to reduce friction.

Clause 45. A drill bit assembly for use in a holesaw assembly, comprising: an elongate shaft; and a collar defining a central bore configured to receive the elongate shaft, the collar defining a mechanical engagement surface configured to engage a plug formed within a holesaw to facilitate at least partial ejection of the plug, wherein the collar includes at least one flute.

Clause 46. The drill bit assembly of clause 45, wherein the collar has a total axial length and the at least one flute has an axial flute length, wherein the axial flute length is at least approximately 70% of the total axial length.

Clause 47. The drill bit assembly of clause 45, wherein the collar includes a leading surface defining a first outer diameter and a rear end portion defining a second outer diameter that is less than the first outer diameter and that provides a radial clearance.

Clause 48. The drill bit assembly of clause 45, wherein the elongate shaft includes a flat surface and a lip, wherein the collar is non-rotationally coupled to the flat surface, and wherein the lip inhibits axial movement of the collar relative to the elongate shaft.

Clause 49. The drill bit assembly of clause 48, further comprising a set screw that engages the flat surface to non-rotationally couple the collar to the elongate shaft.

Clause 50. The drill bit assembly of clause 45, wherein the mechanical engagement surface comprises a stepped surface that is transverse to a longitudinal axis of the drill bit assembly and is configured to perform a cutting operation.

Clause 51. The drill bit assembly of clause 45, wherein the elongate shaft includes a rear shank having a retention groove and a rear flat located adjacent to the retention groove to accommodate burr formation.

Additional embodiments of the present disclosure can be described in view of the following clauses:

Clause 1. An arbor assembly for a holesaw, comprising:
an arbor body extending along an axis and having a first threaded portion configured to engage a second threaded portion of a holesaw;
a drive pin supported by the arbor body and configured to engage an aperture in a base of the holesaw;
a base support plate movable axially relative to the arbor body and configured to support the base of a holesaw;
a support surface non-movable axially relative to the arbor body; and
a resilient member disposed between the support surface and the base support plate, the resilient member biasing the base support plate axially toward the base of the holesaw.

Clause 2. The arbor assembly of Clause 1, wherein the resilient member is positioned such that seating of the base of the holesaw against the base support plate causes the base support plate to move toward the support surface against a biasing force of the resilient member.

Clause 3. The arbor assembly of any of the preceding clauses, wherein the resilient member comprises at least one of an elastomeric ring, a coil spring, a wave spring, or an elastomeric pad.

Clause 4. The arbor assembly of any of the preceding clauses, wherein the support surface is integral with the arbor body.

Clause 5. The arbor assembly of any of the preceding clauses, wherein the support surface comprises a washer coupled to the arbor body.

Clause 6. The arbor assembly of Clause 5, wherein the washer defines an opening configured to receive a first portion of the arbor body, and comprises protrusions configured to engage second portions of the arbor body so as to inhibit axial displacement of the washer relative to the arbor body.

Clause 7. The arbor assembly of any of the preceding clauses, wherein the resilient member permits relative rotational adjustment of the holesaw with respect to the arbor body of less than one full turn of a threaded engagement between the first threaded portion and the second threaded portion.

Clause 8. The arbor assembly of any of the preceding clauses, wherein the base support plate defines an opening through which the drive pin extends.

Clause 9. An arbor assembly for a holesaw, comprising:
a shank including:
a first portion couplable to a tool holder of a power tool,
a second portion couplable to a holesaw;
a drive pin supported by the shank and configured to engage an aperture in a base of the holesaw;
a base support plate movable axially relative to the arbor body and configured to support the base of a holesaw;
a support surface non-movable axially relative to the shank; and
a resilient member disposed between the support surface and the base support plate, the resilient member biasing the base support plate axially toward the base of the holesaw;
a drill bit carrier movably coupled to the shank and configured to be couplable to a drill bit, the drill bit carrier configured to move relative to the shank between an extended position and a retracted position, the drill bit carrier being closer to the first portion of the shank in the retracted position than in the extended position; and
a retainer configured to selectively maintain the drill bit carrier in the retracted position, wherein release of the retainer permits movement of the drill bit carrier toward the extended position.

Clause 10. The arbor assembly of any of the preceding clauses, wherein the resilient member is positioned such that seating of the base of the holesaw against the base support plate causes the base support plate to move toward the support surface against a biasing force of the resilient member.

Clause 11. The arbor assembly of any of the preceding clauses, wherein the second portion includes a first threaded portion configured to engage a second threaded portion of the holesaw, and wherein the resilient member permits relative rotational adjustment of the holesaw with respect to the arbor body by less than one full turn of a threaded engagement between the first threaded portion and the second threaded portion.

Clause 12. The arbor assembly of any of the preceding clauses, wherein the resilient member comprises at least one of an elastomeric ring, a coil spring, a wave spring, or an elastomeric pad.

Clause 13. The arbor assembly of any of the preceding clauses, wherein the support surface comprises a washer coupled to the arbor body.

Clause 14. The arbor assembly of any of the preceding clauses, further comprising a biasing member configured to exert an ejection force on the drill bit carrier upon release of the retainer when the drill bit is in the retracted position, the ejection force being sufficient to move the drill bit carrier toward the extended position and at least partially eject a plug from the holesaw.

Clause 15. The arbor assembly of any of the preceding clauses, further comprising a release actuator including a collar positioned about an exterior surface of the shank, the collar being movable between at least a first position and a second position, the second position corresponding to the release of the retainer.

Clause 16. The arbor assembly of any of the preceding clauses, wherein the shank includes a helical channel, and wherein the drill bit carrier includes at least one projection engageable with the helical channel, such that rotation of the shank relative to the drill bit carrier causes retraction of the drill bit carrier from the extended position toward the retracted position.

Clause 17. The arbor assembly of any of the preceding clauses, wherein the shank includes an axial channel, and wherein the drill bit carrier includes at least one projection engageable with the axial channel, wherein the axial channel facilitates movement of the drill bit along the longitudinal axis between the extended position and the retracted position through compression of the drill bit or release of the retainer.

Clause 18. The arbor assembly of any of the preceding clauses, wherein the base support plate defines an opening through which the drive pin extends.

Clause 19. A hole cutting assembly comprising:
a holesaw comprising a cylindrical wall defining an internal space configured to receive a plug of material formed during a cutting operation, a cutting edge coupled to a first end of the wall, and a base coupled to an opposite second end of the wall;
an arbor assembly configured to be removably coupled to the holesaw and configured to rotate the cutting tool during the cutting operation, the arbor assembly comprising:
an arbor body having a first threaded portion configured to engage a second threaded portion in the base of the holesaw,
a drive pin supported by the arbor body and configured to engage an aperture in the base of the holesaw,
a base support plate movable axially relative to the arbor body and configured to support the base of the holesaw,
a support surface non-movable axially relative to the arbor body, and
a resilient member disposed between the support surface and the base support plate, the resilient member biasing the base support plate axially toward the base of the holesaw;
a drill bit having a cutting tip configured to create a pilot hole in a workpiece and a shaft configured to be coupled to the arbor, the drill bit movable relative to the arbor along a longitudinal axis between an extended position and a retracted position;
a retainer associated with the arbor and configured to selectively maintain the drill bit in the retracted position;
a biasing member configured to exert a force on the drill bit to move the drill bit toward the extended position when the retainer is disengaged; and
a release actuator operable to release the retainer, wherein movement of the drill bit toward the extended position causes the drill bit to apply an ejection force to at least partially dislodge the plug from the internal space of the cutting tool.

Clause 20. The hole cutting assembly of Clause 19, wherein the resilient member is positioned such that seating of the base of the holesaw against the base support plate causes the base support plate to move toward the support surface against a biasing force of the resilient member.

### Terminology

Example embodiments have been provided so that this disclosure will be thorough, and to fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. Additionally, the words “herein,” “above,” “below,” and words of similar import, when used in this application, refer to this application as a whole and not to any particular portions of this application.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal, or close to equal) with sufficient precision as would be understood by one of ordinary skill in the art in the context of the various elements, components, regions, layers and/or sections being described.

Any terms generally associated with circles, such as “radius” or “radial” or “diameter” or “circumference” or “circumferential” or any derivatives or similar types of terms are intended to be used to designate any corresponding structure in any type of geometry, not just circular structures. For example, “radial” as applied to another geometric structure should be understood to refer to a direction or distance between a location corresponding to a general geometric center of such structure to a perimeter of such structure; “diameter” as applied to another geometric structure should be understood to refer to a cross sectional width of such structure; and “circumference” as applied to another geometric structure should be understood to refer to a perimeter region. Nothing in this specification or drawings should be interpreted to limit these terms to only circles or circular structures.

Within this disclosure, references to “extended position,” “intermediate position,” and “retracted position” may be used interchangeably when referring to the positional states of a holesaw assembly, a drill bit, and/or a drill bit carrier. For example, the phrase “extended position of a holesaw assembly” may refer to an extended position of a drill bit or a drill bit carrier. Likewise, the phrase “extended position of a drill bit” may refer to the extended position of a holesaw assembly or a drill bit carrier. Similarly, the phrase “extended position of a drill bit carrier” may refer to an extended position of a drill bit or a holesaw assembly. This interchangeable usage may also apply to an “intermediate position” and a “retracted position.”

Numerous modifications may be made to the exemplary implementations described above. These and other implementations are within the scope of this application.

What is claimed is:

1. An arbor assembly for a holesaw, comprising:
an arbor body extending along an axis and having a first threaded portion configured to engage a second threaded portion of a holesaw;
a drive pin supported by the arbor body and configured to engage an aperture in a base of the holesaw;
a base support plate movable axially relative to the arbor body and configured to support the base of a holesaw;
a support surface non-movable axially relative to the arbor body; and
a resilient member disposed between the support surface and the base support plate, the resilient member biasing the base support plate axially toward the base of the holesaw.

2. The arbor assembly of claim 1, wherein the resilient member is positioned such that seating of the base of the holesaw against the base support plate causes the base support plate to move toward the support surface against a biasing force of the resilient member.

3. The arbor assembly of claim 1, wherein the resilient member comprises at least one of an elastomeric ring, a coil spring, a wave spring, or an elastomeric pad.

4. The arbor assembly of claim 1, wherein the support surface is integral with the arbor body.

5. The arbor assembly of claim 1, wherein the support surface comprises a washer coupled to the arbor body.

6. The arbor assembly of claim 5, wherein the washer defines an opening configured to receive a first portion of the arbor body, and comprises protrusions configured to engage second portions of the arbor body so as to inhibit axial displacement of the washer relative to the arbor body.

7. The arbor assembly of claim 1, wherein the resilient member permits relative rotational adjustment of the holesaw with respect to the arbor body of less than one full turn of a threaded engagement between the first threaded portion and the second threaded portion.

8. The arbor assembly of claim 1, wherein the base support plate defines an opening through which the drive pin extends.

9. An arbor assembly for a holesaw, comprising:
a shank including:
a first portion couplable to a tool holder of a power tool,
a second portion couplable to a holesaw;
a drive pin supported by the shank and configured to engage an aperture in a base of the holesaw;
a base support plate movable axially relative to the shank and configured to support the base of a holesaw;
a support surface non-movable axially relative to the shank; and
a resilient member disposed between the support surface and the base support plate, the resilient member biasing the base support plate axially toward the base of the holesaw;
a drill bit carrier movably coupled to the shank and configured to be couplable to a drill bit, the drill bit carrier configured to move relative to the shank between an extended position and a retracted position, the drill bit carrier being closer to the first portion of the shank in the retracted position than in the extended position; and
a retainer configured to selectively maintain the drill bit carrier in the retracted position, wherein release of the retainer permits movement of the drill bit carrier toward the extended position.

10. The arbor assembly of claim 9, wherein the resilient member is positioned such that seating of the base of the holesaw against the base support plate causes the base support plate to move toward the support surface against a biasing force of the resilient member.

11. The arbor assembly of claim 9, wherein the second portion includes a first threaded portion configured to engage a second threaded portion of the holesaw, and wherein the resilient member permits relative rotational adjustment of the holesaw with respect to the shank by less than one full turn of a threaded engagement between the first threaded portion and the second threaded portion.

12. The arbor assembly of claim 9, wherein the resilient member comprises at least one of an elastomeric ring, a coil spring, a wave spring, or an elastomeric pad.

13. The arbor assembly of claim 9, wherein the support surface comprises a washer coupled to the shank.

14. The arbor assembly of claim 9, further comprising a biasing member configured to exert an ejection force on the drill bit carrier upon release of the retainer when the drill bit is in the retracted position, the ejection force being sufficient to move the drill bit carrier toward the extended position and at least partially eject a plug from the holesaw.

15. The arbor assembly of claim 9, further comprising a release actuator including a collar positioned about an exterior surface of the shank, the collar being movable between at least a first position and a second position, the second position corresponding to the release of the retainer.

16. The arbor assembly of claim 9, wherein the shank includes a helical channel, and wherein the drill bit carrier includes at least one projection engageable with the helical channel, such that rotation of the shank relative to the drill bit carrier causes retraction of the drill bit carrier from the extended position toward the retracted position.

17. The arbor assembly of claim 9, wherein the shank includes an axial channel, and wherein the drill bit carrier includes at least one projection engageable with the axial channel, wherein the axial channel facilitates movement of the drill bit along a longitudinal axis thereof between the extended position and the retracted position through compression of the drill bit or release of the retainer.

18. The arbor assembly of claim 9, wherein the base support plate defines an opening through which the drive pin extends.

19. A hole cutting assembly comprising:
a holesaw comprising a cylindrical wall defining an internal space configured to receive a plug of material formed during a cutting operation, a cutting edge coupled to a first end of the wall, and a base coupled to an opposite second end of the wall;
an arbor assembly configured to be removably coupled to the holesaw and configured to rotate the holesaw during the cutting operation, the arbor assembly comprising:
an arbor body having a first threaded portion configured to engage a second threaded portion in the base of the holesaw,
a drive pin supported by the arbor body and configured to engage an aperture in the base of the holesaw,
a base support plate movable axially relative to the arbor body and configured to support the base of the holesaw,
a support surface non-movable axially relative to the arbor body, and
a resilient member disposed between the support surface and the base support plate, the resilient member biasing the base support plate axially toward the base of the holesaw;
a drill bit having a cutting tip configured to create a pilot hole in a workpiece and a shaft configured to be coupled to the arbor assembly, the drill bit movable relative to the arbor assembly along a longitudinal axis between an extended position and a retracted position;
a retainer associated with the arbor assembly and configured to selectively maintain the drill bit in the retracted position;
a biasing member configured to exert a force on the drill bit to move the drill bit toward the extended position when the retainer is disengaged; and
a release actuator operable to release the retainer, wherein movement of the drill bit toward the extended position causes the drill bit to apply an ejection force to at least partially dislodge the plug from the internal space of the holesaw.

20. The hole cutting assembly of claim 19, wherein the resilient member is positioned such that seating of the base of the holesaw against the base support plate causes the base support plate to move toward the support surface against a biasing force of the resilient member.
